(19) United States
(12) Patent Application Publication
(10) Pub. No.: US 2025/0390284 A1
(43) Pub. Date: Dec. 25, 2025

(54) SYSTEMS AND METHODS FOR A DATA-DRIVEN WORKFLOW PLATFORM

(71) Applicant: ELEMENTUM LTD, San Mateo, CA (US)

(72) Inventors: David A. BLONSKI, Brooklyn, NY (US); Robert HUGHES, Lehi, UT (US); Karen JENKINS, Atlanta, GA (US); Nader MIKHAIL, Huntington Beach, CA (US)

(21) Appl. No.: 19/180,904

(22) Filed: Apr. 16, 2025

Related U.S. Application Data
(63) Continuation of application No. PCT/US2023/077464, filed on Oct. 23, 2023.
Application No. PCT/US2023/077464 is a continuation-in-part of application No. 18/340,510, filed on Jun. 23, 2023, now Pat. No. 12,158,894.
(60) Provisional application No. 63/418,397, filed on Oct. 21, 2022.
(60) Provisional application No. 63/418,397, filed on Oct. 21, 2022.
(60) Provisional application No. 63/454,917, filed on Mar. 27, 2023.
(60) Provisional application No. 63/454,917, filed on Mar. 27, 2023.

(51) Int. Cl. G06F 8/34

(52) U.S. Cl. CPC G06F 8/34

(57) ABSTRACT

The present disclosure provides platforms, systems and methods that may provide a data-driven workflow platform. A method of the present disclosure may comprise: mapping selected data objects to a data storage model of the data-driven workflow platform, where the selected data objects are stored in a data cloud configuration that is operatively coupled to the data-driven workflow platform; and displaying, on a graphical user interface (GUI), a flow for building a cloud application utilizing or managing the selected data objects. The interactive flow comprises at least one graphical element corresponding to a rule for automating an action triggered by a triggering event of the selected data objects.

### CROSS-REFERENCE

This application is the by-pass continuation of International Application No. PCT/US2023/077464, filed Oct. 20, 2023, which claims the priority and benefit of U.S. Provisional Application No. 63/454,917, filed Mar. 27, 2023, U.S. Provisional Application No. 63/418,397, filed Oct. 21, 2022, and U.S. application Ser. No. 18/340,510, filed Jun. 23, 2023; and International Application No. PCT/US2023/077464, filed Oct. 20, 2023, which is a continuation-in-part of U.S. application Ser. No. 18/340,510, filed Jun. 23, 2023, which claims the priority and benefit of U.S. Provisional Application No. 63/454,917, filed Mar. 27, 2023, and U.S. Provisional Application No. 63/418,397, filed Oct. 21, 2022, each of which is incorporated herein by reference in its entirety.

### BACKGROUND

Computing systems are ubiquitous in modern businesses and typically are employed as critical operating resources. For example, many enterprises utilize so-called “enterprise resource planning” (or “ERP”) systems to assist with various aspects of financial management, human resources, inventory management, and the like. Other commonly utilized distributed computing business systems include those known as “transportation management systems” (or “TMS”), which may be utilized to plan, monitor, and optimize logistics and transportation, as well as those known as “risk management systems” (or “RMS”), which may be utilized to assist compliance officers and others regarding the risk profile of an enterprise as well as levels of adherence to applicable rules and regulations. The global ERP software market alone is estimated to be in the range of $45 billion annually, with providers such as SAP®, Oracle®, Workday® and others providing various solutions.

### SUMMARY

Current data-heavy applications (e.g., ERP software, ERP application, RMS application, etc.) may require integration with the cloud lake or data warehouse, copying or downloading the data from the cloud for business intelligence analysis, computation and execute workflows on the local data. For example, ETL (extract, transform, load) or ELT (load and transform in data warehouse) processes are required to move data from one database, multiple databases, or other sources to a unified repository.

A need exists for a service management cloud that can be connected natively to the cloud, allowing for cloud applications created and executed on real-time data in the existing cloud-based repository without the need to integrate, transform, or download. The present disclosure provides systems and methods allowing for users to create, customize and manage applications for managing data flows and processes utilizing distributed computing systems. In particular, systems and methods herein may be utilized for business process optimization wherein operations and processes may be managed and utilized without conventional relocation and/or duplication of enterprise data. The present disclosure provides a unified platform (e.g., cloud-native SaaS platform for no-code business applications with data-driven workflows) for users, organizations or cloud services providers to access their cloud data, process the cloud data for business applications that initiate and manage workflows by connecting natively to the cloud without the need to integrate, transform, or download the data thereby improving efficiency. The platform herein may allow users to create, customize and/or configure cloud applications via a no-code user interface with built-in features such as data mining, configurable and automated workflows, and dynamic relationships discovery and creation.

In an aspect, described herein are methods for providing a data-driven workflow platform. The method comprises: mapping selected data objects to a data storage model of the data-driven workflow platform, wherein the selected data objects are stored in a data cloud configuration that is operatively coupled to the data-driven workflow platform; and displaying, on a graphical user interface (GUI), an interactive flow for building a cloud application utilizing or managing the selected data objects, wherein the interactive flow comprises at least one graphical element corresponding to a rule for automating an action triggered by a triggering event of the selected data objects.

In some embodiments, the data cloud configuration comprises one or more data clouds storing data objects, and wherein the data-driven workflow platform is granted permission to access, process, and edit the data objects stored on the one or more data clouds. In some embodiments, mapping the selected data objects to the data storage model comprises defining a relationship between the selected data objects and an element of the data storage model. In some cases, the relationship is defined by a user via the GUI. In some instances, the GUI permits the user to link one or more data fields of selected data objects to one or more data fields or the element of the data storage model. In some cases, the relationship is automatically generated by the data-driven workflow platform and displayed on the GUI as a recommended relationship.

In some embodiments, mapping the selected data objects to the data storage model comprises identifying a missing element from the data storage model and prompting a user to identify another set of data objects for the missing element. In some embodiments, the data storage model comprises a plurality types of data including at least one of task type, application type, and element data type. In some cases, mapping the selected data objects to the data storage model comprises mapping the selected data objects to an element data type.

In some embodiments, the interactive flow permits a user to add, remove or modify one or more components of the cloud application by dragging and dropping one or more graphical elements to the interactive flow. In some cases, the interactive flow comprises a pre-built template flow prompting the user to add, remove or modify the one or more components. In some instances, the pre-built template flow is automatically determined based at least in part on the selected data objects and the cloud application.

In some embodiments, the rule is automatically generated based at least in part on one or more data fields added to the interactive flow. In some cases, the rule is automatically generated using a model and wherein the model is developed using rules extracted from past actions and previously processed data. In some instances, the rule is recommended to a user on the GUI and wherein the at least one graphical element allows the user to accept, reject or modify the rule.

In some embodiments, the rule is manually defined by a user via the GUI. In some embodiments, the rule comprises a definition of the triggering event and wherein the triggering event is time-based, or is associated with a change of value or a change of status of at least a subset of the selected data objects. In some cases, the rule further comprises a definition of condition for executing the action. In some cases, the rule further comprises a definition of the action. In some examples, the action is selected from the group consisting of add a watcher, update a field, send a notification, post a comment, assign to a user or a group, and create a record.

In some embodiments, the method further comprises displaying, within a portal of the GUI, the selected data objects conforming to the data storage model. In some cases, the method further comprises modifying a value of at least one of the selected data objects via the GUI and automatically updating the value of the corresponding selected data objects in the data cloud configuration via an API connection. In some cases, the method further comprises receiving an instruction to perform an operation on at least one of the selected data objects via the GUI and executing the operation on the at least one of the selected data objects in the data cloud configuration without using an extract, transform and load (ETL) data integration process. For example, the selected data objects comprise transactional data or streaming data and wherein executing the operation further comprises caching an intermediary result by the data-driven workflow platform. In some embodiments, the triggering event of the selected data objects includes a change of the selected data objects stored in the data cloud configuration.

In another aspect, described herein are systems for providing a data-driven workflow platform. The system comprise: a first module configured to operatively couple the data-driven workflow platform to one or more data clouds; a second module configured to map selected data objects to a data storage model of the data-driven workflow platform, wherein the selected data objects are stored on the one or more data clouds; and a visualization module configured to display, on a graphical user interface (GUI), an interactive flow for building a cloud application utilizing or managing the selected data objects, wherein the interactive flow comprises at least one graphical element corresponding to a rule for automating an action triggered by a triggering event of the selected data objects.

In some embodiments, the first module manages one or more permissions granted to the data-driven workflow platform for accessing, processing, and editing data objects stored on the one or more data clouds. In some embodiments, the selected data objects are mapped to the data storage model by defining a connection between the selected data objects and an element of the data storage model. In some embodiments, the visualization module is further configured to display a second GUI allowing a user to define a relationship between elements of the data storage model. In some cases, the second GUI permits the user to link one or more data fields of a first selected element to one or more data fields of a second selected element of the data storage model. In some cases, the relationship is automatically generated by the data-driven workflow platform and displayed on the second GUI as a recommended relationship.

In some embodiments, the second module is configured to further identify a missing element from the data storage model and prompt a user to identify another set of data objects for the missing element. In some embodiments, the data storage model comprises a plurality types of data including at least one of task type, application type, transactional data type, and element data type. In some cases, the second module is configured to further map the selected data objects to a transactional data type or an element data type.

In some embodiments, the interactive flow permits a user to add, remove or modify one or more components of the cloud application by dragging and dropping one or more graphical elements to the interactive flow. In some cases, the interactive flow comprises a pre-built template flow prompting the user to add, remove or modify the one or more components. For example, the pre-built template flow is automatically determined based at least in part on the selected data objects and the cloud application. In some cases, the rule is automatically generated based at least in part on one or more data fields added to the interactive flow. In some instances, the rule is automatically generated using a model and wherein the model is developed using rules extracted from past actions and previously processed data. For example, the rule is recommended to a user on the GUI and wherein the at least one graphical element allows the user to accept, reject or modify the rule.

In some embodiments, the rule is manually defined by a user via the GUI. In some embodiments, the rule comprises a definition of the triggering event and wherein the triggering event is time-based, or is associated with a change of value or a change of status of at least a subset of the selected data objects. In some cases, the rule further comprises a definition of condition for executing the action, in some cases, the rule further comprises a definition of the action. In some instances, the action is selected from the group consisting of add a watcher, update a field, send a notification, post a comment, assign to a user or a group, and create a record.

In sone embodiments, the visualization module is further configured to display, within a portal of the GUI, the selected data objects conforming to the data storage model. In some cases, a value of at least one of the selected data objects is modified via the GUI and a value of the corresponding selected data objects in the data cloud configuration is automatically updated via the first module. In some embodiments, the first module is configured to translate an instruction to perform an operation on at least one of the selected data objects received via the GUI into a database operation executable in the data cloud configuration. In some cases, the database operation is executed on the selected data objects in the data cloud configuration without using an extract, transform and load (ETL) data integration process. In some instances, the selected data objects comprise transactional data or streaming data and wherein the data-driven workflow platform is configured to cache an intermediary result for performing the operation. In some embodiments, the triggering event of the selected data objects includes a change of the selected data objects stored in the data cloud configuration.

In some embodiments, the interactive flow is identified from a plurality of predefined workflows by a large language model (LLM). In some cases, the interactive flow is identified based at least in part on a data schema of the selected data objects stored in the data cloud configuration. In some cases, an output of the LLM comprises a list of instructions for creating the interactive flow.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, and the accompanying drawings (also “Figure” and “FIG.” herein), of which.

FIG. 1 shows an example of storing enterprise data in conventional database systems.

FIG. 2 shows an example of cloud-based repository providers.

FIG. 3 schematically shows an example of cloud services and SaaS.

FIGS. 4-7 illustrate various configurations where a service management cloud system may be configured to have direct interconnectivity between a user and a Data Cloud configuration.

FIG. 8 schematically illustrates a platform providing an interface for view, access and manage process-data all secured within a data cloud.

FIG. 9 schematically illustrates an example of a service management cloud system.

FIG. 10 illustrates a Service Management Cloud configuration.

FIG. 11 illustrates a Service Management Cloud session configuration.

FIG. 12 illustrates a Service Management Cloud session configuration with write-back capability.

FIGS. 13-15 illustrate access management, control, and collaboration within the platform.

FIG. 16 illustrates the platform with secure and efficiently-administered access.

FIG. 17 illustrates an example of setting up connection to data sources in a data cloud, and mapping the source data to data elements in the platform.

FIGS. 18-20 show examples of use cases for configuring and employing Data-driven workflow platform variations in sophisticated business processes with varying levels of automation.

FIGS. 21-23 show examples of GUIs for creating and/or editing an automation.

FIGS. 24 and 25 show examples of GUI for a creating or adding a relationship.

FIGS. 26-30 show examples of GUIs for creating workflows.

FIG. 31 and FIG. 32 show an example of GUI displaying a created workflow with tracked progress and analytics.

FIGS. 33-38 show examples of a logistics application suite.

FIGS. 39-43 show examples of GUI for configuring or creating data mining.

FIG. 44 schematically illustrates an architecture for the data-driven workflow platform.

FIG. 45 schematically shows an example of AI-based Application discovery feature, in accordance with some embodiments of the present disclosure.

FIGS. 46-48 show examples of GUI for an AI-based Application discovery feature.

FIG. 49 schematically shows an example of AI-generated workflow feature, in accordance with some embodiments of the present disclosure.

FIGS. 50-53 show examples of GUI of an AI-generated workflow feature.

FIGS. 54 and 55 show examples of GUI for automation flow.

FIGS. 56 and 57 show examples of GUI for an Application marketplace.

FIGS. 58 and 59 show examples of a GUI (e.g., CloudLink Explorer) allowing users to find data in the data cloud (e.g., Snowflake).

FIG. 60 shows an example of a GUI for users to set up logic rules (e.g., filter parameters and logic operators in records) to find the data.

FIG. 61 shows an example of a GUI for users to set up machine-learning-based Anomaly Detection and Report rules.

FIG. 62 shows an example of a GUI for a user to select a primary column to be used as unique identifier of the data.

FIG. 63 shows a non-limiting example of a computing device; in this case, a device with one or more processors, memory, storage, and a network interface.

FIG. 64 shows a non-limiting example of a web/mobile application provision system; in this case, a system providing browser-based and/or native mobile user interfaces.

FIG. 65 shows a non-limiting example of a cloud-based web/mobile application provision system; in this case, a system comprising an elastically load balanced, auto-scaling web server and application server resources as well synchronously replicated databases.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Certain Definitions

Unless otherwise defined, all technical terms used herein have the same meaning as commonly understood by one of ordinary skill in the art to which this invention belongs.

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system.” “interface,” “unit” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein a processor encompasses one or more processors, for example a single processor, or a plurality of processors of a distributed processing system for example. A controller or processor as described herein generally comprises a tangible medium to store instructions to implement steps of a process, and the processor may comprise one or more of a central processing unit, programmable array logic, gate array logic, or a field programmable gate array, for example. In some cases, the one or more processors may be a programmable processor (e.g., a central processing unit (CPU) or a microcontroller), digital signal processors (DSPs), a field programmable gate array (FPGA) and/or one or more Advanced RISC Machine (ARM) processors. In some cases, the one or more processors may be operatively coupled to a non-transitory computer readable medium. The non-transitory computer readable medium can store logic, code, and/or program instructions executable by the one or more processors unit for performing one or more steps. The non-transitory computer readable medium can include one or more memory units (e.g., removable media or external storage such as an SD card or random access memory (RAM)). One or more methods or operations disclosed herein can be implemented in hardware components or combinations of hardware and software such as, for example, ASICs, special purpose computers, or general purpose computers.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

### Overview of Cloud Service

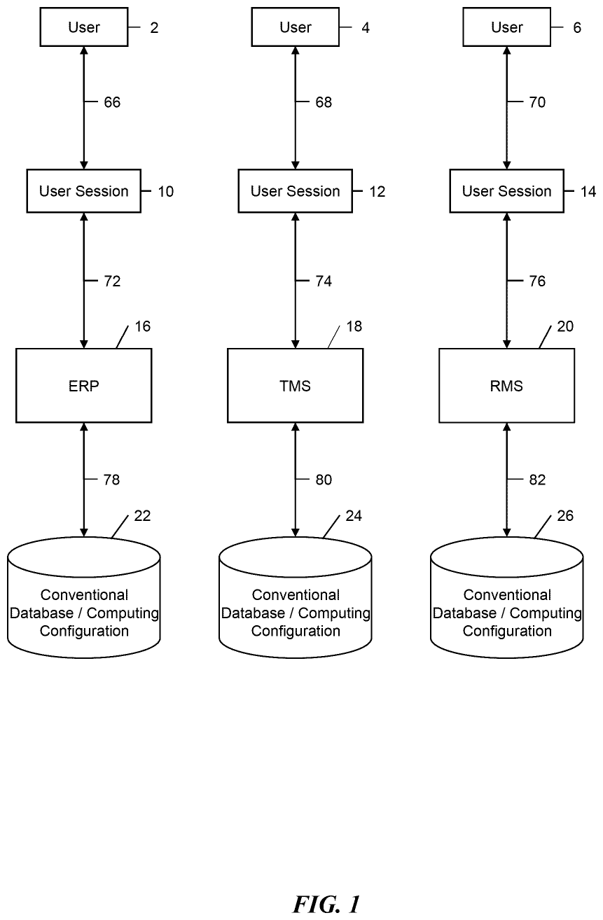

FIG. 1 shows an example of storing enterprise data in conventional database systems. As illustrated in the example, typically one or more users (2, 4, 6; such users may be the same user operating through separate systems, or may represent three different users operating separate systems) within an enterprise will establish separate user sessions (10, 12, 14) with each connected (66, 68, 70; 72, 74, 76) system (16—an ERP system, for example: 18—a TMS system, for example; 20—an RMS system, for example) with which such one or more users (2, 4, 6) have credentials and authority for access and utilization. Typically, each system (16, 18, 20) may be operatively coupled (78, 80, 82) to one or more database systems (22, 24, 26) configured to store pertinent data and conduct sorting, report generation, and/or computation utilizing such data, for example, dynamic to the requests coming through the interconnected systems (16, 18, 20). Enterprises using such configurations often have specific information technology resources available to maintain, update, and address various aspects of the database/computing systems (22, 24, 26), and there are inherent operating risks and inefficiencies for such enterprises pertaining to the proprietary and arcane nature of many ERP/database/computing configurations, as is discussed in further detail below.

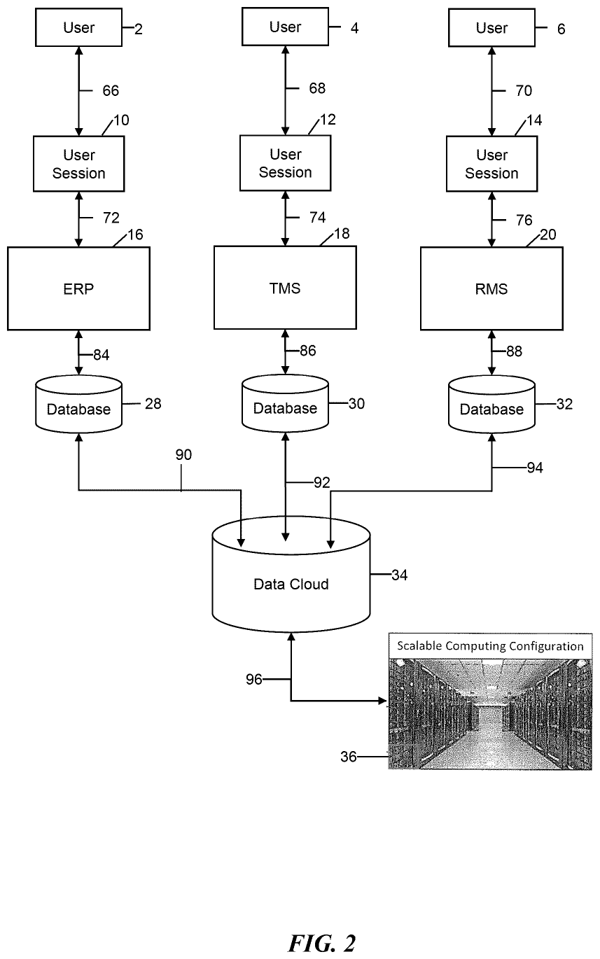

A next-generation configuration has evolved wherein enterprise data is becoming more separated from computing resources. As illustrated in FIG. 2, cloud-based repository providers (e.g., Snowflake®) continue to gain market share from conventional ERP/database/computing configurations (such as that illustrated in FIG. 1) by providing systems wherein a data cloud system configured for the particular enterprise (34) is established to essentially separate the data of the enterprise from the core computing resources, which may reside in an intercoupled (96, such as via high-throughput connectivity) scalable computing configuration (36), such as those made available by Amazon®, Google®, and Microsoft® under the tradenames Amazon Web Services®, Google Cloud®, and Azure®.

As illustrated in FIG. 2, one or more users (2, 4, 6; such users may be the same user operating through separate systems, or may represent three different users operating separate systems) within an enterprise may utilize one or more computing sessions (10, 12, 14) to operate one or more connected systems (16, 18, 20), which may be intercoupled (84, 86, 88; 90, 92, 94) to the data cloud configuration (34). Many such systems, such as those shown in FIG. 2 (16, 18, 20) still typically will require a significant level or amount of enterprise data maintained (such as via a conventional system integration such as an application programming interface (or “API”), batched table, XML dispatch, or the like) using a separate database (28, 30, 32) to be able to operate, and thus even though some of the data of the enterprise, such as reporting and/or audit data, may be stored in and then copied from the data cloud (34) with operational computing provided by an intercoupled (96) scalable computing configuration (36), data and data processing typically remains distributed on other disparate systems (18, 20, 22), which again presents various efficiency, complexity, expense, and risk management downsides to such enterprise.

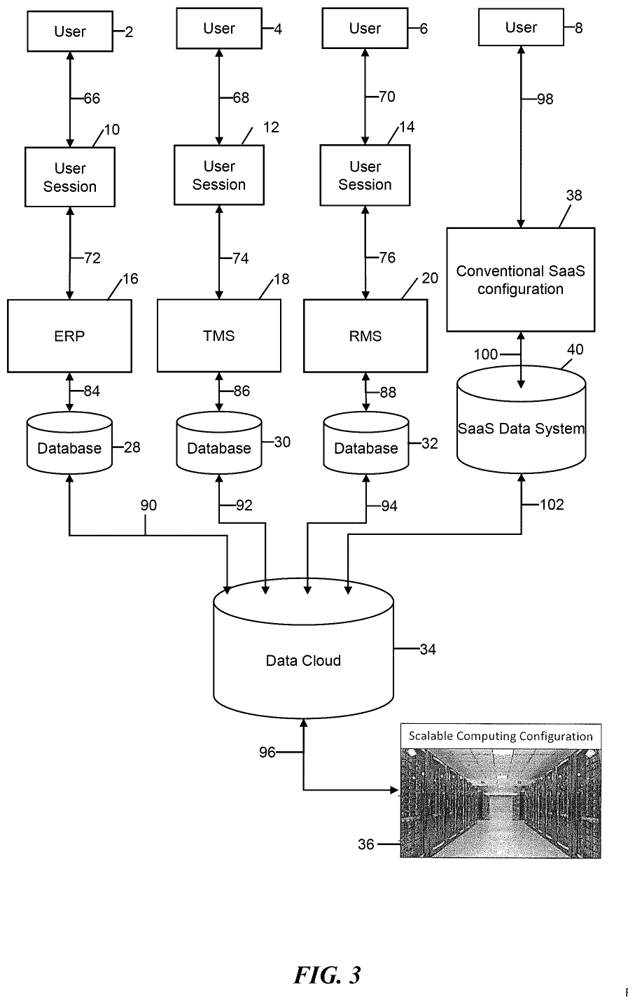

Recently, cloud services and SaaS (software-as-a-service) may provide enterprise computing resources that are more scalable, functional, efficient, upgradeable, and less isolated, while also remaining secure. Particularly in the scenario of a typical modern enterprise navigating various issues such as supply chain challenges, the number of disparate pieces of information from disparate systems that may be integrated and entertained, often manually, to make a timely and informed business decision can be extreme. For example, as illustrated in FIG. 3, it may not be unusual for a typical enterprise manufacturing a complex technology product to be trying to pull information from multiple conventionally-integrated systems (16, 18, 20) and/or SaaS (38) systems (e.g., software to examine approved purchase orders for key parts for goods to be manufactured, as well as to examine shipping/transportation status, operational risks, payment status, and pertinent weather data) to understand whether a particular shipment is actually going to arrive on time to the appropriate manufacturing facility to assist in making manufactured goods to be shipped in time for a particular holiday.

Perhaps more importantly, even in a scenario wherein enough users/operators are able to be present for a real-time discussion to address such compound and complex issues, they may likely be bringing data from disparate systems which is not linked, not coordinated, probably not updated in real or near-real time, and not already worked through business process analysis to assist in making a decision based upon many inputs. In other words, such a discussion can require 30 operators, each coming with their own perspective and data from disparate systems (some of which may not be within the enterprise firewall), each wanting to join into a real-time discussion regarding the issues present and potential solutions to address. Described herein are systems and methods for business process operation, management, and automation, which are configured to meet these and other operational challenges within the modern enterprise.

Referring to FIG. 3, an enterprise configuration similar to that illustrated in FIG. 2 is shown, with the addition of one or more so-called “software-as-a-service” (or “SaaS”) systems (38) configured to allow a user (8) to engage a SaaS configuration (38), such as Customer Relationship Management (CRM), Enterprise Resource Planning (ERP), Content Management System (CMS), Project Management Software, Sales, Marketing, or eCommerce software (e.g., Salesforce®, Adobe Creative Cloud®, ServiceNow®, and the like). Such systems typically utilize an intercoupled (100) SaaS Data System (40), such as a database, specifically configured to facilitate operation of the SaaS configuration (38) by pulling certain data from the intercoupled Data Cloud Configuration (34), such as via a conventional system integration as discussed above in reference to the interconnected systems (16, 18, 20). As with the system configuration illustrated in FIG. 2, even though some of the data of the enterprise will be located on the data cloud (34) with operational computing provided by a scalable computing configuration (36), there will remain some data distributed on other disparate systems (28, 30, 32, 40), which again presents various efficiency, complexity, expense, and risk management downsides to such enterprise.

### Service Management Cloud System (Data-Driven Workflow Platform)

The present disclosure provides an improved service management cloud system or a cloud-native SaaS platform for no-code applications with data-driven workflows utilizing cloud data. The service management cloud system as described herein may provide configurable and automated data-driven workflows via no-code applications. The service management cloud system may be natively integrated to any data cloud and may allow for configurable applications for workflows or processes without the need of ETL (extract, transform, load) or ELT (load and transform in data warehouse). The term “service management cloud” or “cloud-native SaaS platform” may also be referred to as “data-driven workflow platform” which are utilized interchangeably throughout the specification.

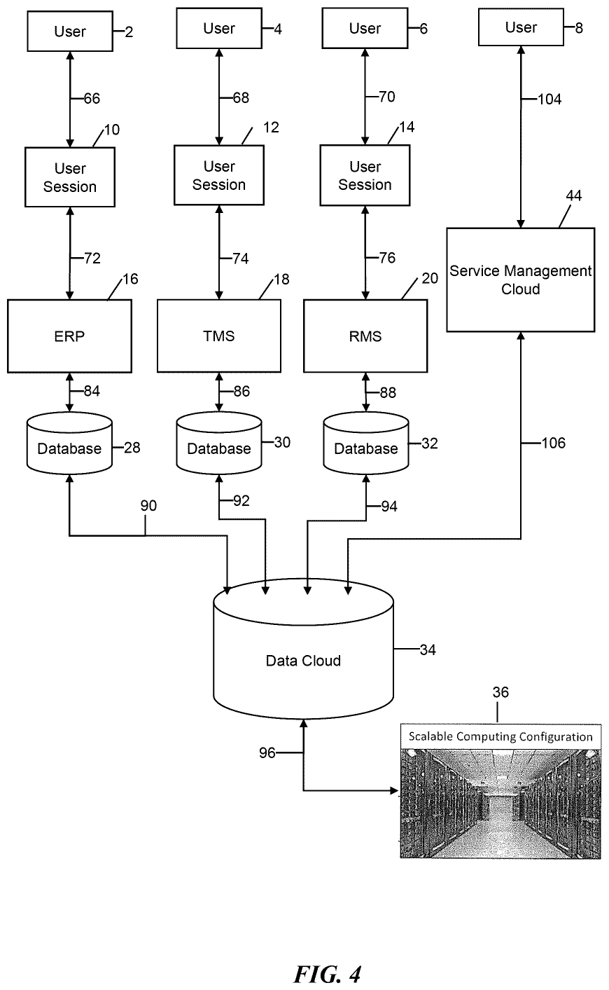

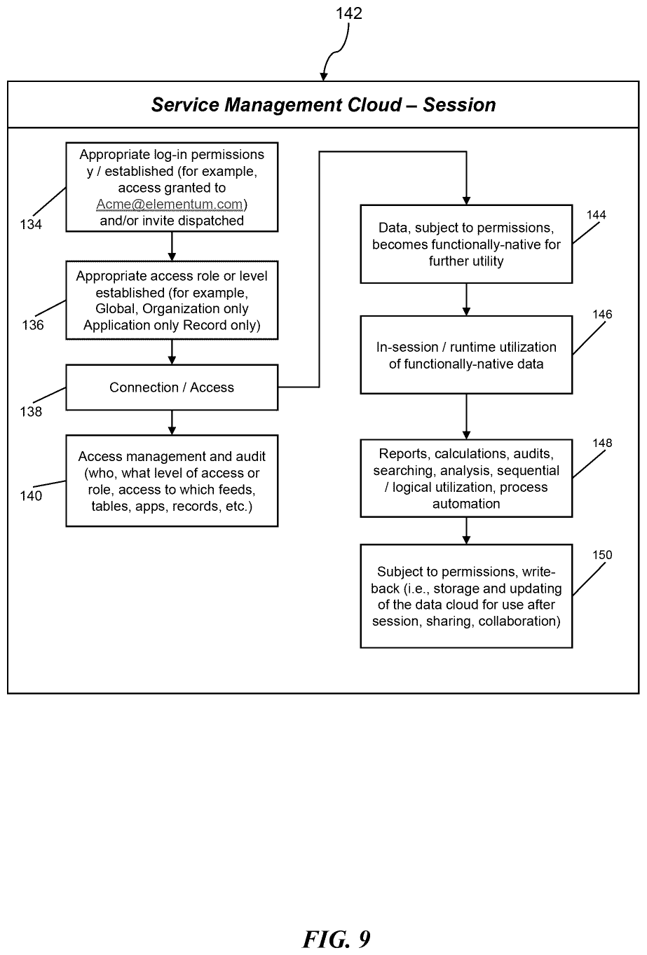

FIGS. 4-7, illustrate various configurations wherein a service management cloud system (44) may be configured to have direct interconnectivity (104, 106) between a user (8) and a Data Cloud configuration (34). The service management cloud system (44) may be specifically configured to operate without requiring a significant amount of data migration from the Data Cloud configuration (34) to other systems, while also providing visibility and utility to the user (8) through the Service Management Cloud (44) to manage business activities and processes in an efficient and scalable manner, as described in further detail below. As described in further detail below in reference to FIG. 9, for example, the service management cloud system (44) may be specifically configured to not only provide efficient and globally controllable access to various interconnected systems and data via the use of duly granted privileges, but also to connect these data and systems such that the data becomes available to the service management cloud system (44) with efficiency and latency similar to that which may be present if the data was local to the service management cloud system (44). In other words, during a given session, the service management cloud system (44) and intercoupled resources (34, 36) may be configured to cause targeted data to become “functionally-native” to the subject service management cloud system (44) session—and such condition brings about significant additional opportunities for utilization of the data as an enterprise, while also assuring that the data continues to be updated, such as in real-time or near-real-time, and continues to reside entirely, or at least primarily, on the data cloud (34).

Referring to FIG. 4, an enterprise data configuration is illustrated wherein conventional connected business systems (16, 18, 20), such as those illustrated in FIG. 2, remain in place (i.e., within the data cloud) to assist one or more given users (2, 4, 6) in conventional operations through sessions (10, 12, 14) with such systems (16, 18, 20) and their connected data (28, 30, 32; 34), and wherein a separate Service Management Cloud system (44) is configured to provide direct access to the intercoupled (106) Data Cloud configuration (34), such that the user (8) of the Service Management Cloud system (44) may not only examine information contained upon the Data Cloud Configuration (34) in the form of views of returns to queries, reports, and the like without migrating data toward the user (8) from the Data Cloud Configuration (34), but also wherein the user (8) may create, operate, and manage business processes by utilizing the combined interconnected resources of the Service Management Cloud system (44), the Data Cloud Configuration (34), and the associated Scalable Computing Configuration (36) without migrating data toward the user (8) from the Data Cloud Configuration (34), as discussed further below, such as in reference to FIG. 9.

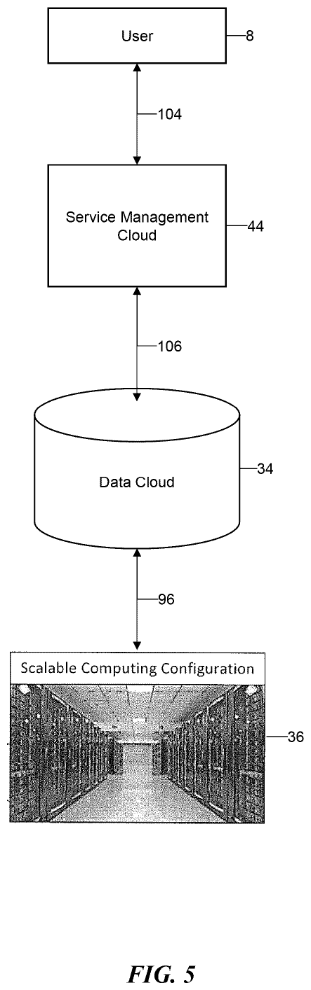

FIG. 5 illustrates a variation without the integrated conventional enterprise systems (16, 18, 20 of FIG. 4, for example) present, for simplicity purposes. Such a configuration may occur in a paradigm wherein such conventional configurations may have been migrated to Service Management (44) and Data Cloud (34) configurations, or wherein conventional functionality has been obviated by the functionality available with Service Management (44) and Data Cloud (34) configurations.

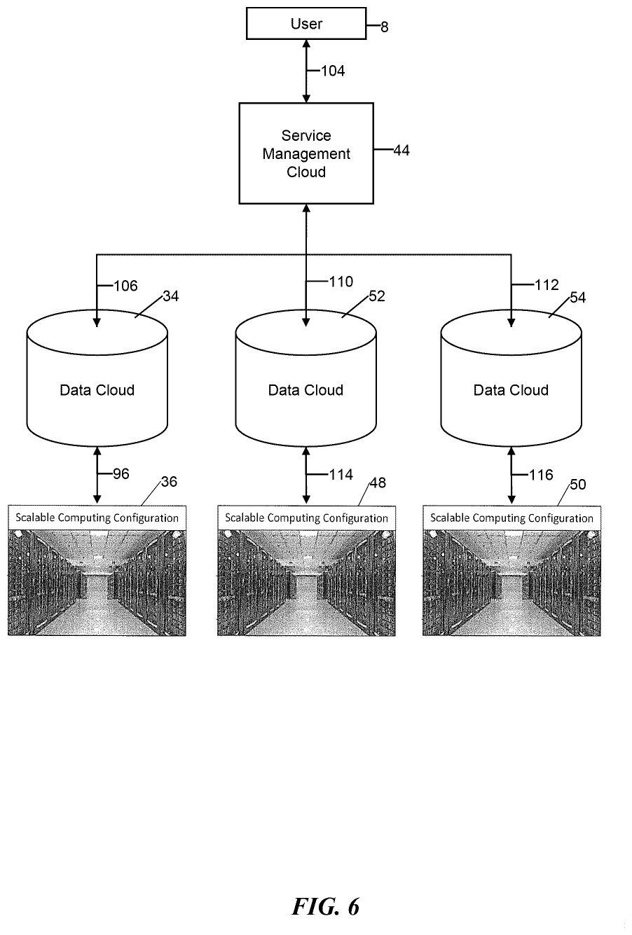

FIG. 6 illustrates an embodiment wherein three separate Data Cloud Configurations (34, 52, 54) are shown interconnected (106, 110, 112) between the Service Management Cloud system (44) and three separate interconnected (96, 114, 116) Scalable Computing Configurations (36, 48, 50), which may be maintained by different and/or distinct providers (for example, Amazon Web Services®, Google Cloud®, and/or Azure®). Such a configuration illustrates that a single user (8) may utilize a single instantiation of a Service Management Cloud (44) to examine and control data, and conduct computing operations, from various disparate interconnected systems, as described further below in reference to FIG. 9, again without heavy reliance upon pulling data from such systems toward the user (8), depending to some extent upon the Data Cloud Configurations (34, 52, 54). For example, in an embodiment wherein a particular Data Cloud Configuration is one featuring remote compute management features such as those offered by Snowflake® under the tradename “Streams” ®, or where a suitable adapter has been built in its place, data manipulation language (“DML”) changes made to tables, directory tables, external tables, or underlying tables in one or more views (including secure views) may be recorded for a given source object, thereby allowing for a form of trackable remote operation or remote manipulation of the Snowflake Data Cloud Configuration instantiation. Such streaming configurations may be utilized to provide the Service Management Cloud (44) with access to the data within one or more of the Data Cloud Configurations (34, 52, 54) along with access to computing manipulation thereof through one or more pertinent interconnected (96, 114, 116) Scalable Computing Configurations (36, 48, 50).

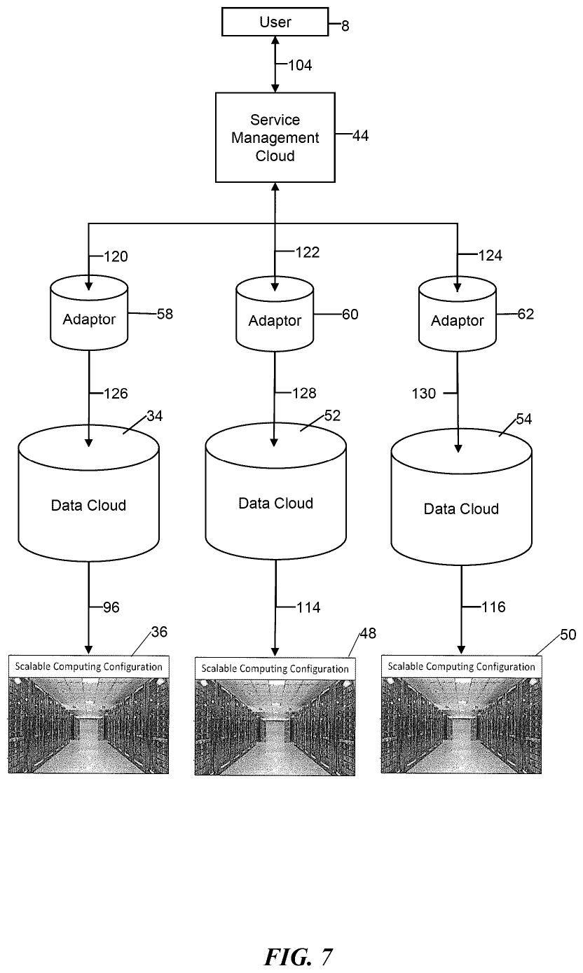

Referring to FIG. 7, one or more interconnected (120, 122, 124, 126, 128, 130) adaptor (58, 60, 62) modules may be configured to assist with specific utility of the subject Data Cloud configurations (34, 52, 54) by the Service Management Cloud (44), such as to assist with functions pertaining to utilizing the Scalable Computing Configurations (36, 48, 50) for as much of the associated computing as possible. The adapter may enable data hosted in the data cloud (e.g., Snowflake) to appear like it is native inside of the service management cloud platform. For instance, during the configuration or integration between the data cloud (e.g., Snowflake) and the Service Management Cloud for the targeted data, the adapter may setup a mapping and data type matching without changing the data or applying any type of modifications to the data within the data cloud. Details about the adapter, data type matching, assignment and data mapping (setting up connection to data source) are described later herein.

As noted above, in many multifactorial modern business challenges, it can require personnel, information, and expertise from not only various people and sources within a particular organization, but also from other (i.e., outside) organizations. For example, a typical enterprise may contract for various aspects of its logistics operation. To understand and address a particular urgent business challenge which may involve logistics, the enterprise may need to involve personnel and information from the outside logistics service provider. Such involvement conventionally may require emails, teleconferences, phone calls, and many people. A key benefit of the subject Service Management Cloud (44) configurations is an enhanced ability to bring people into collaborative processes with specific and controlled levels of access, whether they are within a particular organization, department, generalized security, or not.

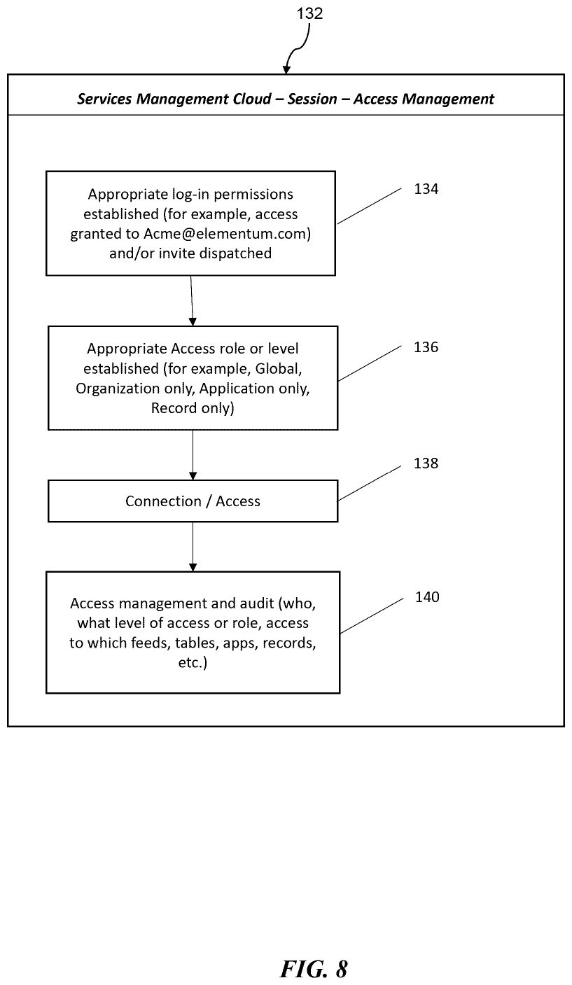

The service management cloud platform may allow for process sharing. In addition to sharing data securely within the data cloud, participants or different entities involved in a workflow may share processes. For example, supply chain team may collaborate, working directly with partners on the same data within the same workflows via the platform herein. The platform may provide an interface for view, access and manage process-data such as tasks, assignments, reminders, all secured within the data cloud. Referring to configuration (132) FIG. 8, the Service Management Cloud (44) may be configured to allow pre-established, or in-app defined, (134) log-in permissions which may provide specific access roles or levels (for example, total global access, organization only, application only, and even limited to a single record) (136). The Service Management Cloud (44) may be configured to allow appropriate connection and access to the information using the data cloud (34) and associated computing resources (such as 36 in FIG. 4).

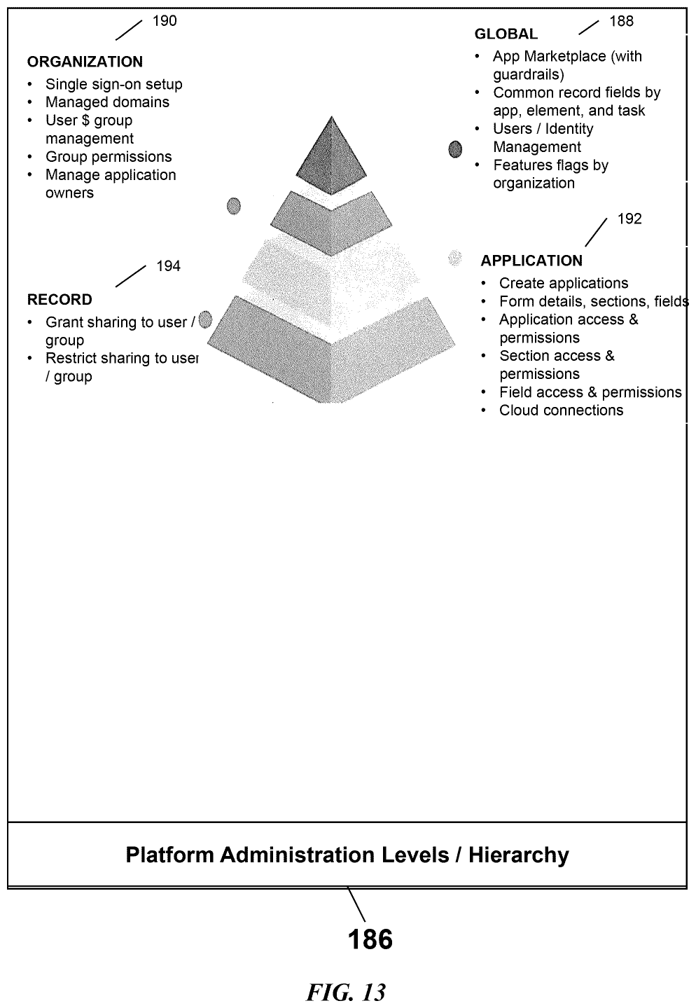

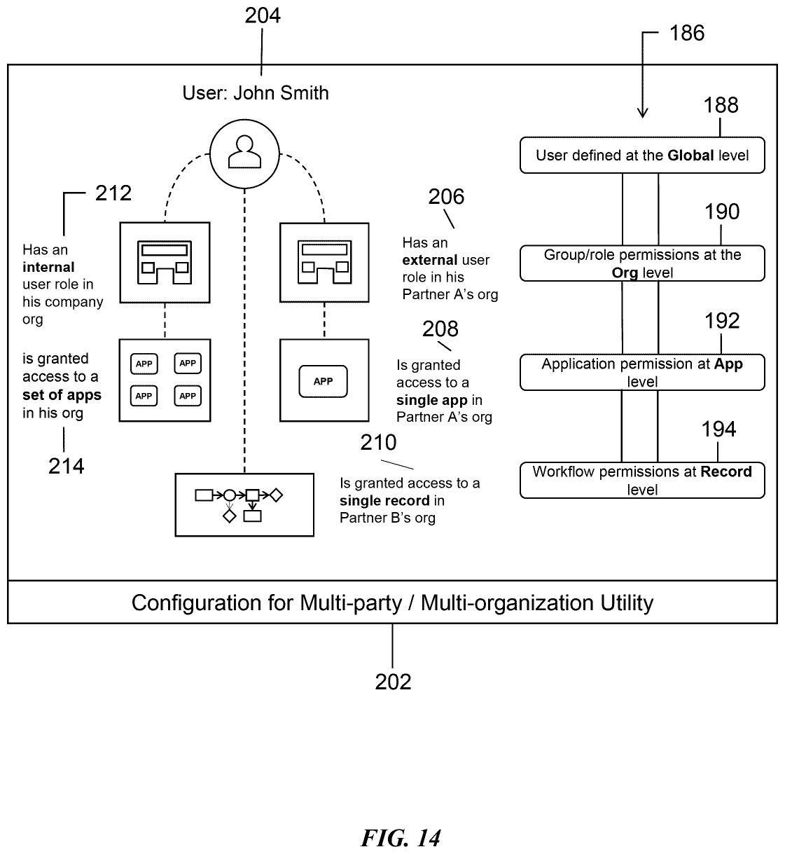

Further, with precision access and tracking by record, application, organization, role, and the like, the access to each particular aspect of the enterprise data and system may be tracked and audited (140). For example, a report, user-interface dashboard, or notification may be set up to allow administrators of a Service Management Cloud (44) configuration to conveniently, with real-time or near-real-time updating, understand who has access to what, throughout the system. Referring ahead to FIGS. 13-15, further aspects of access management, control, and collaboration are illustrated. Referring to FIG. 13, a hierarchy configuration is illustrated (186), which, as noted above, may be utilized to assist an administrator of a Service Management Cloud (44) configuration in providing very specific access to aspects of the system, such as based upon individual records (194), applications (192), on an organization basis (190), or globally (188), subject to appropriate limitations. Thus, for example, referring to FIG. 14, collaboration within and outside of a given organization, by one or many parties, is facilitated with such configuration (202). A user (“John Smith” 204) is illustrated having an internal role (212) in a given company organization with appropriate access (214) to this company's Service Management Cloud (44). Using the access configurability as discussed in reference to FIG. 8, John Smith (204) also may be granted separate and distinct access to external resources of a partner organization's Service Management Cloud (44), such as based upon his role (206) with that external partner organization, or on an app-specific basis (208). FIG. 14 also illustrates that John Smith (204) may have limited access to a single record (210) within the Service Management Cloud (44) of a third organization. Thus John Smith (204) may conveniently and efficiently collaborate with persons, processes, and data of three or more organizations, securely, and in real or near-real time, through the cloud using the subject configurations of Service Management Cloud and without needing to log-in and log-out of multiple systems.

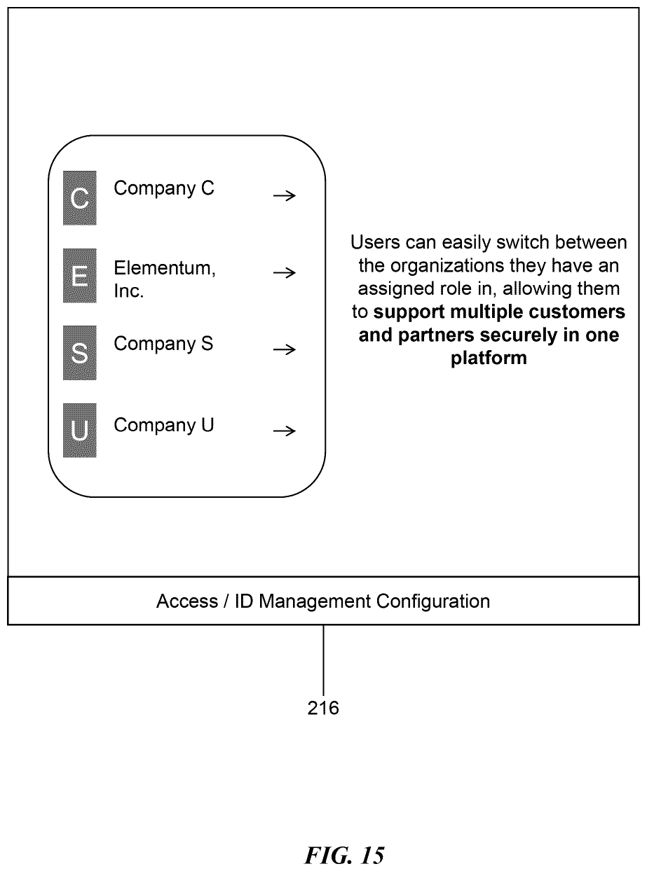

FIG. 15 illustrates that with such a Service Management Cloud (44) configuration (216) a user such as John Smith (element 204 of FIG. 6B) may easily switch between organizations to collaborate. In other words, “bringing in someone from another organization to help on this urgent/particular issue”—becomes very efficient, secure, and controlled, and can be automated in many regards, as described further below. Further, the Service Management Cloud (44) may be configured to be platform-independent, such that it may be accessed and utilized from any web interface, thereby allowing appropriate users to administer any platform from anywhere, generally backed by the significant computing capabilities of a secure data center, such as the Scalable Computing Configuration (36) operatively coupled (96) to the Data Cloud (34) in the embodiment of FIG. 4.

Referring to FIG. 9, with a robust, precise, and convenient paradigm for managing access, operators are able to not only visualize data that is being updated in real or near-real time, but also utilize it in new ways in business processes of many kinds, with various levels of automation. As shown in FIG. 9, data, subject to appropriate access limitations, becomes functionally-native for further utility. As noted above the notion of functionally-native is in reference to the fact that the Service Management Cloud (44) may be configured to present a given user with access to data that is constantly updated in real or near-real time, with a level of latency and access as though the data was resident in their local computing operation, notwithstanding the fact that the data generally is actually residing on the Data Cloud (34) and is being supported by significant Scalable Computing Configuration (such as element 36 of FIG. 4). With updated data available efficiently, subject to appropriate permissions, it may be utilized for various in-session operations (146), such as the creation of reports or notifications, calculations of various types, audits, searching, analysis, sequential and/or logical utilization, process automation, and the like (150). Further, subject to appropriate permissions, data may be written-back (150) such that changes or new data are stored on the Data Cloud and may be utilized to update other interconnected systems and databases thereof.

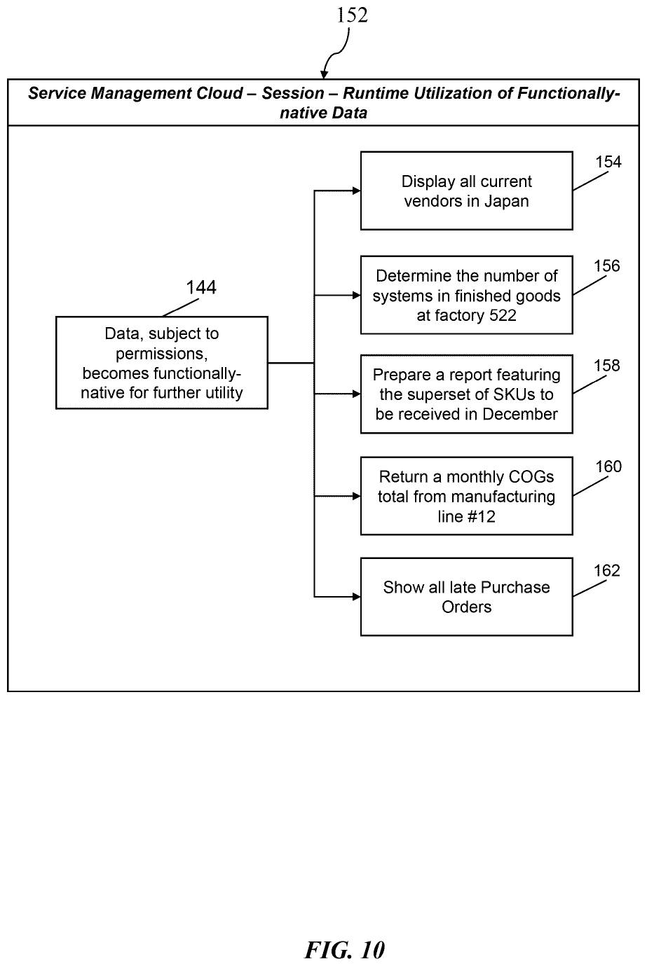

Referring to FIG. 10, an expanded illustrative view of a Service Management Cloud (44) configuration (152) is shown wherein given functionally-native access to the data, many operations may be efficiently accomplished using the Service Management Cloud (44) through a web service, again, on a platform-independent basis. For example, a cloud application (“App”) may be created to conduct various operations on a repeated or one-time basis, such as those that may functionally: “display all current vendors in Japan” (154); “determine the number of assemblies in finished goods inventory at Factory #522” (156); “prepare a report featuring the superset of SKUs to be received in December” (158); “return a monthly cost of goods sold total from Manufacturing Line #12” (160); and “show all late Purchase Orders since January” (162).

With regard to the utilization of data that has been made functionally-native during a given session on a Service Management Cloud (44), the system may be configured to deliver data into a given user's session based upon factors such as: the platform being used by the user to access the Service Management Cloud (44) (for example, a smart-phone-based platform may not have the ability to throughput or receive as much data as a robust desktop workstation); the quality of the connection between the user's client device and the Service Management Cloud (44); the bandwidth or latency of the connection between the user's client device and the Service Management Cloud (44); and/or the location of the user's client device relative to the Data Cloud (such as element 34 of FIG. 4, for example, it may be desirable to allow a user to configure his or her particular session in the Service Management Cloud (44) to prioritize data most immediately local to the user) and Scalable Computing Configuration (such as element 36 of FIG. 4). In other words, the Service Management Cloud (44) may be configured to automatically modulate the delivery of data into the user's session based upon various factors, to enhance utility and generally support the user in collaboration and other business operations.

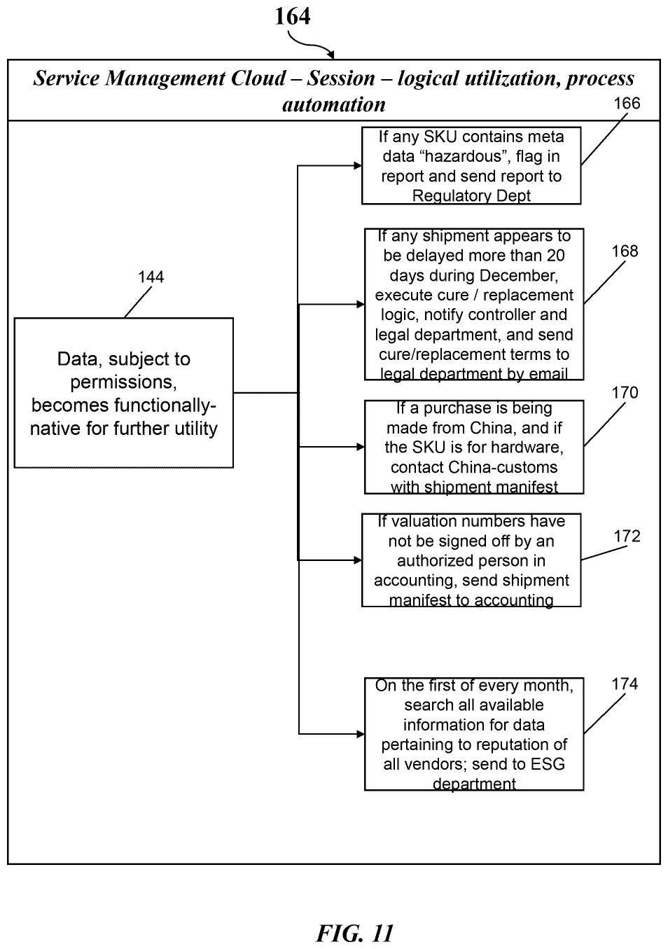

Referring to FIG. 11, a Service Management Cloud (44) session configuration (164) is illustrated wherein functionally-native data (144) may be utilized for sophisticated business process automation. For example, the Service Management Cloud (44) may be configured to functionally and automatically run processes that utilize the available data, such as: “if any SKU contains meta data ‘hazardous’, flag in report and send report to Regulatory Department” (166); “if any shipment appears to be delayed more than 20 days during December, execute cure/replacement logic, notify controller and legal department, and send cure/replacement terms to legal department by email” (168); “if a purchase is being made in China, and if the SKU is hardware, contact China-customs with shipment manifest” (170); “if valuation numbers have not been signed off by an authorized person in Accounting, send shipment manifest to Accounting” (172); “on the first day of every month, search all available information for data pertaining to reputation of all vendors, send to ESG department” (174).

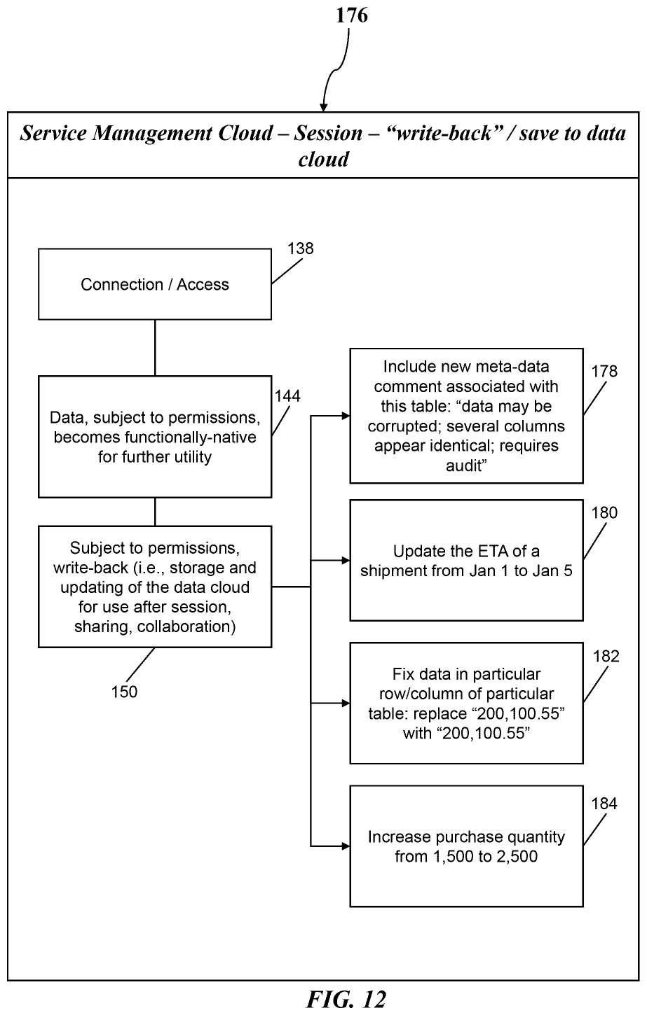

Referring to FIG. 12, a Service Management Cloud (44) session configuration (176) is illustrated wherein the real-time or near-real-time access (138) to functionally-native data (144) may be utilized for write-back purposes (150). For example, the Service Management Cloud (44) may be configured to functionally write back to the Data Cloud (such as element 34 of FIG. 4), which may be utilized to update other intercoupled systems, as noted above, in the following example scenarios: “include new meta-data comment associated with this table; ‘data may be corrupted; several columns appear identical; requires audit’” (178); “update the ETA of a shipment from January 1 to January 5” (180); “fix data in particular row/column of this particular table: replace ‘2oo,100.55’ with ‘200,100.55’” (182); “increase purchase quantity from 1,500 to 2,500” (184). Such write-backs may represent significant changes in operation, and the ability to efficiently navigate them through one interface, securely, and have the data populate out to other users immediately, presents another key paradigm shift. As the Service Management Cloud is connected directly to the data stored on a Data Cloud provider and the workload or queries run in the Data Cloud, the source data may be updated, modified in the Data Cloud, and/or new data may be added to the data cloud (e.g., upon execution of actions in the automation setting that are requested to update data). The Service Management Cloud may provide an alternative capability to call an API directly to a Cloud Service (e.g., Salesforce) to perform an action (e.g., add a new data record in a new column or table in the data cloud) or update the source data. The platform may be capable to write-back to the Cloud Service (e.g., Salesforce), directly to the source systems (e.g., ERP, CRM, CMS, etc.) or a combination of both. In some cases, the platform may allow a user to set up preference or permission of write-back. For example, a user may set up the write-back as enabled for both the Cloud Service and the connected source systems. Alternatively, a user may set up the write-back as enabled for the Cloud Service only.

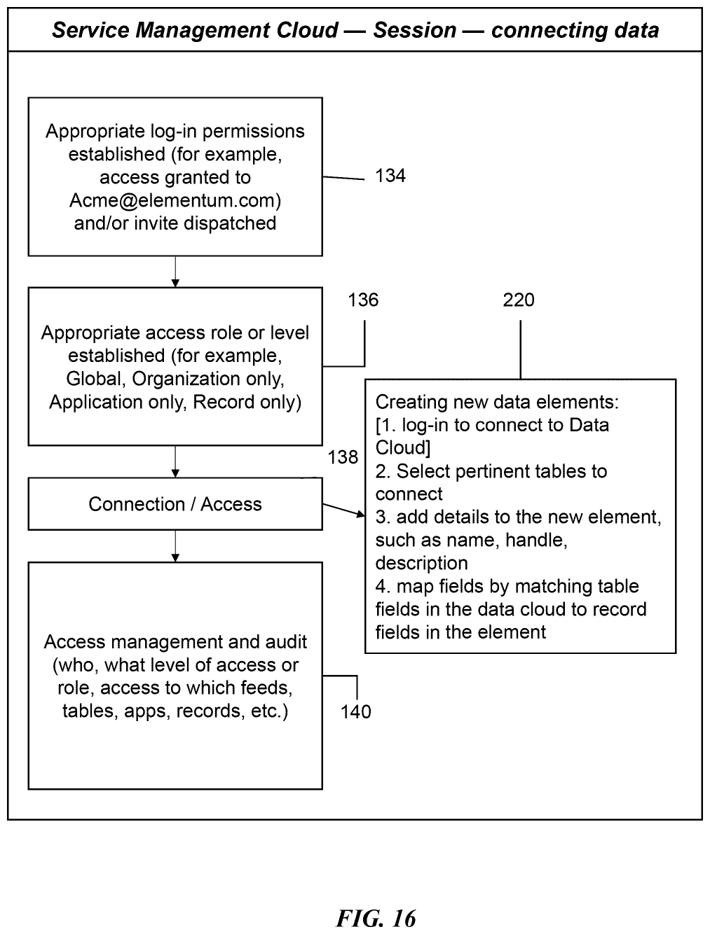

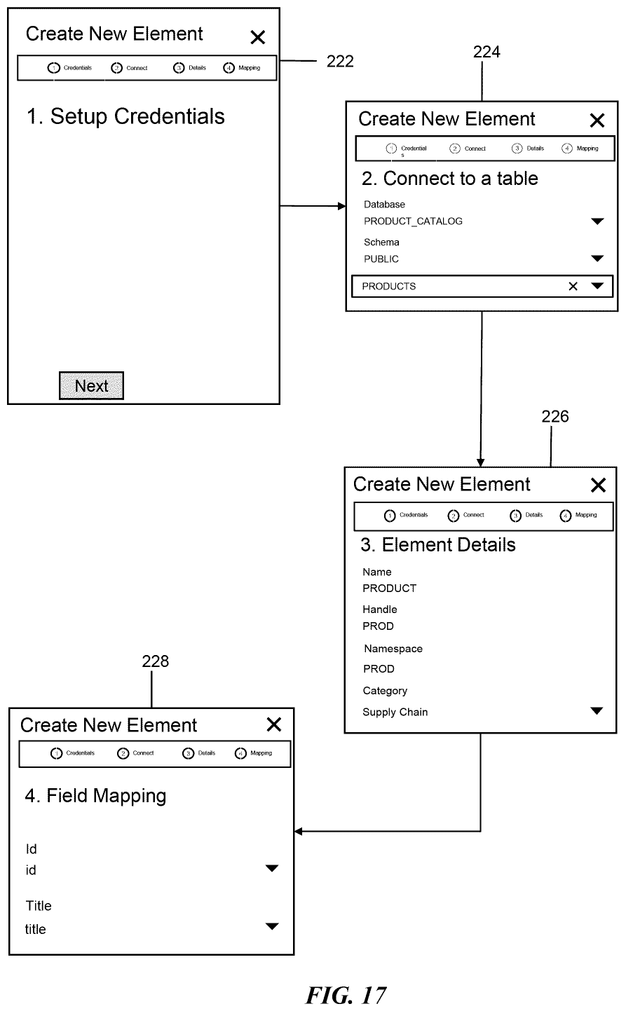

Referring to FIG. 16, with secure and efficiently-administered access (138) on a platform-independent basis as discussed above, making additional data available on a functionally-native basis may be accomplished using the Service Management Cloud (44) as shown (220): 1. log-in using credentials to connect to the Data Cloud; 2. Select pertinent tables to connect; 3. Add details in the new element, such as name, handle, and/or description; 4. Map fields by matching table fields in the Data Cloud to record fields in the element. Referring to FIG. 17, such steps are illustrated in views of a Service Management Cloud (44) session user interface (set up credentials 222; connect to a table 224; associate element details 226; configure field mapping 228).

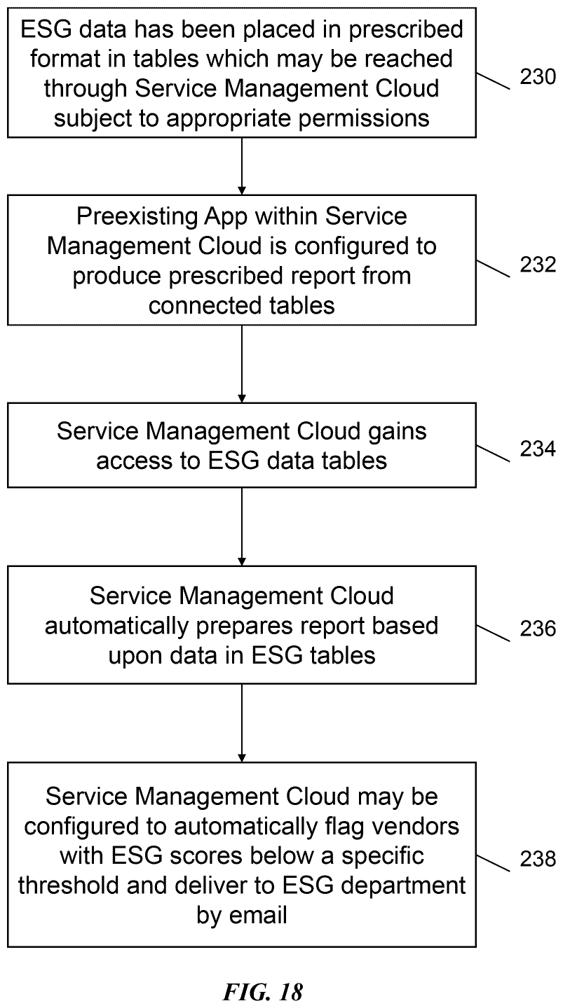

Referring to FIGS. 18-20, several use cases are illustrated for configuring and employing Service Management Cloud (44) variations in sophisticated business processes with varying levels of automation.

Referring to FIG. 18, environmental, social, and governance (“ESG”) scoring and the monitoring thereof has become a key priority in many business organizations. Data can be utilized from many sources, in many forms, with various levels of latency, certainty, and other key factors, resulting in various complexities within such business organizations FIG. 18 illustrates a scenario wherein an organization has required that all of its partners provide ESG-related data in a prescribed format, in a prescribed table, in a prescribed location such that it may be made available subject to appropriate permissions using the Service Management Cloud (44). Thus ESG data has been placed in the prescribed format in tables which may be reached through the Service Management Cloud (44) subject to the appropriate permissions (230); to facilitate efficient and automatic use of the relatively standardized and predictable data from the various partners, a pre-existing App may be created and configured to automatically (236) produce a prescribed record or report (232) based upon connectivity (234) with the ESG data tables. Further the Service Management Cloud (44) may be configured to automatically flag vendors or partners with ESG scores that may be below a specific predetermined or customizable threshold, and automatically deliver such information, such as via an emailed written report document or an electronic notification to a Service Management Cloud (44) dashboard interface, smart phone, or the like (238).

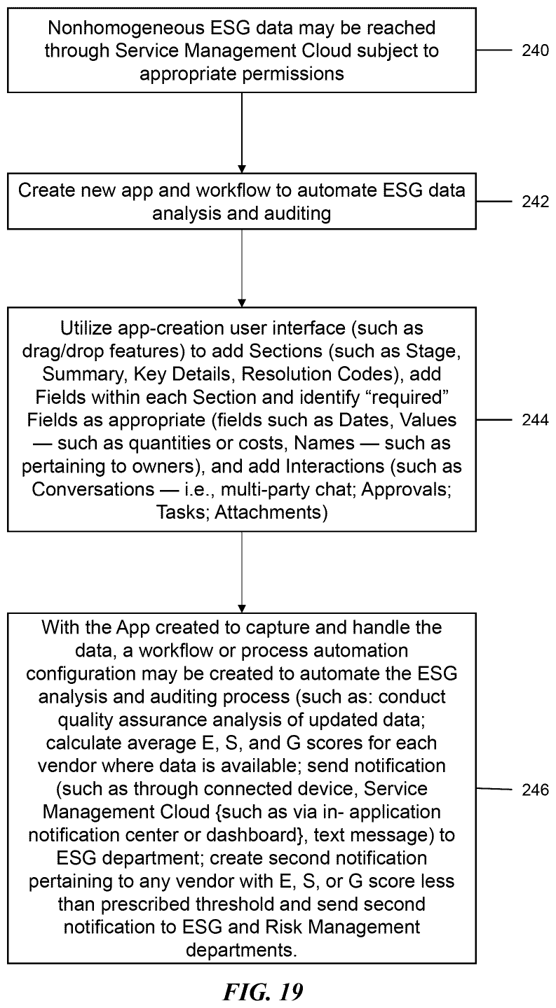

Referring to FIG. 19, an embodiment is illustrated pertaining to ESG analysis wherein available data may not be homogeneous or standardized, but rather made available through the Service Management Cloud (44) in non-homogenous form (240). In such case, rather than using or modifying one of several pre-created Apps available on the Service Management Cloud (44), an operator of the Service Management Cloud (44) may create a custom App to operate within the Service Management Cloud (44) using sophisticated and simplified (“no-code” and/or “drag-and-drop” configuration interfaces of the Service Management Cloud). Details about the user interface and systems for the workflow creation are described later herein. Referring again to FIG. 19, a user may utilize an app-creation user interface (such as drag/drop features) to add Sections (such as Stage, Summary, Key Details, Resolution Codes), add Fields within each Section and identify “required” Fields as appropriate (fields such as Dates, Values—such as quantities or costs, Names—such as pertaining to owners), and add Interactions (such as Conversations—i.e., multi-party chat; Approvals; Tasks; Attachments; Update Component) (244). With the App created to capture and handle the data, a workflow or process automation configuration may be created to automate the ESG analysis and auditing process (such as: conduct quality assurance analysis of updated data; calculate average E, S, and G scores for each vendor where data is available; send notification (such as through connected device, Data-driven workflow platform {such as via in-application notification center or dashboard}, text message) to ESG department; create second notification pertaining to any vendor with E, S, or G score less than prescribed threshold and send second notification to ESG and Risk Management departments (246).

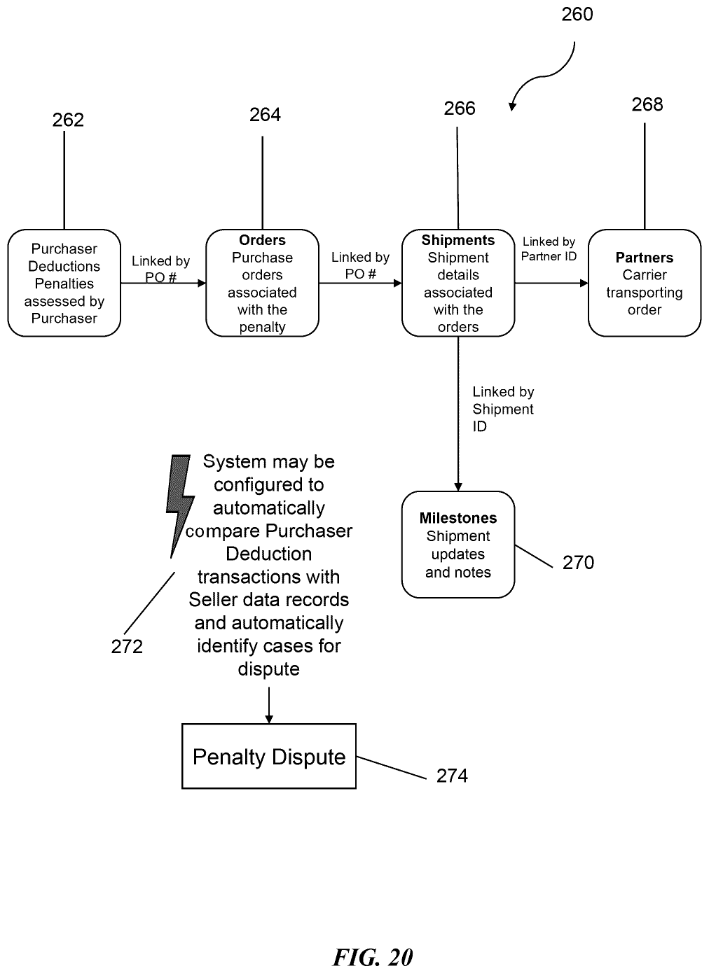

Referring to FIG. 20, a supply-chain-related business process challenge may be automated using configuration of the subject Service Management Cloud (44). A particular Purchaser (such as a large Fortune 500 entity) may require that all Suppliers/Partners precisely meet their delivery needs (i.e., orders are timely, not over, not under, not damaged, etc.) or they will be issued a Penalty fine that is payable and not disputable unless disputed within a relatively short window of time after the Penalty is provisionally issued. With many operators involved from within and outside of a particular Supplier/Partner organization (for example, Partner manufacturing, shipping, logistics personnel; vendor logistics personnel; potential information made available in the Data Cloud via outside vendors such as Project 44, which may geo-track shipping containers and the like, etc.), appropriately flagging and supporting potential Penalty disputes may be very challenging (and, indeed, as a result, many simply may not be disputed in time, resulting in significant operating costs for the various players). In some embodiments, a custom App may be created to bring in any proposed Purchaser Deductions or Penalties (262), original Order information (264), pertinent Shipping information (266), information from Partners (268), final shipment/arrival and other milestone information (270), and automatically (272) and efficiently create a package of information to be utilized in support of a penalty dispute (274) with the Purchaser, and which can be automatically submitted to the Purchaser's dispute resolution portal via automatically-generated workflows from the Service Management Cloud.

With additional data and experience in solving various business challenges automatically, and with the significant amount of data that continues to be updated and aggregated using various instantiations of the Service Management Cloud (44), neural network configurations may be created to assist users and organizations in addressing various business challenges based upon correlations, labeled data, heuristics and algorithms, and reinforcement learning models based upon business goals. Further, the subject Service Management Cloud (44) systems may be configured to automatically identify gaps in various datasets, tables, and/or documents, and to seek to bridge such gaps automatically. For example, in one embodiment, in a configuration wherein an App or process is configured to utilize certain information from “Purchase Order” documents, such as in a business process automation configuration, and wherein a given Purchase Order has all information required but is missing the Supplier's physical mailing address, the system may be configured to identify the Supplier based upon a unique SKU or other field in the data, and to provide the Supplier's physical mailing address from other data linked to the Supplier.

### Data-Driven Automation

As described above, the data-driven workflow platform herein may allow for no-code automation of processes at various levels. In some embodiments, the platform may provide a graphical user interface (GUI) allowing users to configure, create and manage automations thereby initiating workflows upon a change in the data. In some cases, the automation may be created by defining a rule for automating an action triggered by a triggering event of selected data objects. In some cases, the rule may comprise a definition of a triggering event, a definition of condition for executing an action, and a definition of the action.

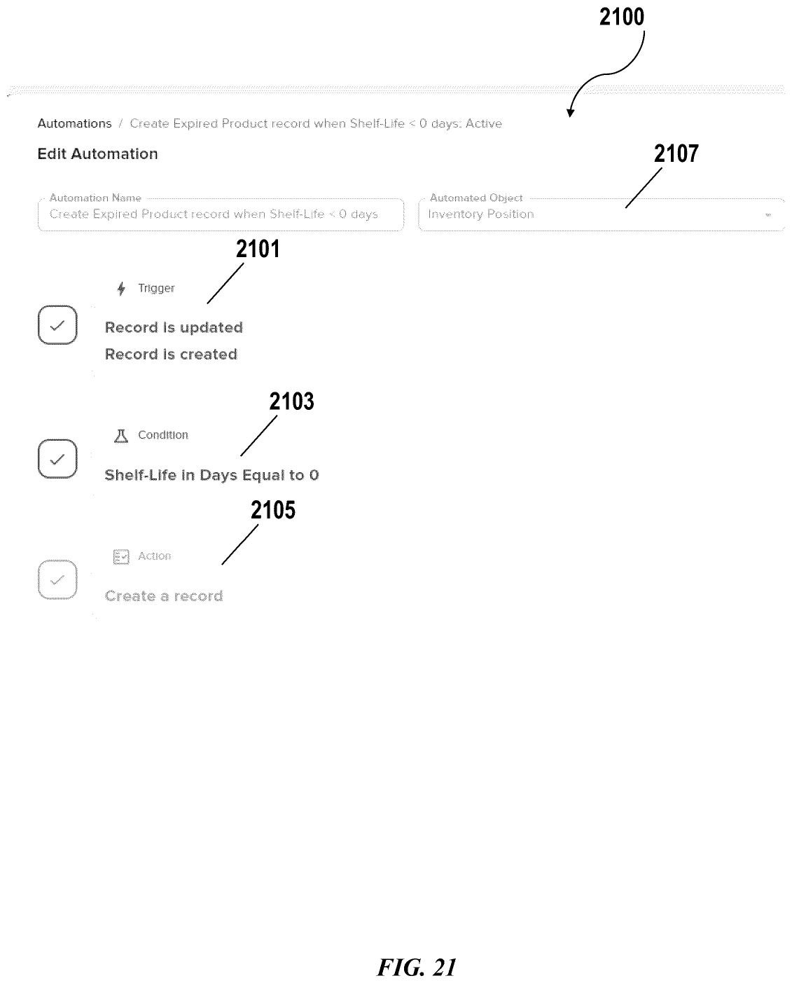

FIGS. 21-23 show examples of GUIs for creating and/or editing an automation. As shown in FIG. 21, the GUI 2100 may allow users to create, modify or edit an automation with a plurality of configurable fields. For example, the automation GUI 2100 may provide at least three fields including trigger 2101, condition 2103 and action 2105 allowing for convenient configuration of a triggers-conditions-actions type of automation.

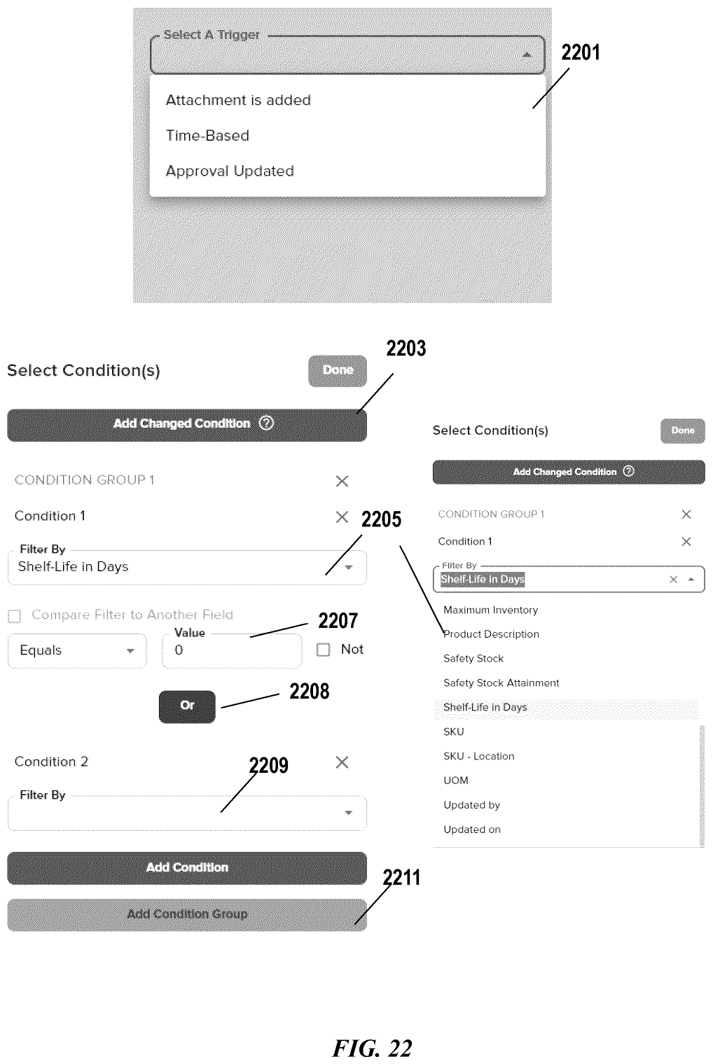

In some embodiments, the automation may be data-driven. For instance, each field (e.g., trigger 2101, condition 2103 and action 2105) may be configurable with auto-populated values or data fields. The auto-populated values or data fields may be dynamically determined based on the connected data objects 2017. For example, upon setting up the automated object 2107, a drop-down menu 2201 with dynamically populated options (e.g., attachment is added, time-based, approval updated) may be provided as shown in FIG. 22. A user may be permitted to assign a trigger based on record create, state update, data change, quantity change, value change or various other type of triggering event. A user may select from the list of options 2201 to set up the triggering event. In some cases, the options provided in the drop-down menu 2201 may change dynamically according to the connected data objects. For example, the trigger options may indicate the data field (e.g., column) upon which a change may trigger an action. In another example, a trigger may include an action/operation executed in the connected cloud database (e.g., creation of a new record).

In some cases, a user may be permitted to define the conditions for the trigger. A condition may define the particular value or state of a condition for the trigger. For example, the condition may be a new stage, days until or past due date, quantity over or under a threshold and the like. As illustrated in FIG. 22, the GUI may also allow a user to set up or define the conditions via a condition panel 2203. The condition panel 2203 may provide data fields such as filter by 2205 with auto-populated options. A user may select from a list of options provided in the drop-down menu 2205 to select a column to apply the filter. In some cases, the list of options may be automatically populated based on the connected data objects. A user may be permitted to further define the condition(s) for the filter (e.g., no value, greater than, equal, less than, between, greater than or equals, less than or equals, etc.) via the condition panel 2203. For example, a user may define a threshold value 2207 and relationship (e.g., equals) to apply the filter. In some cases, a user may create compound conditions (e.g., condition group) via the operator (e.g., AND, OR) 2208 to combine multiple conditions (e.g., filters) 2209. The GUI 2203 may also allow users to create complex conditions such as by adding a condition or a condition group 2211. The condition group may be added via any suitable operations (e.g., AND). The trigger event, and conditions may then be converted to a query language (e.g., Structured Query Language (SQL)) compatible with the database technology supported by the connected data cloud. In some cases, the trigger and condition of the trigger may be implemented via a data mining feature of the platform. For example, the data mining capability may automatically detect a change in the data as defined by the triggering event and the condition. Details about the data mining feature are described later herein.

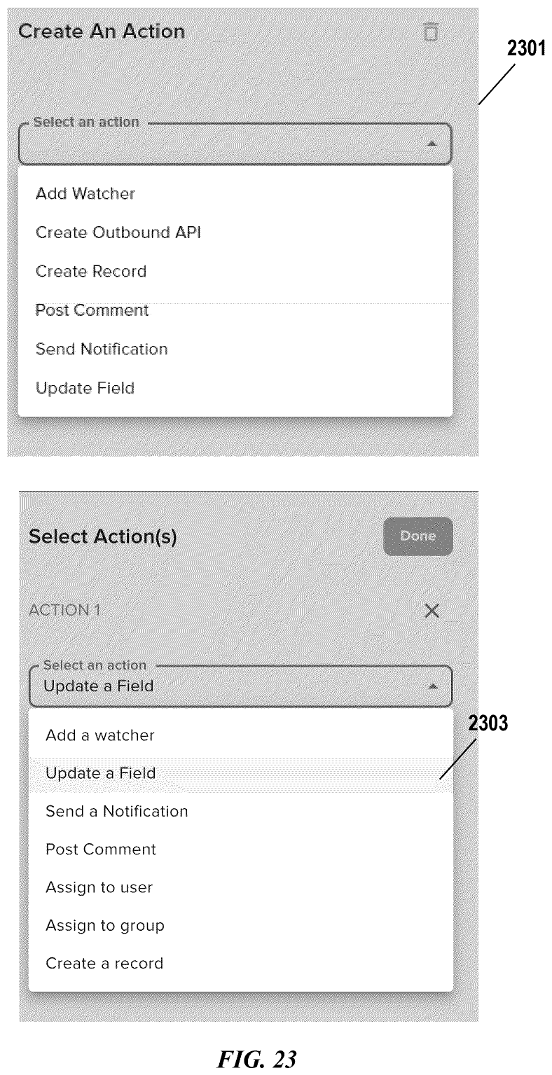

FIG. 23 shows examples of the GUI for a user to create an action. An action may be related to assigning an owner, escalate an alert, updating a selected data field, placing an order and various others. As shown in the example, a user may select an action from a drop-down menu 2302 presenting a list of action options. The action options may be dynamically determined based on the connected objects. As shown in the example, the actions may include, without limiting, Add Watcher, create outbound API, create record, post comment, send notification update field, assign to user, assign to group and the like. In some cases, the action may involve directly adding or modifying data within the connected data cloud. For instance, execution of an action may call an API directly to a Cloud Service (e.g., Salesforce) to perform an action (e.g., add a new data record in a new column or table in the data cloud) or update the source data objects (e.g., update a field 2303). Such automated write-backs capability as described elsewhere herein may beneficially allowing for reduced latency and improved efficiency without the need of transformation or data cleansing as required by conventional ETL.

In some cases, the list of options for defining the trigger and/or the actions may be fixed across different connected data objects. For instance, the trigger options and/or actions may be pre-built based on industry knowledge and expertise. For example, the trigger options and/or actions may be built on top of the connected data cloud monitoring service (e.g., available API calls). Alternatively, the auto-populated list of options for defining an action and/or trigger may be provided dynamically based on the selected data objects. The auto-populated list of options may be determined based on pre-determined rules, industry knowledge and expertise, and/or data pattern extracted from past data. For instance, different action options may be mapped to different type of data objects. In some cases, the list of action options may be provided dynamically according to past behavior associated with a user, an organization, an industry and the like. For example, the action menu for a first user/industry may be different from the action menu presented to a second user/industry based on the past data associated with the user/industry. In some cases, action options may be provided dynamically based on time. For example, different menus or options may be provided based on different times of the year (e.g., different months, different seasons, etc.).

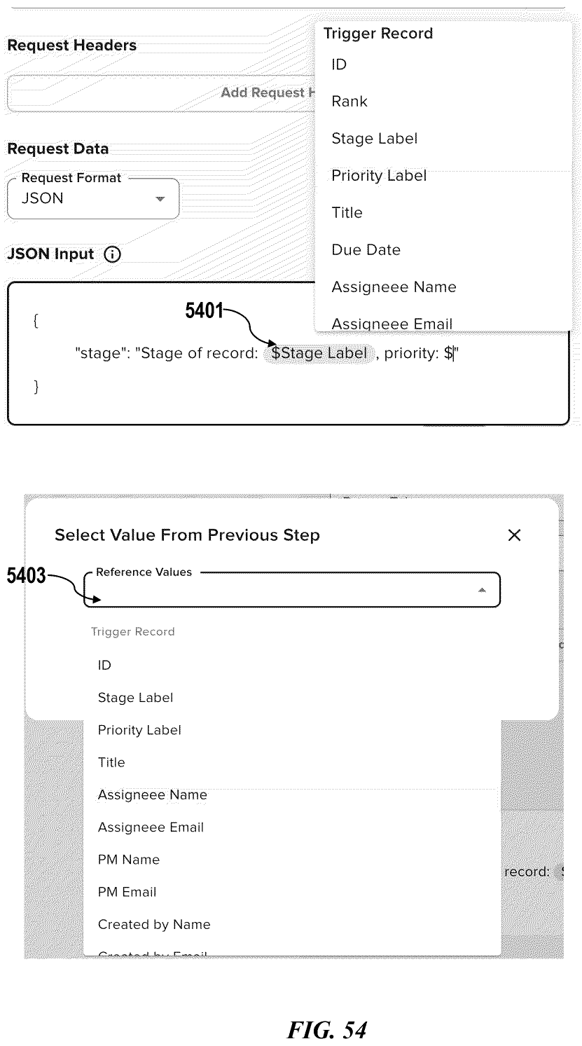

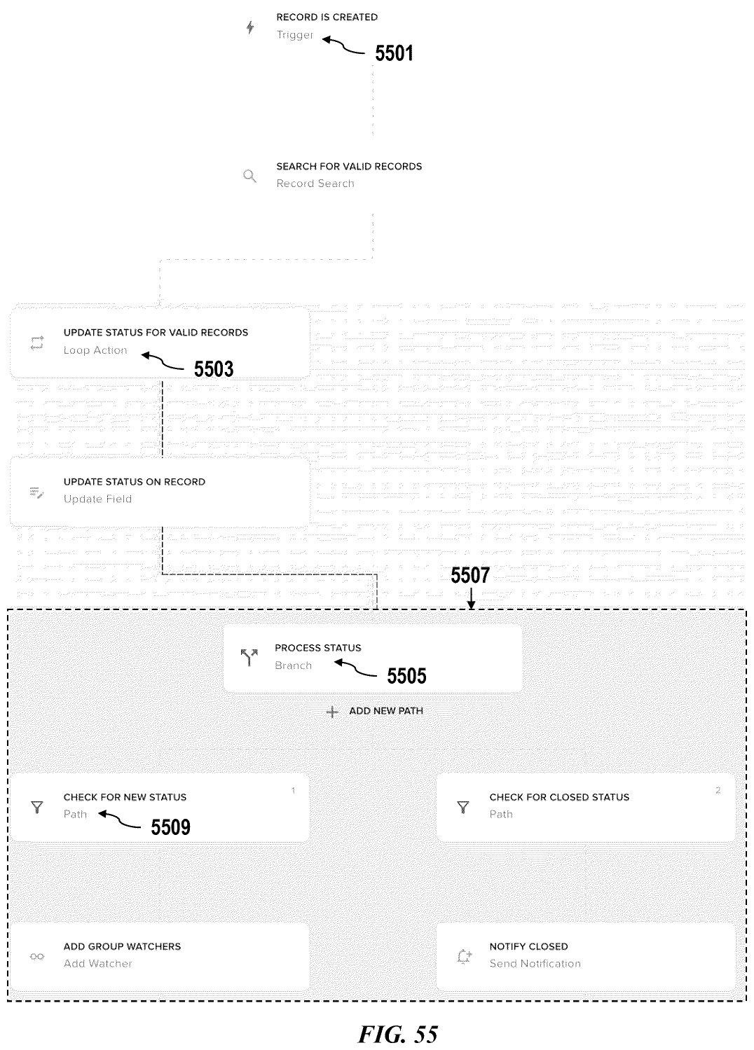

FIGS. 54 and 55 show examples of GUI for automation flow. As described above, the automation flow is a no-code automation platform that gives access to system functions and control flow on top of the data cloud data without requiring programming expertise. The system herein may provide available variables for each action in the automation flow. A user may use functions presented via the GUI such as a ‘link’ button and/or operators (e.g., $ operator) to identify variables out of the automation (e.g., variables from a previous step of the automation process) and use the variables in the one or more actions. The variables may be from original data and/or intermediate data generated by any step of the automation process.

FIG. 54 shows an example of the GUI permitting using an operator (e.g., operator $) 5401 to create a custom payload in the API integration. The API may permit sending a custom message to an external API, such as a Slack API, based on dynamic variables from the automation. The GUI may also permit selecting a link value from an automation. For example, a dropdown menu 5403 may display options filtered down to only valid options (data fields) to beneficially ensure the automation can run successfully. As shown in the example, a user may select from the dropdown menu a reference value for the Trigger Record variable.

The GUI may also permit users to control a flow of the automation by advanced logics without requiring coding or programming skills. As shown in FIG. 55, the GUI may permit users to access data in the data cloud to set up or change a trigger 5501 to start the automation. The system may provide one or more advance logics in a visual manner. The advance logics provided by the system are intuitive without requiring coding skills. For example, logics such as loop and if-statement logic may be provided as Loop and Branch on the GUI for a user to control the flow of the automation. Users may use the advanced logic on the automation variables to control automation flow by selecting a dynamic variable, a logical operator such as equals or less/greater than, and another dynamic variable to compare with. FIG. 55 shows an example of a GUI for controlling the automation flow using visual features such as Loops 5503 and Branches 5505. As shown in the exemplary flow, the Loop Action 5503 in the automation may control the flow to search for all the valid records and one-by-one runs the sub-workflow 5507 on each found record in the record search. The automation flow may then use a Branch Action 5505 to perform if-statement logic checking to execute other actions based on the checks found in the Branch's Path 5509.

The GUI provided by the system may hide complex programming concepts such as types and variable scope from the user to make leveraging the data in the automation more user friendly. Functions that are intuitive may be provided and the associated complex programming concepts may be determined by the system automatically. For instance, a user may provide input such as referencing lists of data and/or running sub-processes against each piece of data in the list while the types and variable scope are automatically determined by the system upon the user input.

In some embodiments, in addition to the GUI for creating or defining an automation, the data-driven workflow platform herein may provide smart automations or automation recommendations utilizing artificial intelligence (AI) technology. For example, an AI model may be trained using past actions, conditions, and trigger data and the connected data objects. Once trained, the AI model may be capable of automatically determining a trigger condition (e.g., condition value) and/or action for recommendation to a user.

### Dynamic Relationship and Data Model

The data-driven workflow platform as described herein may allow users to create dynamic relationships within data. Such dynamic relationship capability beneficially allows for flexible rules to join data elements together. For example, a user may understand that certain elements such as the master and transactional data is related: the shipment is related to the port of entry, the SKU is related to the PO, the computer is related to the vendor. When something happens upstream (e.g., automation is triggered upstream), such upstream data can be used to identify the impacts downstream, thus avoiding the delays (e.g., days or weeks) to identify the impact.

In some embodiments, a relationship may be created by joining data models or elements of data models within the platform. As described above, the Data-driven workflow platform may comprise adaptors configured to connect to data objects in a cloud repository. The adapter may allow a user to map fields between the storage data models of the platform and table fields in the Data Cloud. The storage data models in the platform may comprise different types of datasets. In some cases, the different types of data may include, for example, such as “elements,” “tasks.” “applications,” and the like. The adapter may enable the data hosted in the data cloud (e.g., Snowflake) to appear as native inside of the platform. For example, as illustrated in FIG. 17, the adaptor may provide a GUI allowing a user to set up a mapping and data type matching. For instance, a user may assign a data type (e.g., transaction, element, application, etc.) to the data field or table of the data hosted in the data cloud. For example, for creating an ESG application, the adaptor may connect to tables stored in the data cloud, and the platform may automatically identify elements such as suppliers, product, economic, environmental, labor, social, etc., related to the ESG application, and display a GUI with auto-populated fields allowing a user to assign a data type to the extracted elements. For example, a user may assign data type an element type to Suppliers and Products (e.g., master/static data), or assign an element type to Economic, Environmental, Labor and/or Social (e.g., transactional/streaming data). Such operation may not apply any modification or change to the data in the data cloud.

A relationship may be created between the storage data models within the platform. The storage data models provided by the platform may dynamically map the relationships within the cloud data. For example, a relationship may be created between an “element” type data named “Products” that contains the complete listing of all products a customer makes or sells and a “transaction” type data named “Inventory Positions” that indicates how much of each product a customer has on-hand.

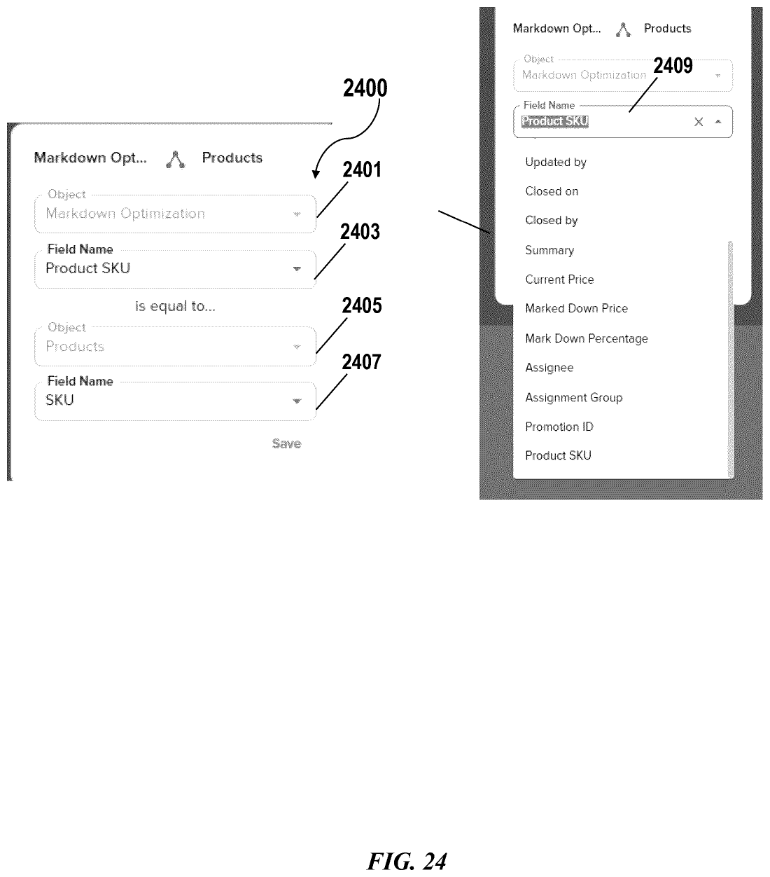

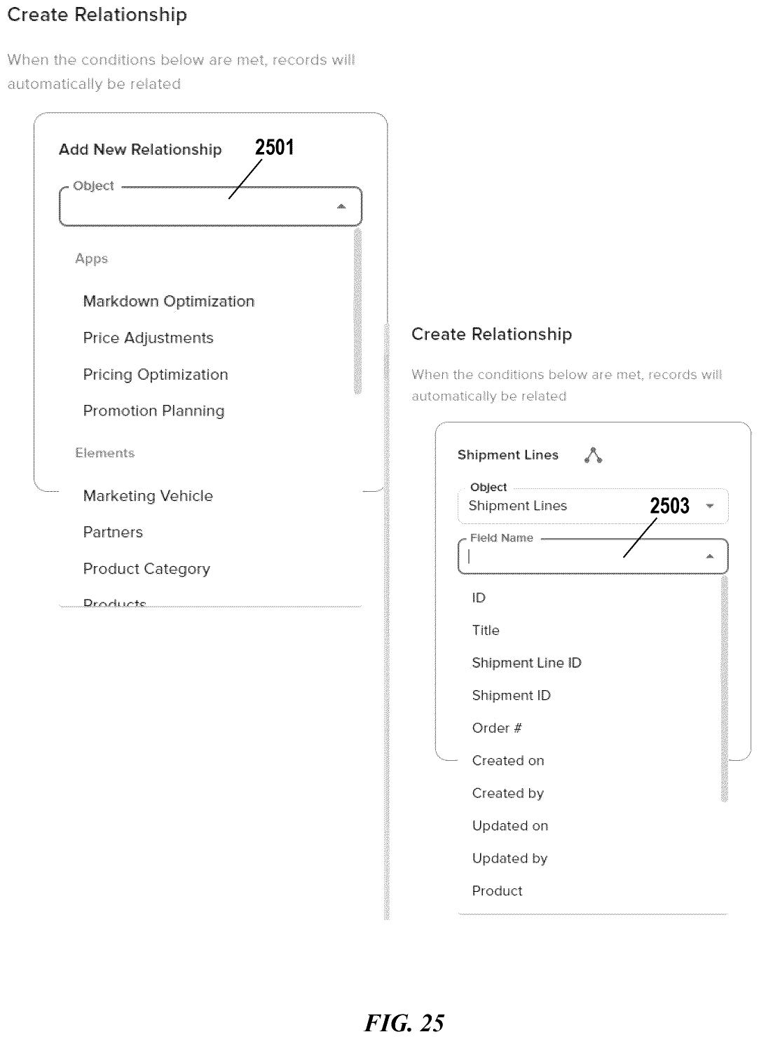

In some cases, a relationship may be created manually by a user via a GUI provided by the platform. FIGS. 24 and 25 show examples of GUI for a creating or adding a relationship. As shown in FIG. 24, the GUI 2400 may provide fields for a user to create a relationship (e.g., equal to) by selecting one or more data fields 2403 of a first data model or element of a first data model 2401 and selecting one or more data fields 2405 of a second data model or element of a second data model 2407. The field name options may be automatically populated in a drop-down menu 240) for the selected object. As illustrated in FIG. 25, the relationship can be created between two objects of various data types as defined within the platform. For example, the object 2501 may be an application type, element type or transaction type. Upon selection of an object 2501, the associated data fields 2503 may be provided in the drop-down menu for selection.

In some cases, a relationship may be created automatically without user intervention. For instance, the platform may analyze the storage data models within the platform and may recommend creating relationships automatically. For example, the platform may automatically identify that a data model “Inventory” having a column named “sku” should be related to a “Products” data model having a column named “sku.” The platform may generate a recommendation to the user to setup the recommended relationship. A user may choose to accept, reject or modify the recommended relationship. In some cases, the platform may develop an AI model for automatically identifying a relationship. Alternatively, the relationship may be identified based on pre-determined rules (e.g., build relationships based on common identifiers, expert knowledge, or other criterion). The platform may also permit users to manage and share all the relationships created for one or more applications. A user may view the relationships in real-time, dynamically modify the relationship at any point in time and make decisions based on the multi-tier organization.

### No-Code Application Creation

As described above, the Data-driven workflow platform provide a no-code configuration interfaces for creating cloud applications. The platform may allow users to create, customize and/or configure cloud applications via a no-code user interface with built-in features such as configurable and automated workflows and dynamic relationships discovery and creation. In some cases, the platform may provide pre-built applications such that a user may further customize the pre-built application via a “drag-and-drop” GUI. For instance, the platform may provide initial “pre-built” automations for “App Suites” (e.g., Inventory Management or Merchandising). In some cases, these initial automations may be generated based on industry knowledge and expertise.

The platform may automatically provide initial workflows based on the connected data objects. In some cases, the platform may initiate workflows automatically based on the connected data objects and may allow for collaboration securely with third parties. The workflow may be highly configurable with computations, approvals, tasks, analytics, automations and the like.

The platform may automatically select from a library of app suites, including logistics, merchandising, inventory management, risk management, procurement, finance, HR, business development, and the like based on the connected data objects. For instance, based on insights extracted from the cloud data (e.g., data mining), the platform may select an initial application/workflow from the library of app suites.

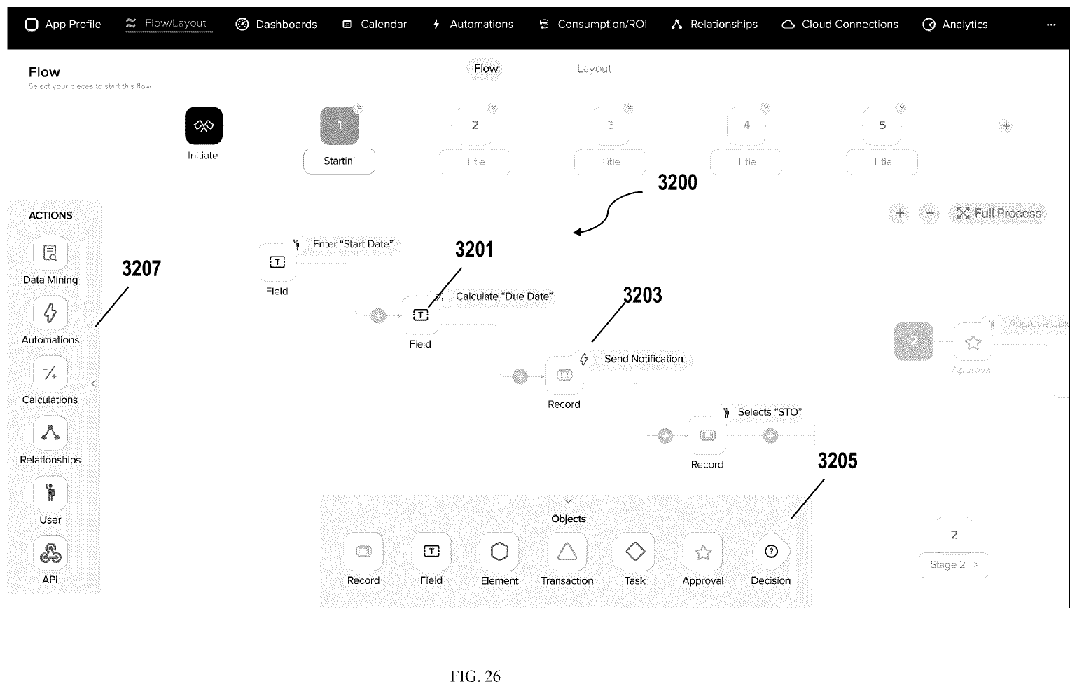

In some cases, the platform may provide a GUI for a user to configure or edit a pre-built workflow. This beneficially allows for a no-code creation of cloud applications with pre-built automations. FIG. 26 shows an example of a GUI 3200 for creating workflows. The initial workflow may be created with pre-built automations 3203 in one or more locations. A user may modify the initial workflow via drag-and-drop functions. For example, a user may add an object 3201 such as a task, record, element, transaction, approval, field to the workflow in any desired location by dragging the component from the “object” panel 3205 and dropping it to the workflow. A user may be permitted to further add actions to a selected object by dragging an element (e.g., data mining, automation, calculations, relationship, assign user, API, etc.) from the actions panel 3207 to an object in the workflow. In some cases, a user may add an object and/or action by clicking on a graphical element 3203 (e.g., plus icon for adding an object or an object icon) in the workflow to activate a menu for selecting the object and/or action to be added. In some cases, a user may choose to delete or modify an action (e.g., automation) or object that is provided in the initial workflow by interacting with the graphical element corresponding to the action or object.

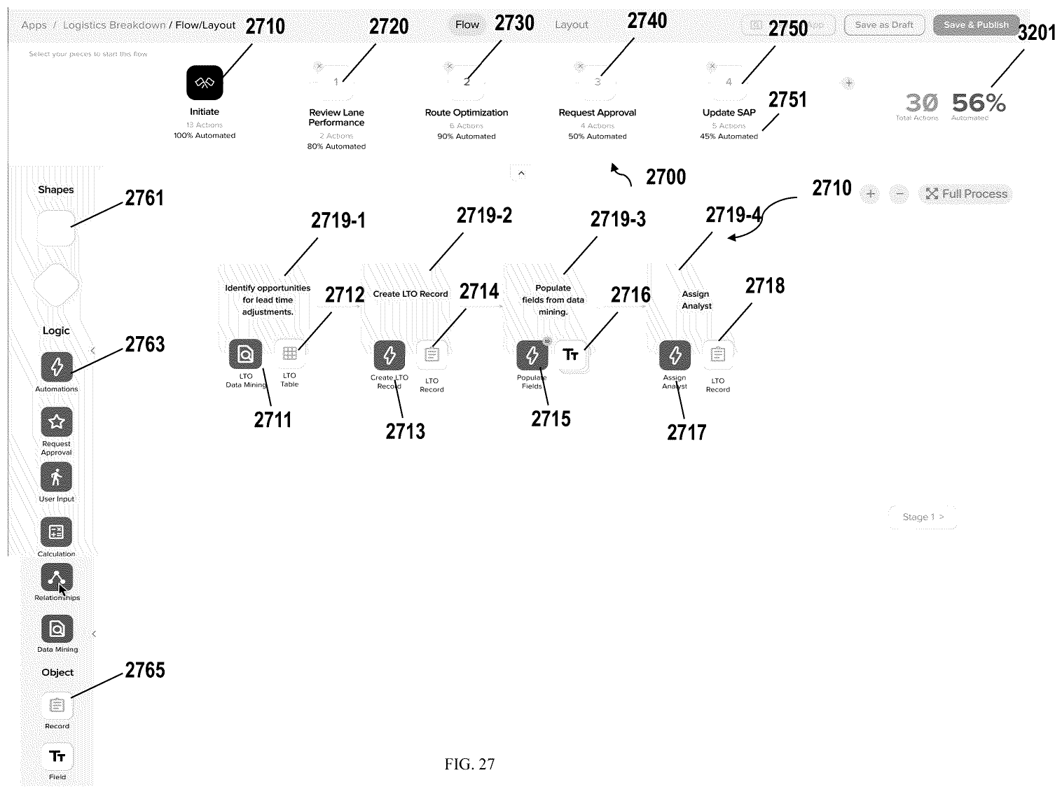

FIGS. 27-30 shows another example of a GUI for creating workflows. As shown in FIG. 27, the GUI may display a workflow with one or more stages 2710, 2720, 2730, 2740, 2750. The GUI may display general information related to each stage such as the number of actions included in each stage and percentage of automation 2751. Different stages may have different automation percentage. As an example illustrated in FIG. 27, an initiate stage 2710 may be 100% automated. The initial stage may comprise a plurality of actions 2719-1, 2719-2, 2719-3, 27194. In some cases, an action may include a logic 2711, 2713, 2715, 2717 and an object 2712, 2714, 2716, 2718. The logic and object may define “who” (logic) does “what” (object). A logic may be, for example, automations, request approval, user input, calculation, relationship, data mining and the like. An object may be, for example, record, field, table, summary and various other objects/elements provided by the system. In some cases, a user may modify a workflow by dragging an element from the panel (left panel) and dropping to the workflow. The panel may provide, for example, shapes 2761 (e.g., square shape may be used to represent Action, diamond shape may be used to represent decision), logic options 2763 and a list of objects 2765. The GUI may also display information related to the overall process such as the percentage of automation and total number of actions 3201 in the entire process/workflow.

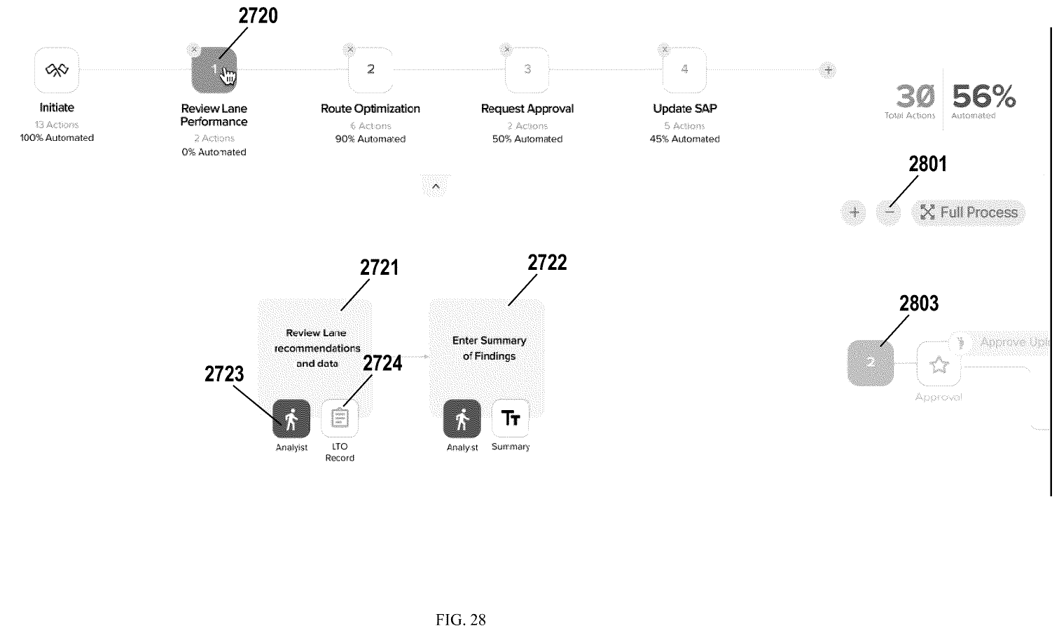

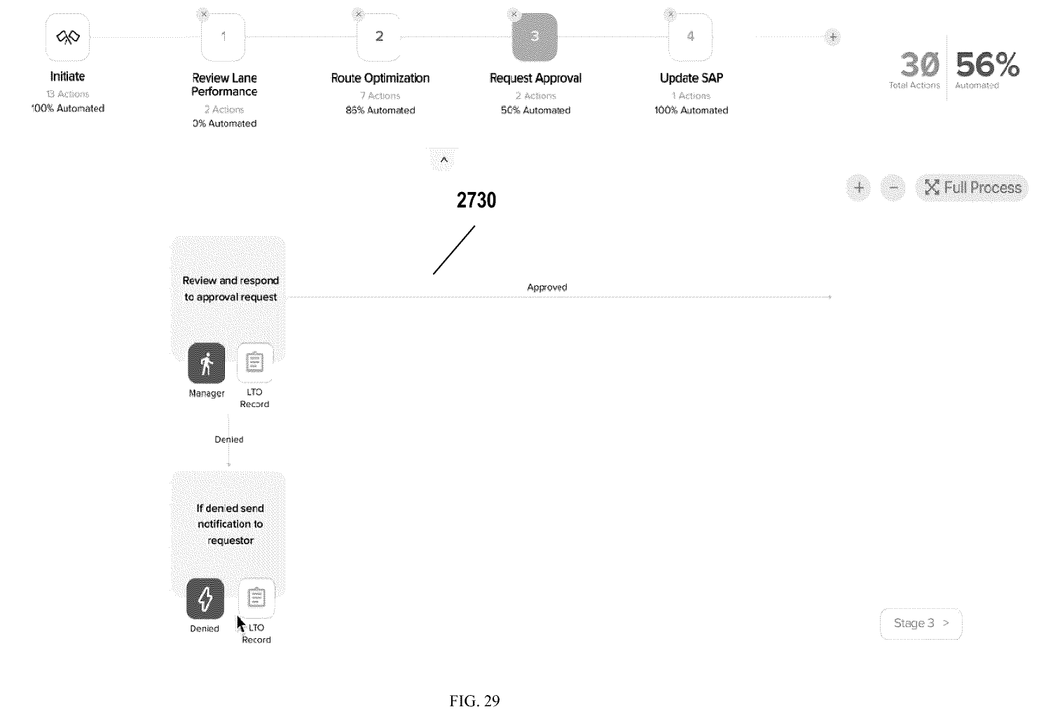

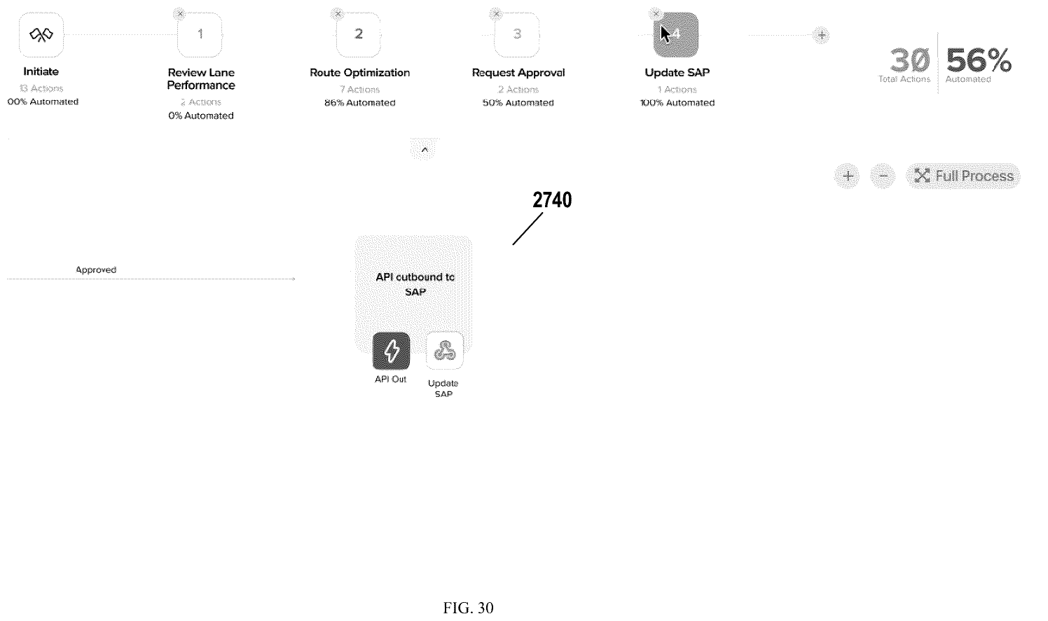

FIG. 28 shows an example of GUI displaying a workflow for the second stage 2720. Similarly, the second stage workflow may comprise one or more actions 2721, 2722 and each action may include logic 2723 and object 2724. In some cases, an initial workflow for a stage may be recommended by the system and displayed on the GUI then a user may choose to accept, modify or rejection any components of the workflow. In some cases, a user may be permitted to zoom in/out from any stage to view the full process 2801. The GUI may also display a preview 2803 of the next stage. FIG. 29 shows an example of GUI displaying a workflow for the third stage 2730. In the example, the workflow may be 50% automated because one action includes human analyst and the other action includes an automation. FIG. 30 shows an example of GUI displaying a workflow for the fourth stage 2740.

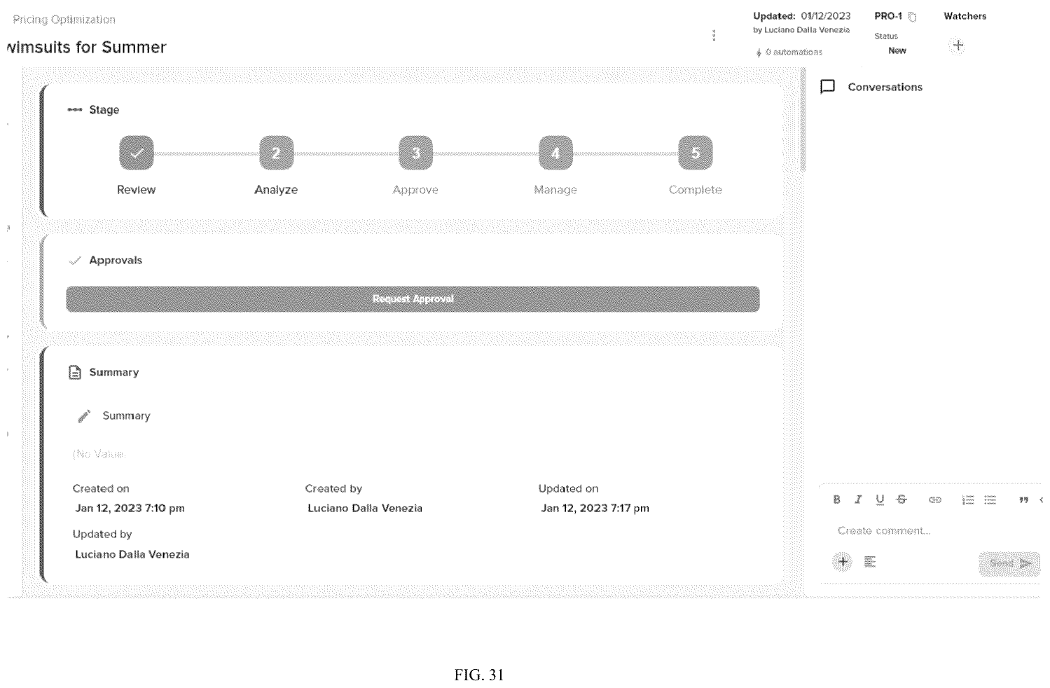

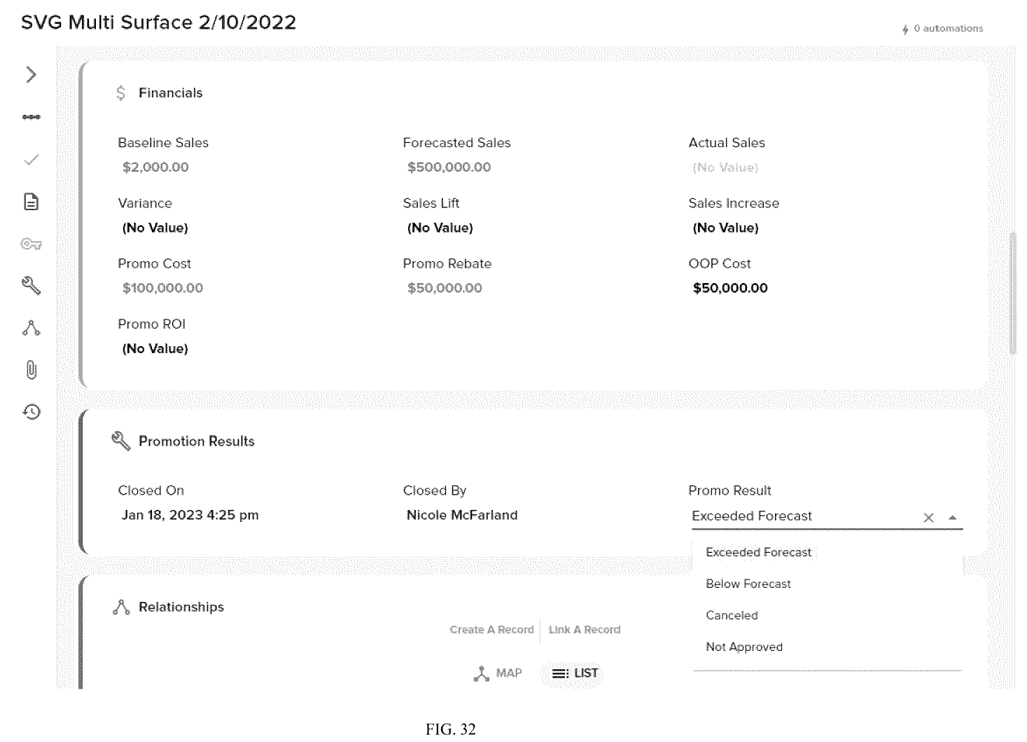

FIG. 31 shows an example of GUI displaying a created workflow with tracked progress. As illustrated in FIG. 31 and FIG. 32, once a workflow is deployed and executed, details about the data analytics, computation, actions, progress and the like may be displayed to a user on the GUI.

### Examples of Use Cases

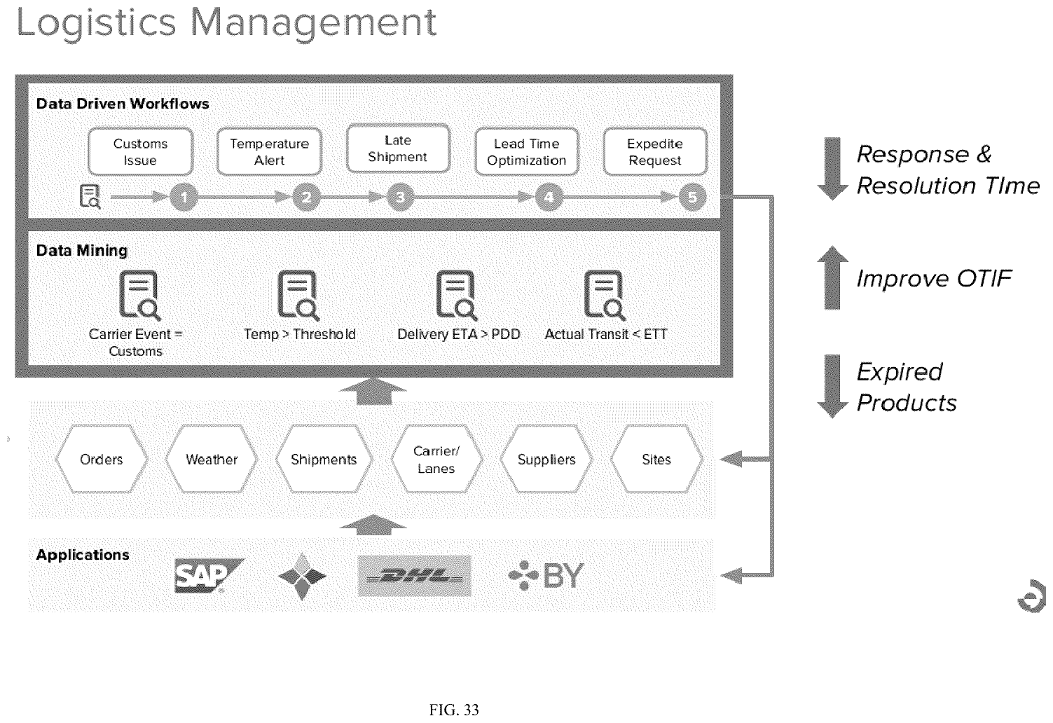

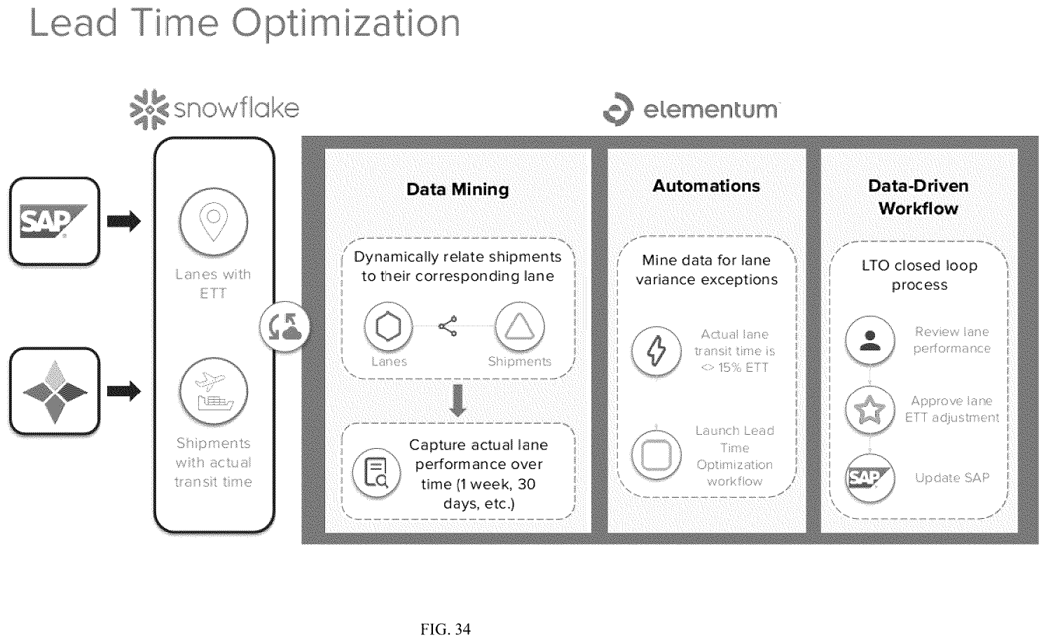

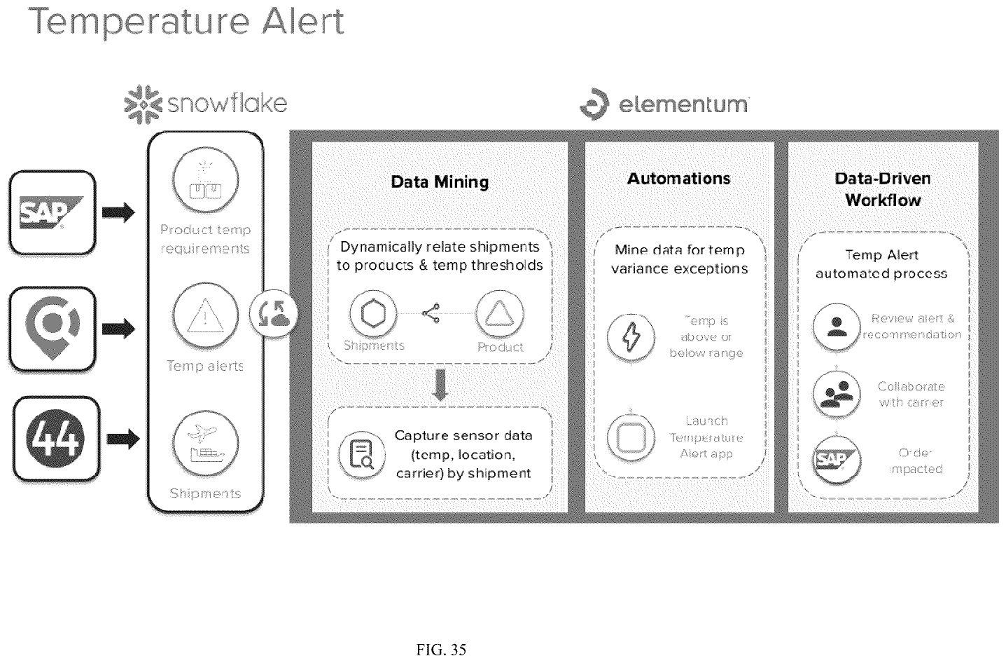

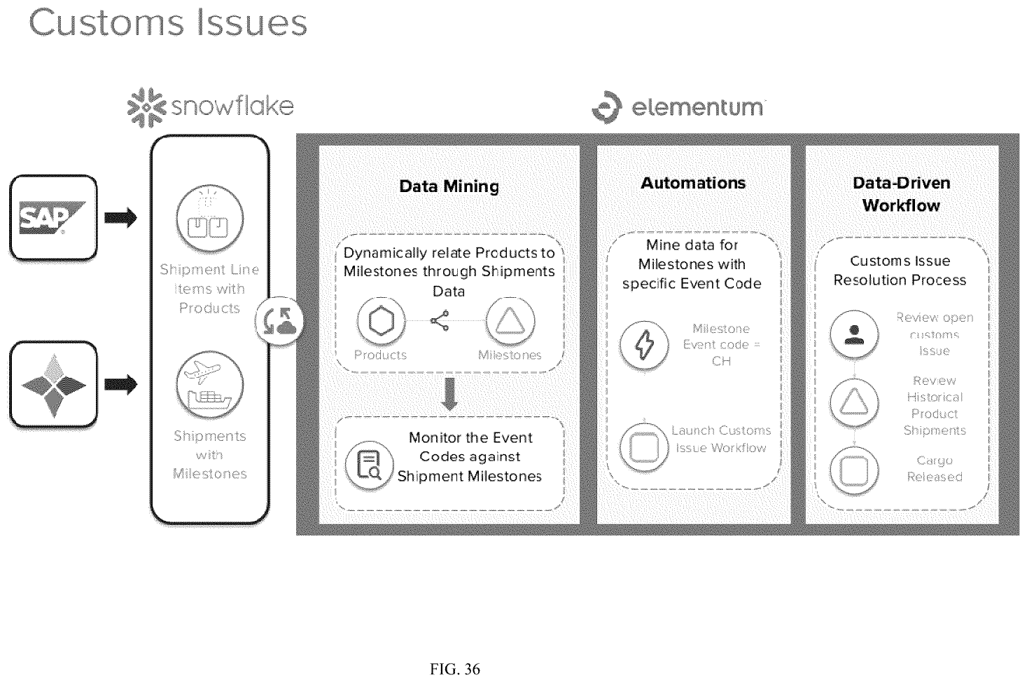

As mentioned above, the platform may automatically select an initial workflow from a library of app suites, including logistics, merchandising, inventory management, risk management, procurement, finance, HR, business development, and the like based on the connected data objects. For instance, based on insights extracted from the cloud data (e.g., data mining), the platform may select an initial application/workflow from the library of app suites. An app suite may include a plurality of workflows. FIGS. 33-38 show examples of logistics application suite. As shown in the examples, a logistics application suite may comprise a plurality of workflows. A workflow may comprise data mining to identify dynamic relationship between objects, and automations (e.g., trigger condition and action). For example, as shown in FIG. 34, the lead time optimization workflow may be provided which reduces excess inventory by proactively addressing lane variance gaps. Data connected to the workflow (e.g., Lanes, Shipments, Partners, Sites) may be mined to identify when the actual lead times are within the defined tolerance levels and actions are automated to adjust the lead time. As shown in FIG. 35, the temperature alert workflow may be provided to reduce expired product volumes by proactively managing temperature conditions during transit. Data is mined to identify-temperature issues of goods in transit. Actions are automated between the logistics team and the carrier to address the alert. The customer issues workflow as illustrated in FIG. 36 may be created to reduce customs delays by proactively managing issues.

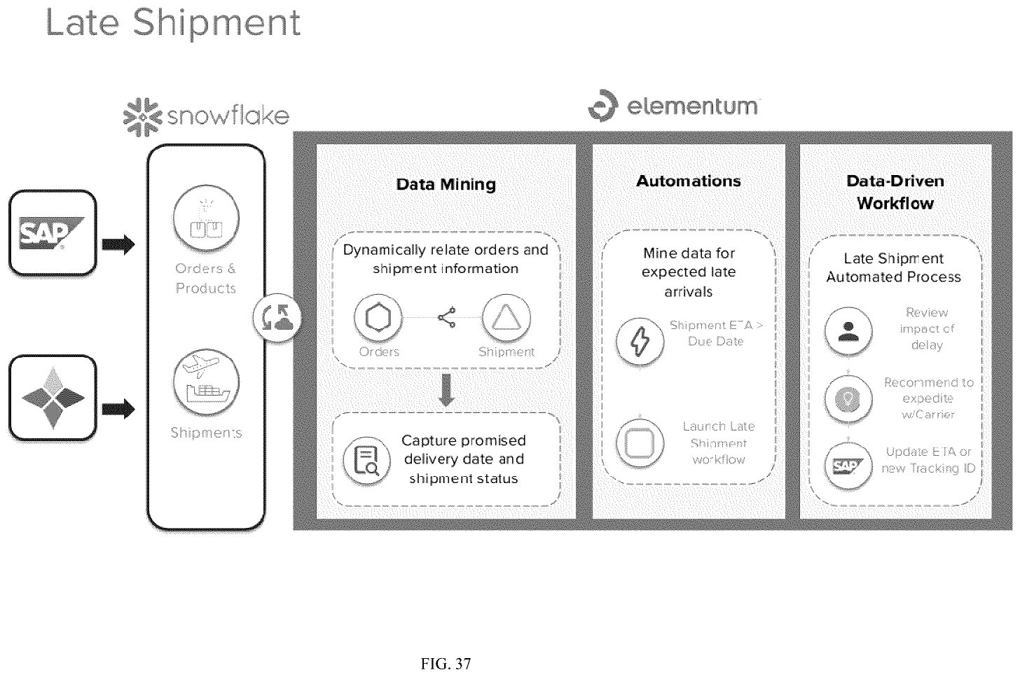

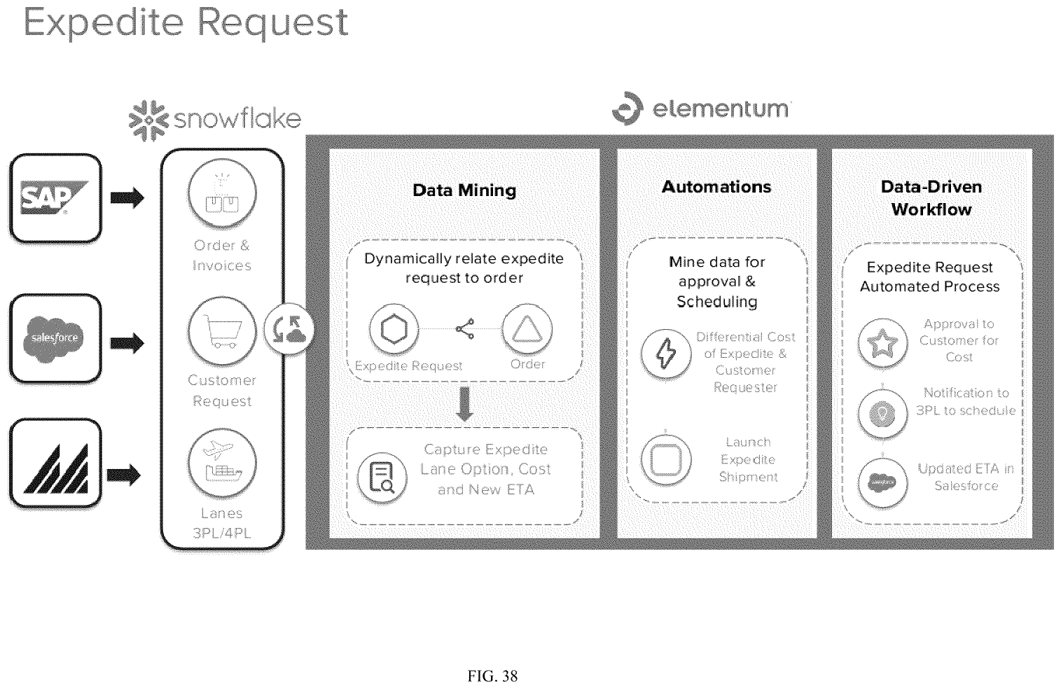

Data is mined to alert logistics of potential issues based on port congestion, strikes and other impacts to the port. Actions between logistics and the broker are automated. The late shipment workflow as illustrated in FIG. 37 may be created to improves OTIF by proactively identifying late shipments. Data is mined to identify when a shipments estimated arrival time is greater than the promised
delivery date. Actions to identify alternate sources, expedite and mitigate the delay are automated. The expedite request workflow as illustrated in FIG. 38 may be created to provide full transparency and accountability of who authorizes the cost for expedite requests is managed and centralized in one platform. Actions are automated to notify carriers, logistics and others of the approval.

### AI-Based Recommendation

In some embodiments, the initial workflow may be provided with AI-based recommendations. For instance, the platform may develop an AI model to generation predictions about when to initiate an action (e.g., location in the workflow), what action to take, or other features in the initial workflow. The AI model may be trained and developed using training datasets collected within the platform. For example, past pattern of actions may be extracted from the action or processes data defined within the platform and the data may be utilized as training data to develop the AI model. In some cases, the data fields involved in a workflow may also be predicted by an AI model.

The provided systems may employ any suitable artificial intelligence techniques to generate the workflow, identify an automation, dynamically relate identification, data model conversion (e.g., normalize original data in the cloud to conform with storage data model in the platform) and/or perform other functions as described elsewhere herein. Artificial intelligence, including machine learning algorithms, may be used to train a predictive model for predicting a recommendation (e.g., automation, workflow etc.), extracting the data relationship, normalizing data, performing impact analytics as described above, and various other functionalities as described elsewhere herein. A machine learning algorithm may be a neural network, for example. Examples of neural networks include a deep neural network, a convolutional neural network (CNN), and a recurrent neural network (RNN). The machine learning algorithm may comprise one or more of the following: a support vector machine (SVM), a naïve Bayes classification, a linear regression model, a quantile regression model, a logistic regression model, a random forest. Isolation Forest (iForest) model, a neural network, CNN, RNN, a gradient-boosted classifier or repressor, or another supervised or unsupervised machine learning algorithm (e.g., generative adversarial network (GAN), Cycle-GAN, etc.). In some cases, a machine learning algorithm trained model may be pre-trained and implemented on the provided system, and the pre-trained model may undergo continual training or refinement with custom data that may involve continual tuning of the predictive model or a component of the predictive model (e.g., classifier) to adapt to changes in the implementation environment or use application over time (e.g., changes in the user data, insight data, model performance, third-party data, etc.).

### Data Mining

The data-driven workflow may provide data mining capability that allows for extracting insights from the data in the data cloud. In some cases, the data mining feature of the platform may be utilized to trigger insights generation directly from the data within the data cloud, and/or automatically identify data events (e.g., change of data, adding/deleting data, data anomalies, or other data analytics provided by the cloud provider). The platform may provide a GUI for user to configure or set up a data mining for selected data in a convenient manner. The data mining feature may be seamlessly integrated with other functions such as Automation. For example, a data mining configuration or data mining result may be used as trigger and condition for an automation to initiate the automation or trigger actions.

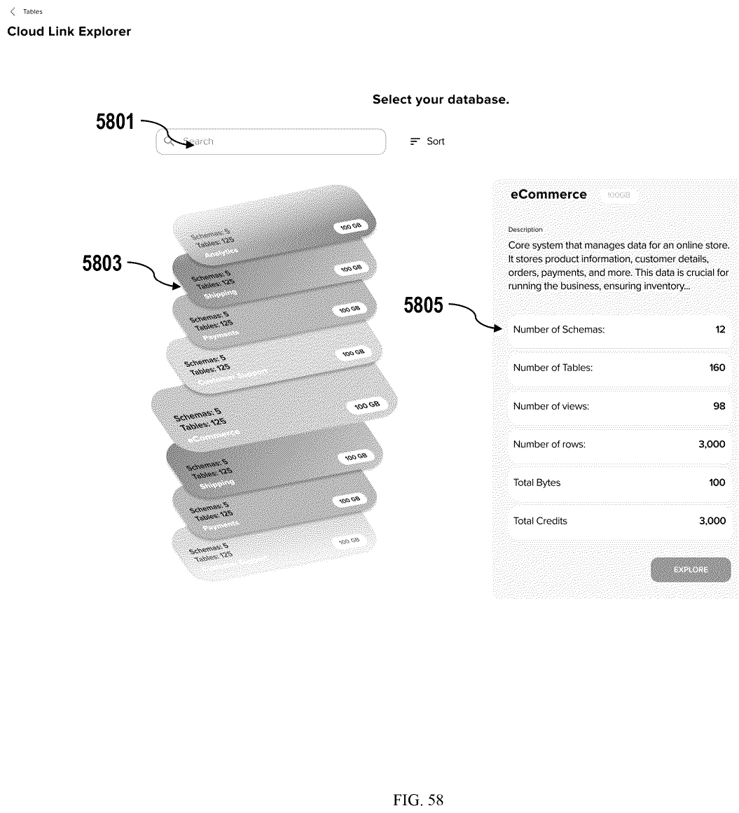

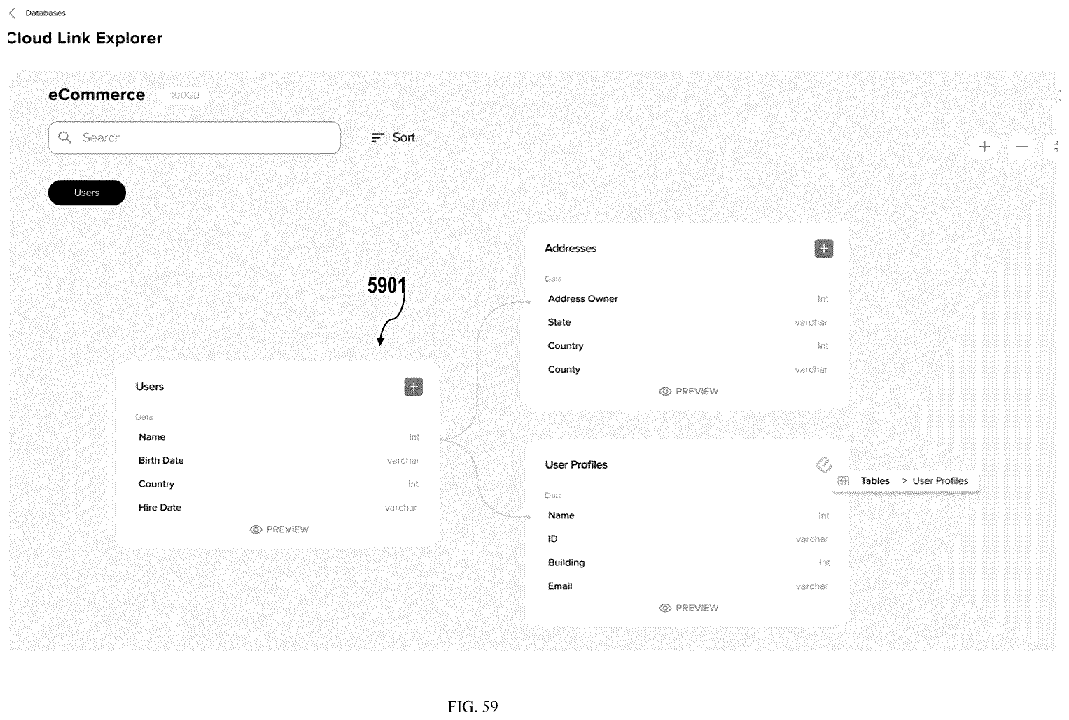

The data mining features may allow users to create a data mine to automatically start a workflow. In some cases, the GUI features may allow a user to find data in the data cloud (e.g., users do not always know their data in the data cloud). The GUI features may also allow users to set up their data flow to join, cleanse, filter, and enhance their data. FIGS. 58 and 59 show examples of a GUI (e.g., CloudLink Explorer) allowing users to find data in the data cloud (e.g., Snowflake). As described above, the system herein may access the data schema for all the customer's data in the connected data lake/cloud. A data schema (logical data structure) or shape of table (e.g., multi-dimensional data model, dimension table, etc.) may be based on the data cloud configuration. As shown in the example, the CloudLink Explorer makes API calls to data providers (e.g., Snowflake, Azure, etc.) to get the metadata about the databases, schemas, and data tables in the data lake. In some embodiments, the platform may automatically provide initial workflows based on the crawled metadata or cloud data objects. In some cases, the platform may initiate workflows automatically based on the connected data objects and may allow for collaboration securely with third parties. The platform may automatically select from a library of app suites such as the marketplace as described later herein, based on the crawled cloud data objects and/or metadata. For instance, based on insights extracted from the cloud data (e.g., data mining), the platform may select an initial application/workflow from the library of app suites. The initial workflow may be presented to a user as a recommendation and a user may further configure or edit the initial workflow as described elsewhere herein.

Upon receiving the metadata, the system may transform the metadata into a graphical view that is searchable and browsable via the GUI. As shown in FIG. 58, a graphical view 5803, 5805 of the data schema/tables associated with a user (e.g., data lake that is associated with a user account) may be displayed on the GUI. A user may visualize their data schemas/tables in the underlying data lake in various formats 5803, 5805 (e.g., table format, graphical representation, etc.). The GUI may also permit a user to search and/or sort 5801 the data. As shown in FIG. 59, a preview of the data schema 5901 may be displayed on the GUI.

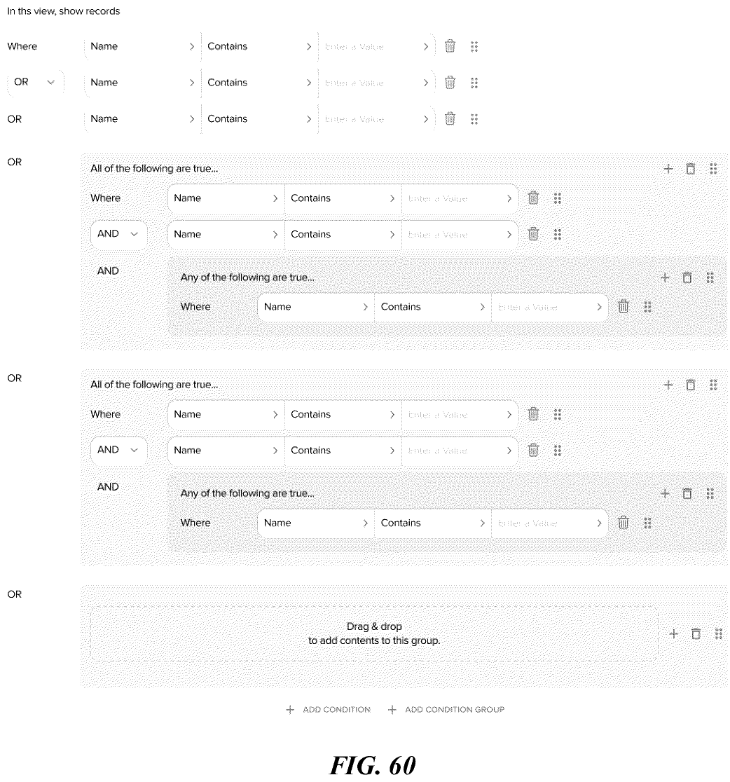

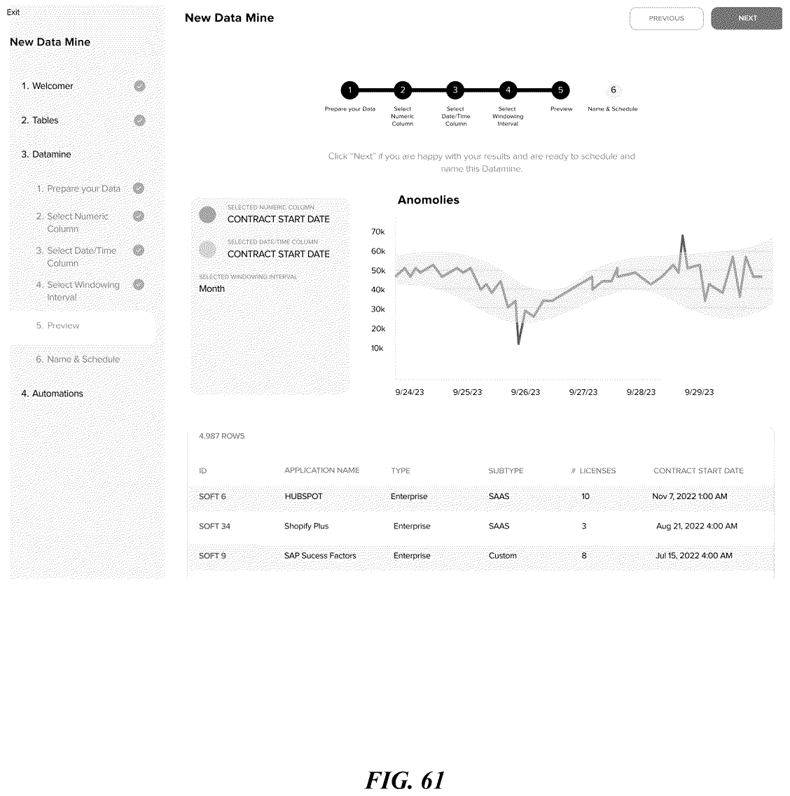

In some embodiments, the GUI provided by the system may allow users to set up logic rules or run machine learning algorithm-trained model on the data to find data. For instance, a user may set up logic rules to find data for starting a workflow. FIG. 60 shows an example of a GUI for users to set up logic rules (e.g., filter parameters and logic operators in records) to find the data. FIG. 61 shows an example of a GUI for users to set up machine-learning-based Anomaly Detection and Report rules. For instance, a user may set up rules for preparing the data, select numeric column, select data/time column, select windowing interval, review the results and schedule and data mine process via the GUI.

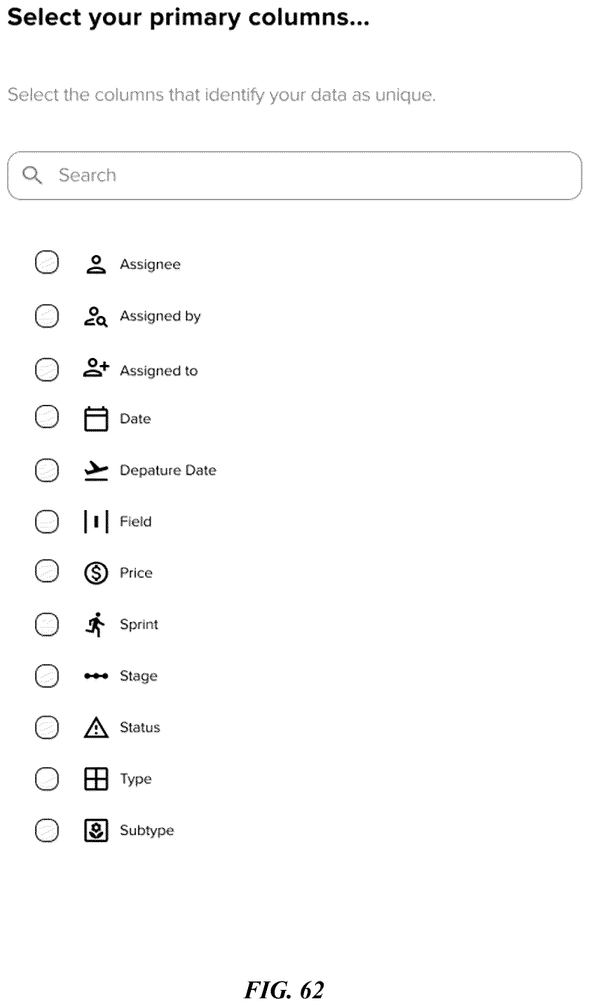

In some embodiments, the system may store the state of the found data so the user may not be notified multiple times when the data is found. For instance, the system may use data identity (e.g., unique identifier) to keep track of every time a row of data starts a workflow, making subsequent data lookups idempotent. For example, a process running hourly may trigger the same workflow multiple times if the system was not tracking that the row of data had already triggered the workflow. This feature beneficially reducing unnecessary notifications to a user such that a user may not be notified multiple times when the data is found until the data no longer passes the logic check. The system herein may use the primary key of a data table for the data identity. In some cases, the system may allow a user to configure or control the identity of the data via a GUI. FIG. 62 shows an example of a GUI for a user to select a primary column to be used as unique identifier of the data. In some cases, the system may also allow users to perform idempotent data lookups on transactional data which does not by default have an identity.

Upon setting up the data mine process, the user may set up an Automation to create a new workflow with the found data. As illustrated in the above GUIs, the user may set up the schedule for the data mine process runs (e.g., schedule on how often a data mine process runs or the condition for running a data mine process).

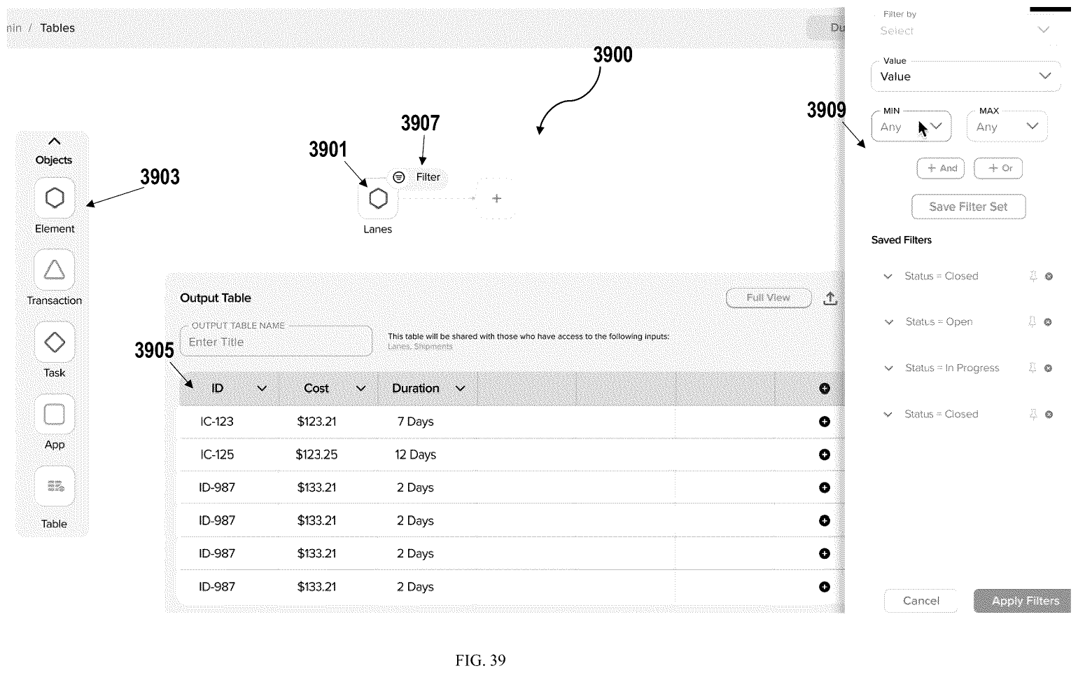

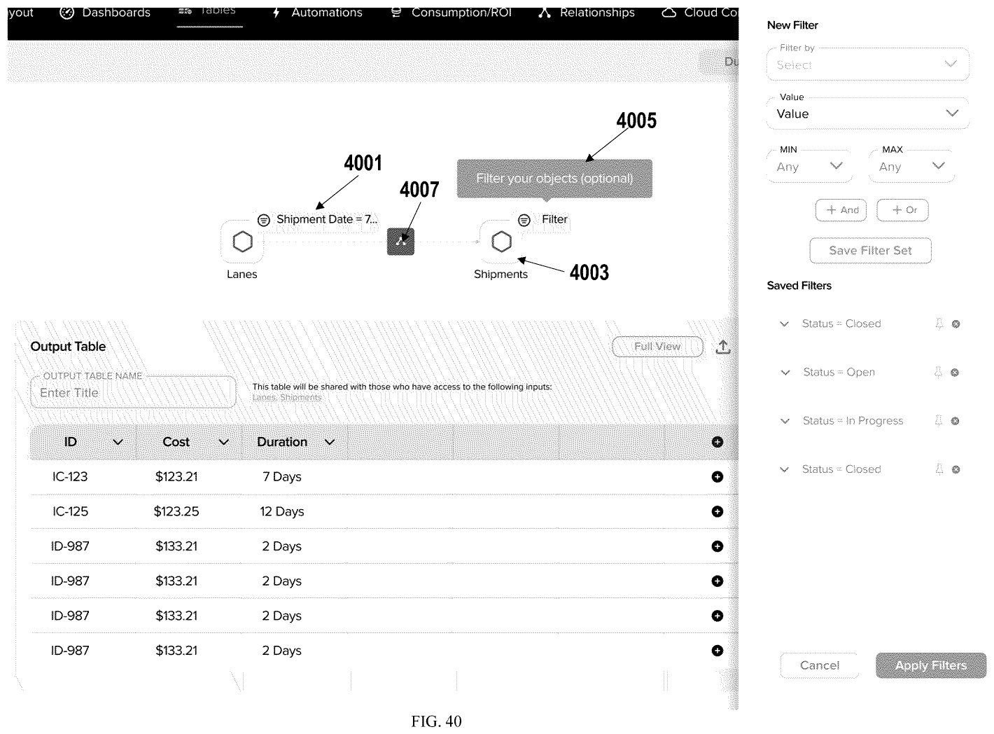

FIGS. 39-43 show examples of GUI for configuring or creating data mining. In some cases, a user may configure or set up the data (e.g., table) to mine and one or more parameters to run data mining on the data. FIGS. 39-42 show examples of a GUI 3900 for creating an object (e.g., table) to data mine. As shown in FIG. 39, a user may drag on an element 3903 from the objects pane and drop the selected element (e.g., Lane 3901). For example, a user may click on the Element icon in the left pane and select the object e.g., Lane from the drop-down menu. The table 3905 of the selected element may be automatically populated on the GUI. A user may choose to filter the selected object 3901 such as clicking on the “filter” icon 3907, then a filter pane 3909 may pop up with a plurality of configurable fields for a user to set up the filter. For example, a user may set up the values, combine filters, set up filter status and the like to set up a filter to be applied to the object 3901. Once the filter is applied, the table 3905 may be automatically updated and information about the filter 4001 may also be displayed with the object as shown in FIG. 40.

A user may be prompted to drag-and-drop another object e.g., shipments 403. Similarly, a user may be prompted 4005 to set up a filter to be applied to the second object 4003. Once the second object and the second filter are set up, the user may be prompted to set up a relationship or view the relationship between the two objects. For example, upon clicking on the relation icon 4007, a relation pane may pop up and allow a user to define the relationship between the two objects as described elsewhere herein. The table may be automatically updated as the relationship, and/filter are configured.

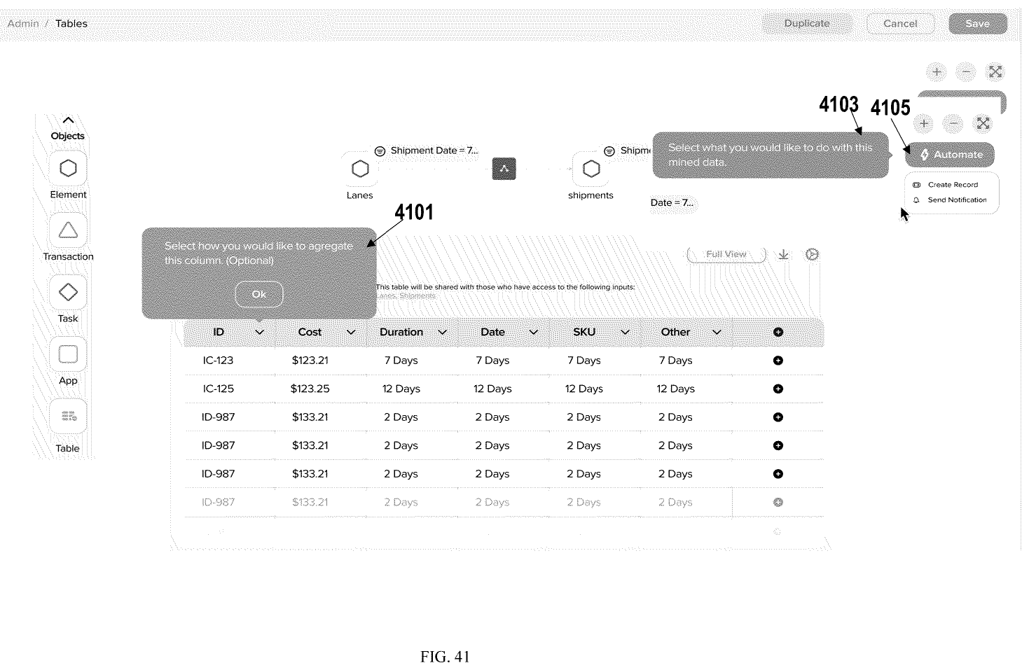

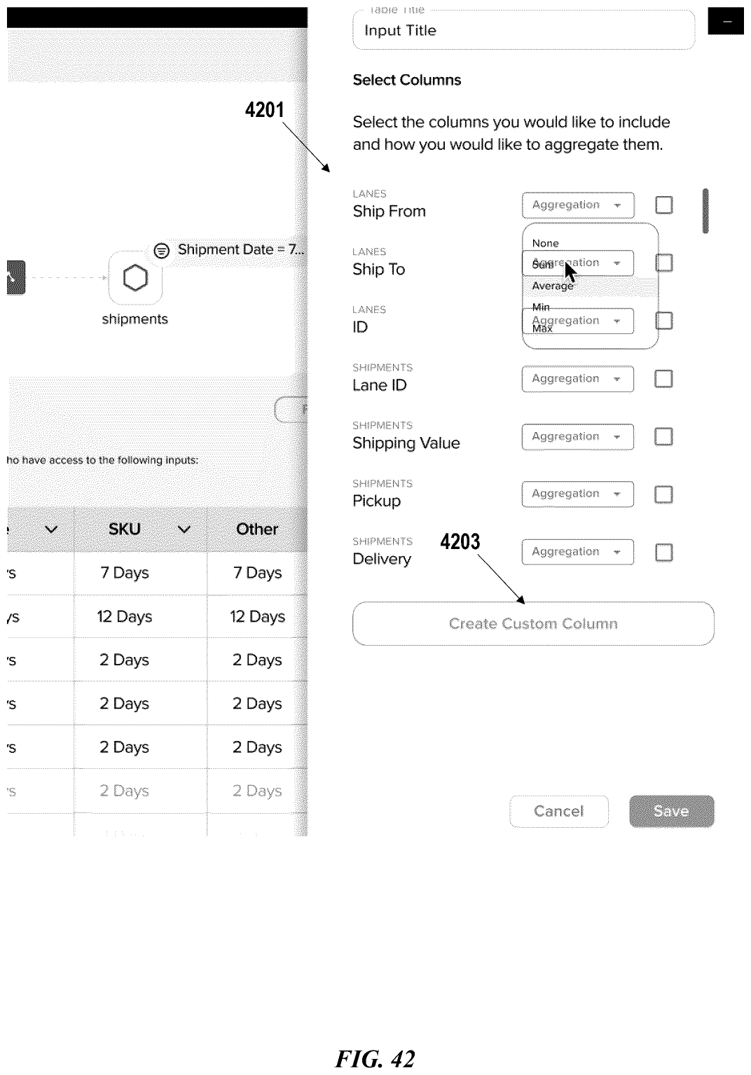

As shown in FIG. 41, the GUI may provide options for a user to aggregate columns 4101 in the output table. For instance, a user may choose to select columns for aggregation and/or define a filter as shown in FIG. 42. The GUI 4201 may allow the user to select columns to include in the output table and define how to aggregate the selected columns. A user may also be permitted to create a new column 4203 in the output table via the GUI.

The GUI may further allow a user to set up actions to be executed on the created table. For example, as illustrated in FIG. 41, the GUI may display message 4103 prompting a user to select actions to be applied to the table. A user may click on the Automation icon 4105 and select from the action options (e.g., create record, send notification) in the drop-down menu to set up the action for the Automation.

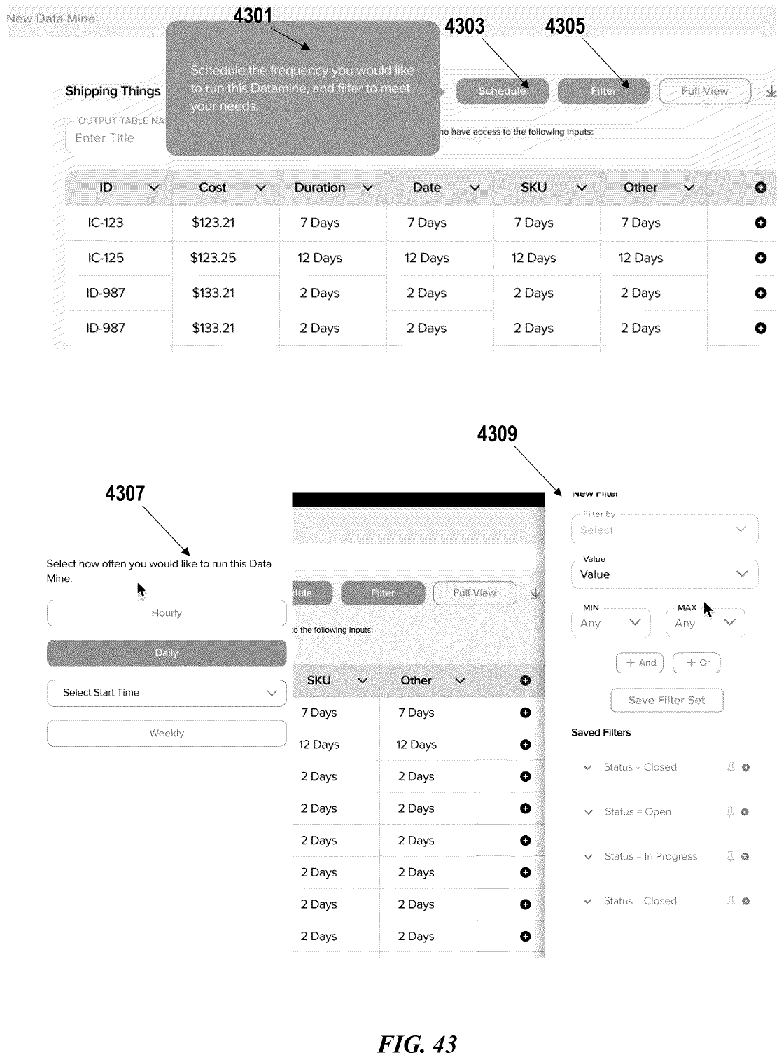

Once the table is created and saved (e.g., data can be written-back to the data cloud directly), a user may set up one or more parameters for running data mine. For example, the GUI illustrated in FIG. 43 may prompt 4301 a user to set up one or more parameters to schedule the frequency, and/or time to run the data mine and/or one or more parameters for filtering the table. As shown in the example, upon clicking on the schedule button 4303, options 4307 to set up a frequency and/time to run the data mine may be displayed. A user may select from the frequency options such as hourly, daily, weekly and/or set up the start time via the GUI. A user may also be permitted to set up a filter via the GUI 4309 to be applied to the data mine by clicking on the filter button 4305.

### Cloud-Native Architecture

In an aspect, the present disclosure provides a system for providing a data-driven workflow platform. The system comprises a first module configured to operatively couple the data-driven workflow platform to one or more data clouds; a second module configured to map selected data objects to a data storage model of the data-driven workflow platform, where the selected data objects are stored on the one or more data clouds; and a visualization module configured to display, on a graphical user interface (GUI), an interactive flow for building a cloud application utilizing or managing the selected data objects. In some cases, the interactive flow comprises at least one graphical element corresponding to a rule for automating an action triggered by a triggering event of the selected data objects.

In some embodiments, the first module is configured to translate an instruction to perform an operation on at least one of the selected data objects received via the GUI into a database operation executable in the data cloud configuration. The database operation is executed on the selected data objects in the data cloud configuration without using an extract, transform and load (ETL) data integration process. In some cases, the selected data objects comprise transactional data or streaming data. In some cases, the data-driven workflow platform is configured to cache an intermediary result for performing the operation.

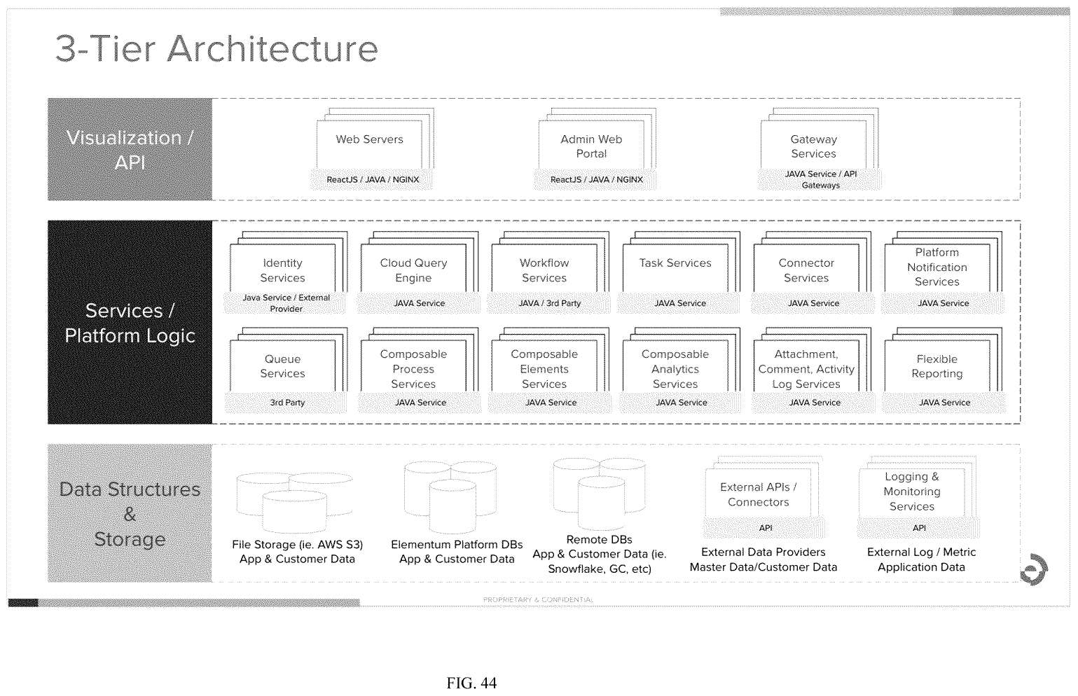

FIG. 44 schematically illustrates an architecture for the data-driven workflow platform. The architecture may be a tiered architecture comprising data structures and storage layer, a services/platform logic layer and a visualization/API layer. The tiered architecture may allow users to access and use data stored in any Data Cloud without the need to move that data to a central location. The data-driven workflow platform may execute workloads (e.g., queries) within the Data Cloud provider (e.g., AWS S3, Snowflake, Databricks, External data provider, etc.) and then stream the data and/or insights back to the user via the user experience interface (UI) provided by the visualization module. In some cases, the platform may employ buffering techniques to allow for live streaming or updating from a Data Cloud to an enterprise SaaS solution. For example, the platform may cache an intermediary result generated during a workflow action for a pre-determined time period (e.g., 15 seconds, 20 seconds, 30 seconds, etc.).

The platform may setup watching processes to be notified as data is changing in the source datasets in the data cloud via a cloud link connected to the notification services in the platform logic layer and the monitoring services in the data structures and storage layer. The watching feature may be utilized for triggering actions in the automation functions within platform. Query execution is performed in services layer. For instance, queries may be processed using “virtual warehouses” where each virtual warehouse is a massively parallel processing compute cluster compute cluster composed of multiple compute nodes from a cloud provider.

### AI-Based Application Discovery

In some embodiments, the platform may analyze the available data sets and leverage artificial intelligence (AI) techniques to recommend one or more predefined applications. This beneficially allows a user to leverage the recommended application with their data.

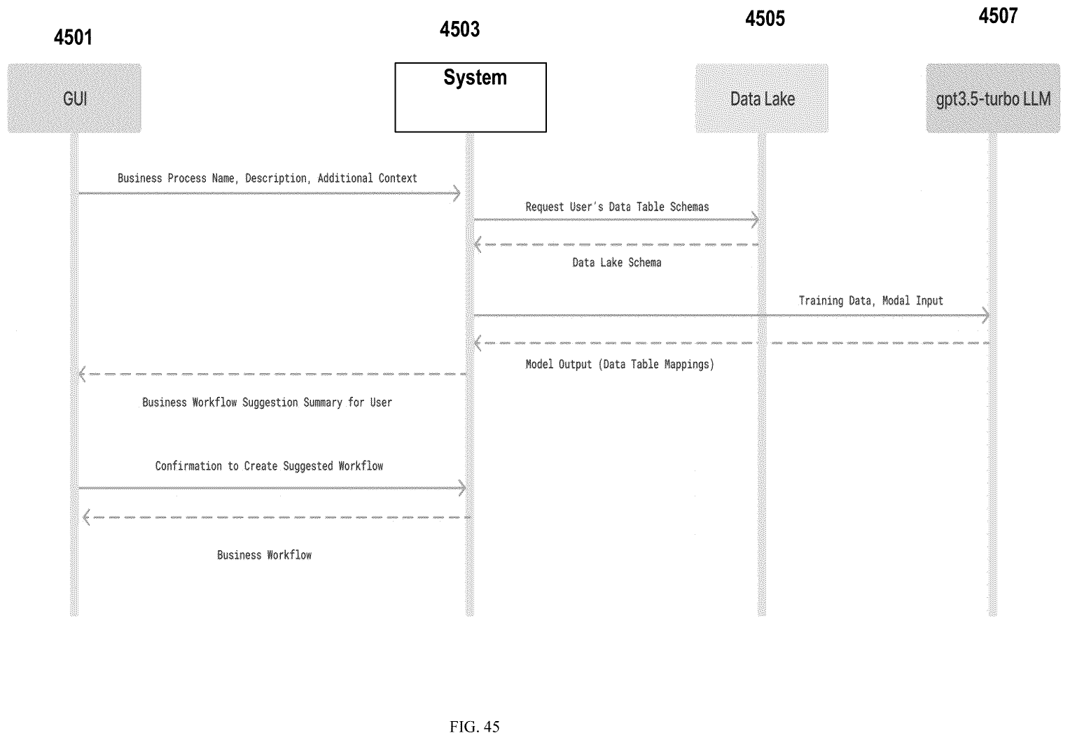

FIG. 45 schematically shows an example of AI-based Application discovery feature, in accordance with some embodiments of the present disclosure. The system 4503 may access the data schema for all the customer's data in the connected data lake 4505. A data schema (logical data structure) or shape of table (e.g., multi-dimensional data model, dimension table, etc.) may be based on the data cloud configuration. The system 4503 can be the same as the data-driven workflow platform or service management cloud system as described elsewhere herein. For instance, the adapter of the system 4503 may enable data hosted in the data cloud (e.g., Snowflake) to appear like it is native inside of the system. For instance, during the configuration or integration between the data cloud (e.g., Snowflake) and the system for the targeted data, the adapter may setup a mapping and data type matching without changing the data or applying any type of modifications to the data within the data cloud. For example, the system 4505 may send a request to access the user's data Table schemas in the data lake 4505. The request may be generated based on the input received via the GUI 4501 such as business process name, description, or other input information.

The system 4503 may comprise a plurality of predefined applications organized or managed in an application library (e.g., application marketplace) that users or customers of the platform can install into their organization. For instance, the system 4503 may comprise a library of predefined applications suites, including logistics, merchandising, inventory management, risk management, procurement, finance, HR, business development, and the like as described elsewhere herein.

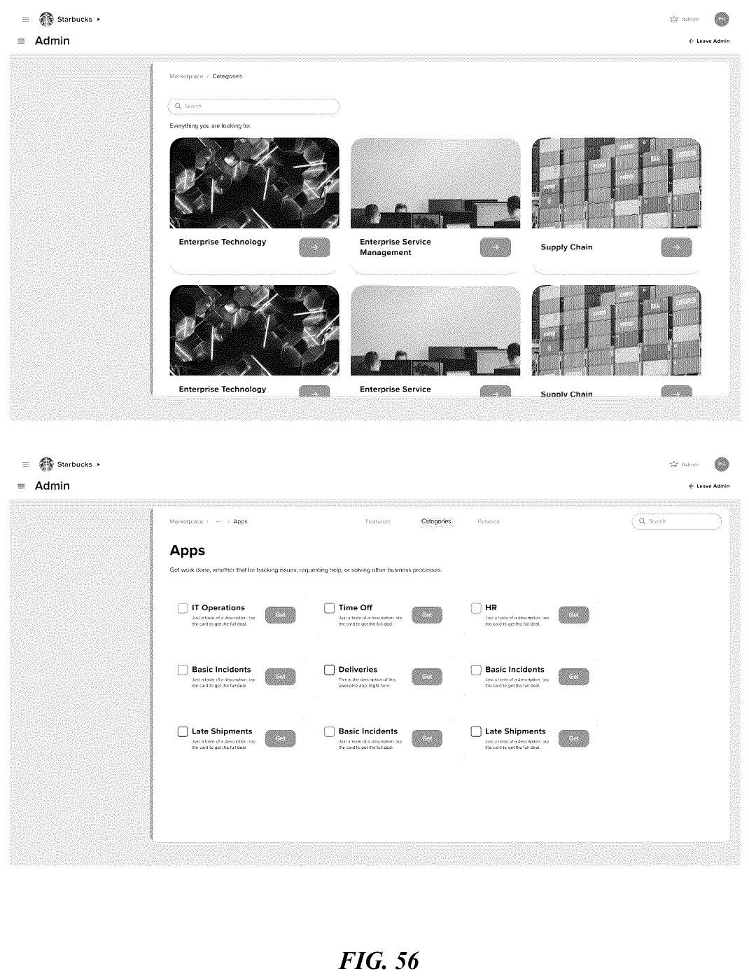

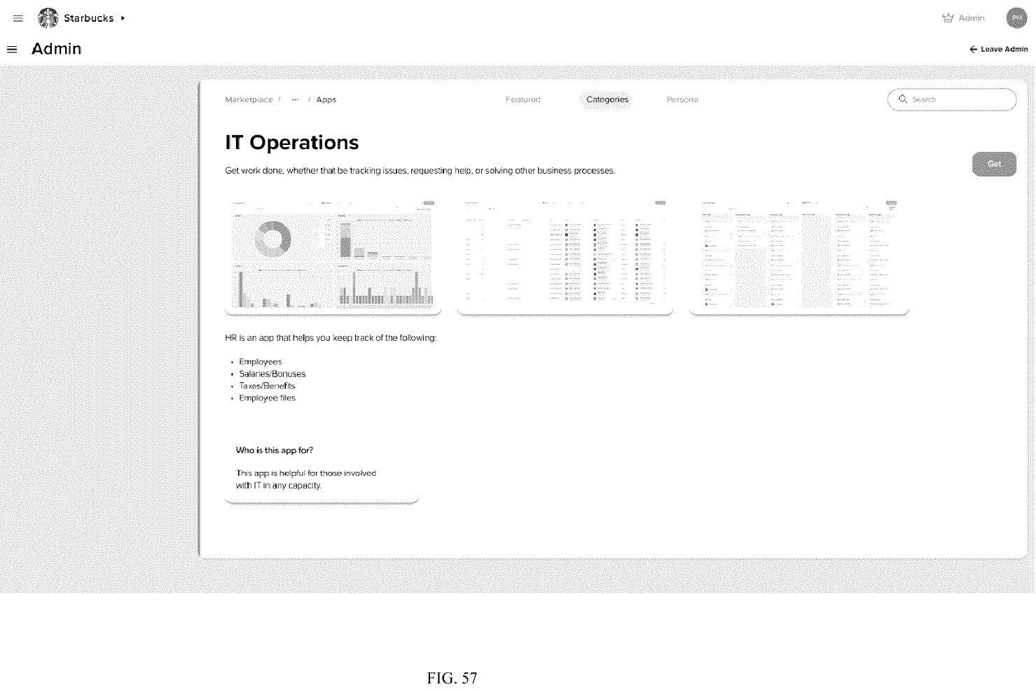

FIGS. 56 and 57 show examples of GUI for an Application marketplace. In some cases, the system 4503 may publish complex workflows into a marketplace that can allow a user (e.g., customer) to deploy a workflow selected from the marketplace in their environment. As shown in FIG. 56, the workflows may be built and maintained (e.g., updated) by admin of the system. In some cases, administrators of the system (e.g., process experts) may build and update the workflows and deploy the updated workflow to customers, and customers may start a workflow in their company without the need to build out the associated data tables, automations, approval processes, or surveys.

The workflows may be organized by categories (e.g., enterprise technology, supply chain, enterprise service management, etc.) for customers to select and deploy to their own company environment. In some cases, a customer/user may search for the workflow by the categories and/or Apps (e.g., IT operations, Time Off, HR, Basic Incidents, Deliveries, etc.). As shown in FIG. 57, a customer/user may view detailed information about a selected workflow or Application (e.g., IT operations) via the GUI. For instance, the GUI may display examples of use applications of the IT operations App, the typical variables can be tracked by the App and potential industry field for the App.

The system may train a large language model (LLM) 4507 on the availability of the predefined applications and the shape of the data tables (i.e., data lake schema) required to fulfill the application. The system trains the LLM on the shape of the data tables of the customer's data lake. The LLM may be personalized or customized using user data. As an example, a user may provide a list of data tables. The system may identify a list of available predefined workflows or business workflows with the required data to power them. For instance, the LLM may be trained to identify one or more workflows from the library of predefined workflows based at least in part on the shape of the data tables associated with a user. The system may be instructed to look for data tables with similar shape and function to the predefined workflows. As an example, the system may return a JSON array of business process objects with the keys:
predefinedWorkflowId (String)
table-mapping:
   predefinedTableId (String)
   tableFieldName (String)
   predefinedTableFieldName (String)

After training the LLM, the system requests the LLM to look for pre-defined applications that can be powered with the data in the data lake. For instance, during an inference/prediction phase, the LLM may be deployed to take as input the data schema (e.g., shape of data table) obtained from the data lake that is associated with a user account, and output a data table mapping result. The LLM returns the data table mappings to the system which is used to create the predefined applications.

If a match to a predefined application is found, the LLM returns the data table mappings to the system and the system creates the application on behalf of the customer. If there are no matches, the system switches to a generative approach and asks the LLM to generate possible business workflows outside the predefined applications.

As described above, the input to the trained LLM may comprise shapes of data tables or schemas (e.g., table fields, views, etc.). Following is an example of input to the trained LLM:

User Data Tables:

<[{“name”: “USERS”,
“databaseName”: “financials”,
“schemaName”: “internal”},
{“name”: “SHIPMENTS”,
“databaseName”: “financials”,
“schemaName”: “internal”},
{“name”: “PRODUCTS”,
“databaseName”: “financials”,
“schemaName”: “internal”

The following is an example of output of the model:

```
“data”: {“aiCloudLinkAppDiscoveryCompletionExecute”: {“apps”: [{“name”: “Manage
Products”,
  “description”: “Create, update, and delete product
information”,
    “tables”: [“PRODUCTS”,
      “PRODUCT_LISTING”]},
  {“name”: “Manage Shipments”,
  “description”: “Create, update, and delete shipment
information”,
  “tables”: [“SHIPMENTS”,
    “SHIPMENT_TRANSACTION”]},
  {“name”: “Manage Users”,
  “description”: “Create, update, and delete user
information”,
    “tables”: [“USERS”]},
  {“name”: “Manage Warehouses”,
  “description”: “View and manage warehouse usage and
metering information”,
  “tables”: [“WAREHOUSE_METERING_HISTORY”,
      “WAREHOUSE_LOAD_HISTORY”,
      “WAREHOUSE_EVENTS_HISTORY”]},
  {“name”: “Manage Contracts”,
  “description”: “View and manage contract information”,
  “tables”: [“CONTRACT_ITEMS” ]},
  {“name”: “View Usage Metrics”,
  “description”: “View usage metrics for various services”,
  “tables”: [“METERING_DAILY_HISTORY”,
      “MONETIZED_USAGE DAILY”,
    “STAGE_STORAGE_USAGE_HISTORY”,
      “STORAGE_USAGE”,
      “USAGE_IN_CURRENCY_DAILY”]}]}}
```

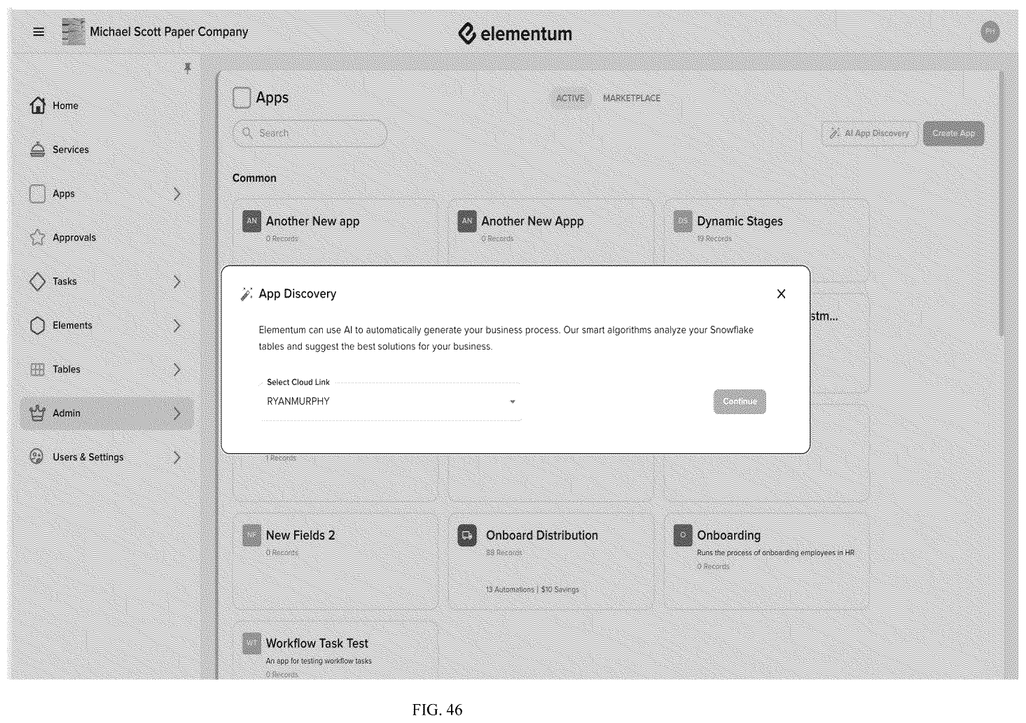

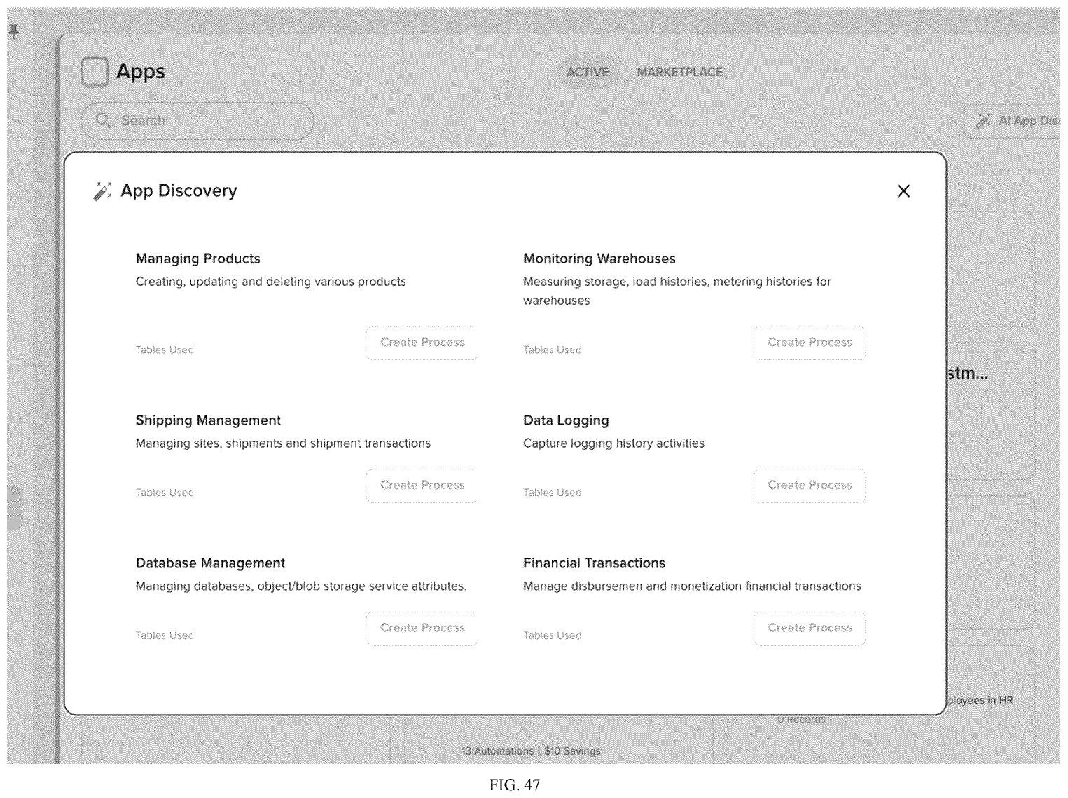

FIGS. 46-48 show examples of GUI for the AI-based Application discovery feature. As shown in FIG. 46, a user may provide input via the App Discovery function within the GUI such as by selecting a cloud link. The system may then automatically gather the data schema in the selected data lake and identify a list of available predefined workflows or business workflows with the required data to power the applications. FIG. 47 illustrates examples of predefined applications identified by the system as the model output.

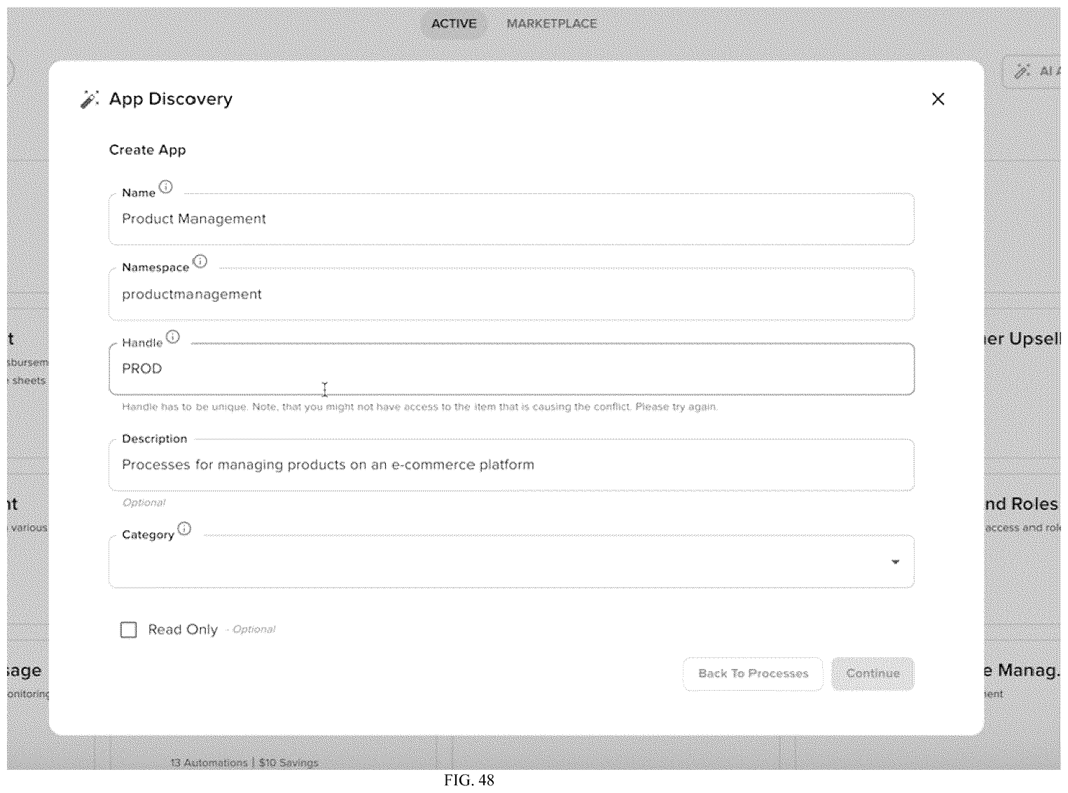

A user may select from the plurality of predefined applications to create an application as shown in FIG. 48. For example, a user may be prompted to provide input in the data fields such as Name, Namespace, Handle, Description, Category to create an App.

### AI-Generated Workflow

In some embodiments, a workflow may be generated by an AI model. For instance, in the AI-based Application discovery feature, if the LLM cannot map the customer's data to a predefined application, the system may use AI to generate a business workflow. The AI workflow module herein may comprise a trained model taking as input a description of a business process (e.g., provided by a customer via a GUI for creating a business process), and outputting a workflow. The model may be trained using machine learning algorithm as described elsewhere herein.

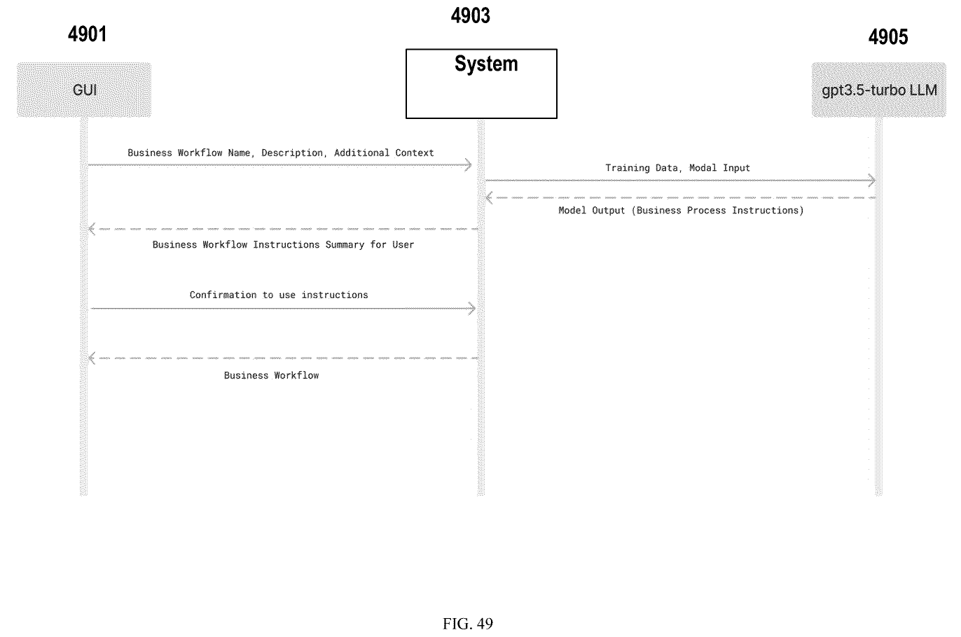

FIG. 49 schematically shows an example of AI-generated workflow feature, in accordance with some embodiments of the present disclosure. The system 4903 may receive input from the GUI 4901 such as business workflow name, description, or other input information. The system 4903 can be the same as the data-driven workflow platform or service management cloud system as described elsewhere herein.

The system 4903 may train an LLM to create a workflow. In some cases, the LLM may be trained by: i) instructing, by the system, the LLM to assume its purpose to create a business workflow, ii) instructing the LLM to break down the business process into one or more stages, iii) instructing the LLM to create one or more steps for each stage in the process, and iv) requesting the LLM to identify data that is relevant in tracking each step of the business process.

After the LLM is trained 4905, the system 4903 may supply the LLM with the name of the business process, a description of the process, and any additional context from the user (received via the GUI 4901) on how they would like their business process defined.

The LLM may be trained to output business workflow data. In some cases, the output of the LLM may include a list of instructions the system 4903 uses to create the business workflows on behalf of the customer.

The AI-generated workflow feature may be capable of automatically generating a business process for a user/customer. For example, the system may i) receive an instruction to create a new business workflow, ii) break business process down into named stages, iii) create named steps for reach stage, and iv) for each step, create data fields that are required to track the business process return only a json object. Following is an example of format:
stages:
name: stage name
steps:
description: step description
dataFields:
name: Field Name
fieldType: Only pick one of the following field types: BOOLEAN| TEXT| NUMBER| DECIMAL| DATE| DATETIME

The input to the trained LLM may be based on user input. For example, the user input may comprise business process name: <HR Onboarding>, business process description: <Runs the process of onboarding employees>, additional business process context: <Make sure to include tracking of social security number, birthday, and T-Shirt size so we can send them swag when they join the company>.

As described above, the output of the model may comprise instructions for the system to create a business workflow. Following is an example of the workflow:

```
“data”: {“aiFlowInstructionsCompletionExecute”: { “stages”: [
  {“name”: “Pre-Onboarding”,
  “steps”: [{“description”: “Receive new employee
information”
  “dataFields”: [{“name”: “First Name”,
  “fieldType”: “TEXT”}, {“name”: “Last Name”,
    “fieldType”: “TEXT”},
  {“name”: “Email”,“fieldType”: “TEXT”},
  {“name”: “Phone Number”,“fieldType”: “TEXT”},
  {“name”: “Address”,“fieldType”: “TEXT”},
  {“name”: “Social Security Number”, “fieldType”:
“TEXT”},
  {“name”: “Birthday”,“fieldType”: “DATE”},
  {“name”: “T-Shirt Size”,“fieldType”: “TEXT”}]}}},
  {“name”: “Onboarding”,“ steps”: [{“description”: “Send
welcome email to new employee”,
  “dataFields”: [{“name”: “Email Sent”,“fieldType”:
“BOOLEAN”}]},{“description”: “Schedule orientation meeting”,“dataFields”: [{“name”:
“Meeting Scheduled”,“fieldType”: “BOOLEAN”},
  {“name”: “Meeting Date”,“fieldType”:
“DATETIME”}]},{“description”: “Assign company equipment”,“dataFields”: [{“name”:
“Equipment Assigned”,“fieldType”: “BOOLEAN”},{“name”: “Equipment Type”,“fieldType”:
“TEXT”},
  {name”: “Equipment Serial Number”,“fieldType”:
“TEXT”}]},{“description”: “Complete paperwork”,“dataFields”: [{“name”: “Paperwork
Completed”,“fieldType”: “BOOLEAN”},
  {name”: “Paperwork Type”,“fieldType”: “TEXT.”}]}]}]}}
```

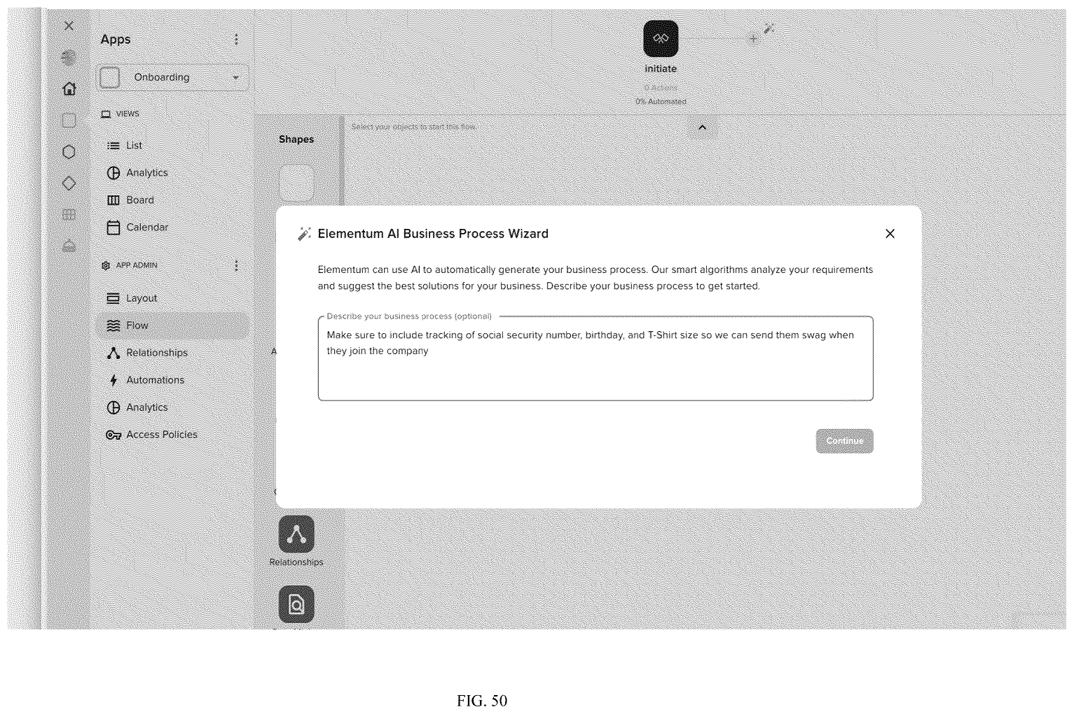

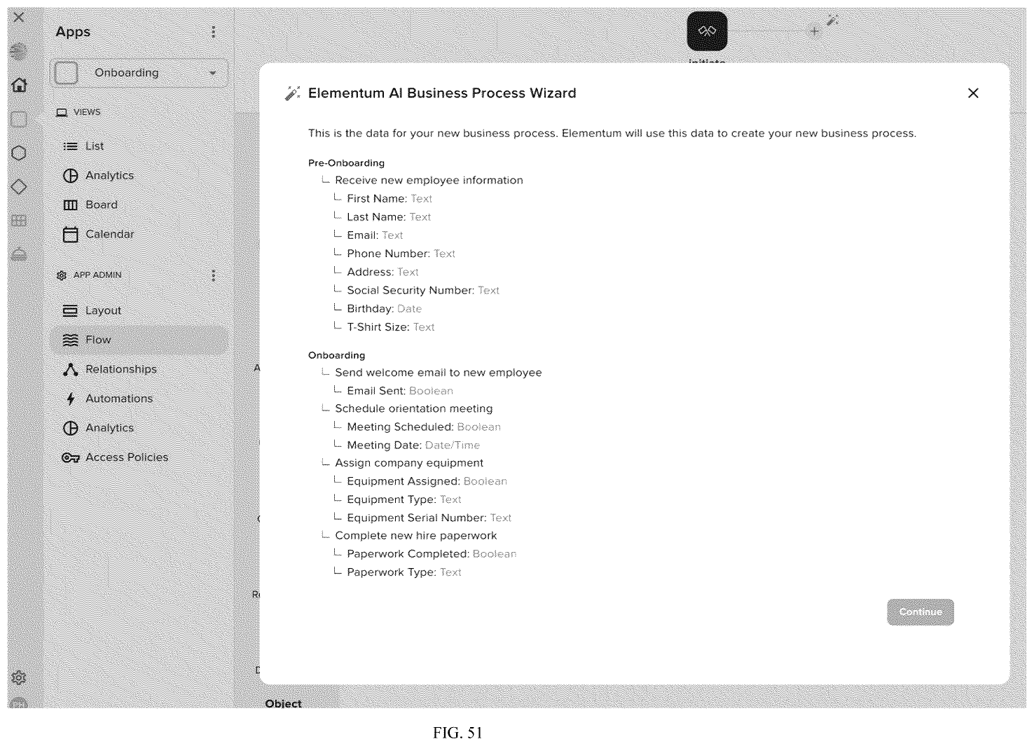

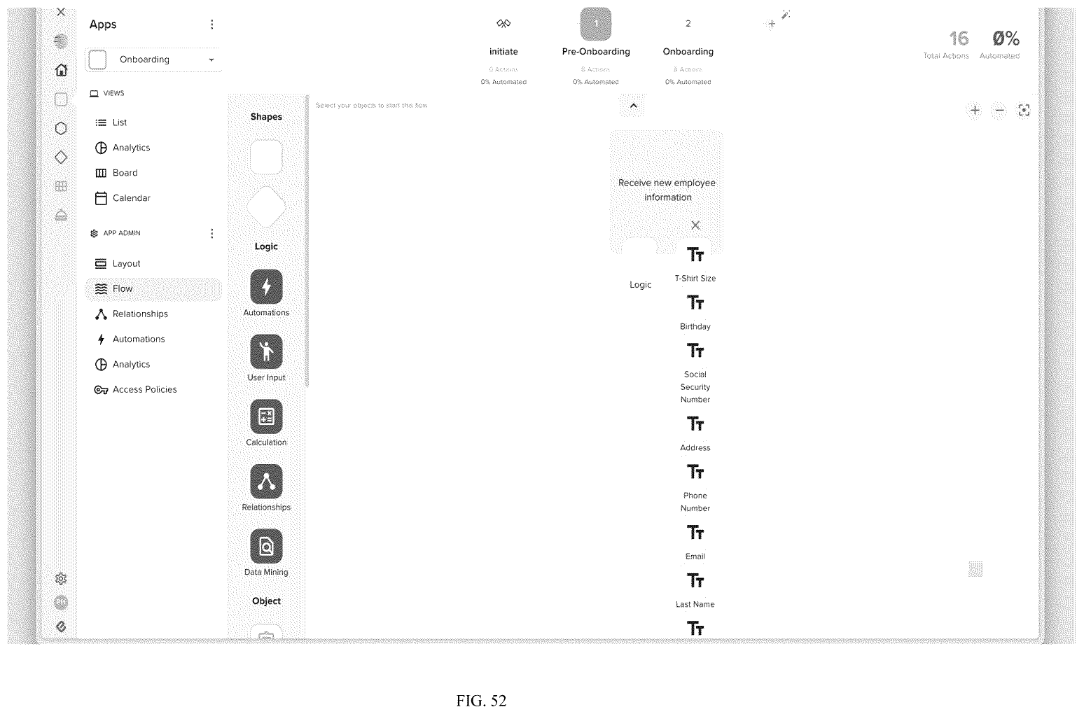

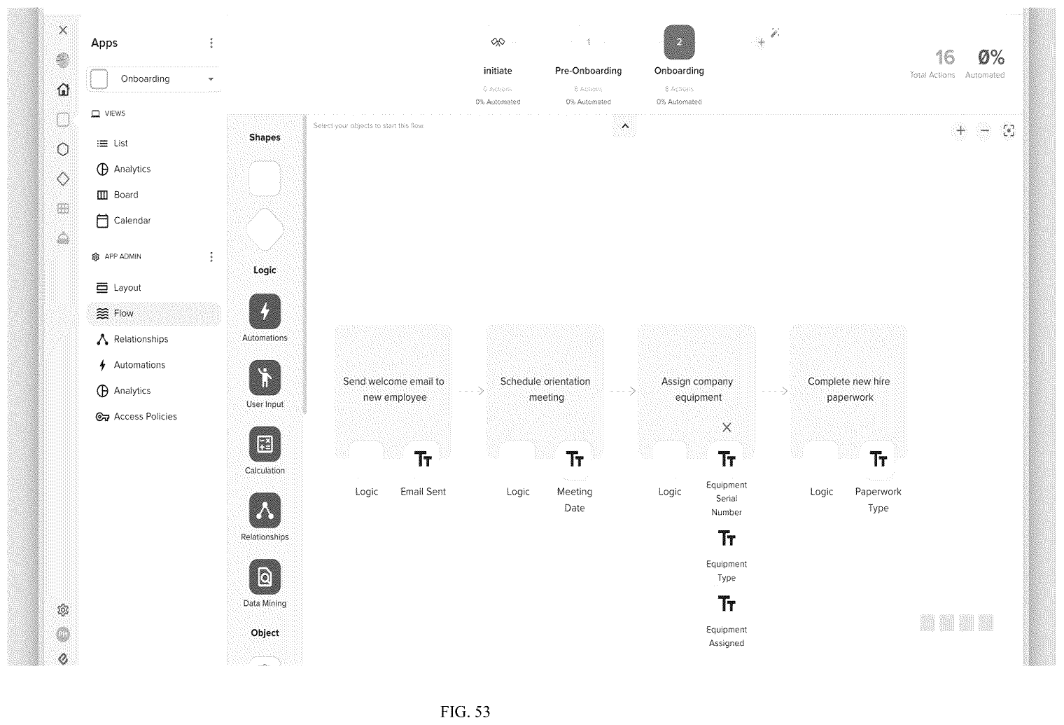

FIGS. 50-53 show examples of GUI of the AI-generated workflow feature. FIG. 50 shows examples of input provided via the GUI. As illustrated in the example, a user may provide a description of the business process to start the business process generation. As shown in FIG. 51, the system may automatically gather data associated with the user and the business process such as by the AI-based application discovery feature described above. As shown in FIG. 52, the LLM may output one or more stages e.g., initiate, pre-onboarding and onboarding for the business process. The LLM may output one or more steps or actions for each stage as illustrated in FIG. 53. The GUI may display the graphical elements representing the one or more stages and one or more steps for each stage upon executing the list of instructions outputted by the LLM.

In some embodiments, the various functions and visual features may be provided virtually without the need to install, configure or manage any software. The data-driven workflow platform system may be implemented on a cloud platform system (e.g., including a server or serverless) that is in communication with one or more user systems/devices via a network. The cloud platform system may be configured to provide the aforementioned functionalities to the users via one or more user interface or graphical user interfaces (GUIs), which may include, without limitation, web-based GUIs, client-side GUIs, or any other GUI as described above. For example, a user may access the coding challenge via a web-based-GUIs or within a web browser. In some cases, the graphical user interface (GUI) or user interface may be provided on a display. The display may or may not be a touchscreen. The display may be alight-emitting diode (LED) screen, organic light-emitting diode (OLED) screen, liquid crystal display (LCD) screen, plasma screen, or any other type of screen. The display may be configured to show a user interface (UI) or a graphical user interface (GUI) rendered through an application (e.g., via an application programming interface (API) executed on the user device or the user system, or on the cloud).

Without the use of such exclusive terminology, the term “comprising” in claims associated with this disclosure shall allow for the inclusion of any additional element—irrespective of whether a given number of elements are enumerated in such claims, or the addition of a feature may be regarded as transforming the nature of an element set forth in such claims. Except as specifically defined herein, all technical and scientific terms used herein are to be given as broad a commonly understood meaning as possible while maintaining claim validity.

### Computing System

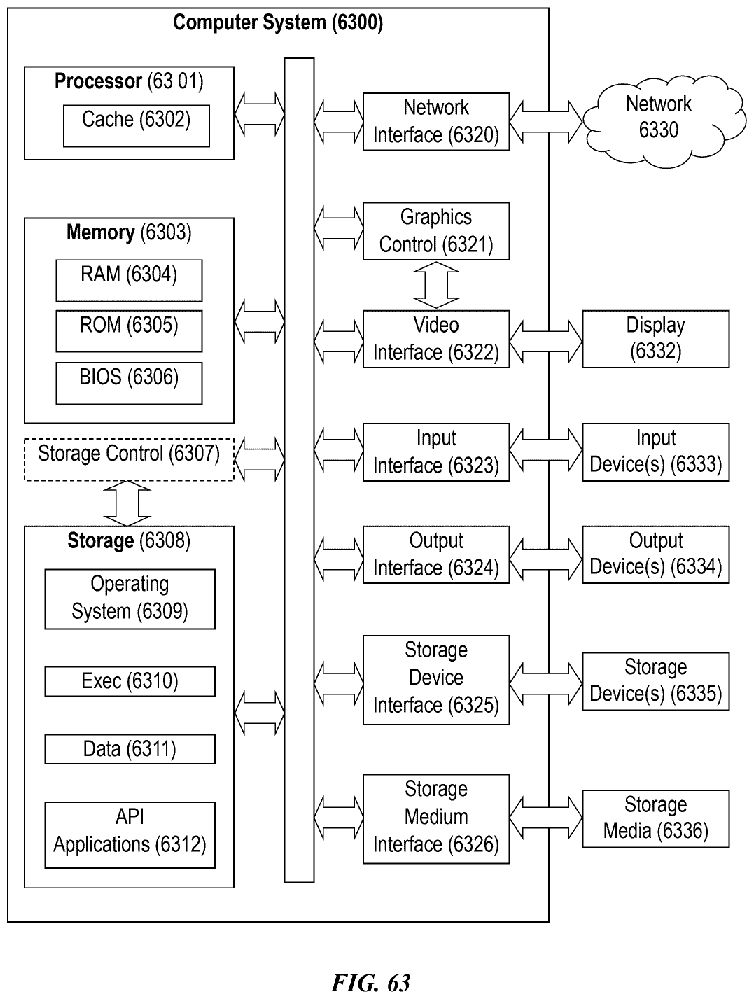

Referring to FIG. 63, a block diagram is shown depicting an exemplary machine that includes a computer system 6300 (e.g., a processing or computing system) within which a set of instructions can execute for causing a device to perform or execute any one or more of the aspects and/or methodologies for static code scheduling of the present disclosure. The components in FIG. 63 are examples only and do not limit the scope of use or functionality of any hardware, software, embedded logic component, or a combination of two or more such components implementing particular embodiments.

Computer system 6300 may include one or more processors 6301, a memory 6303, and a storage 6308 that communicate with each other, and with other components, via a bus 6340. The bus 6340 may also link a display 6332, one or more input devices 6333 (which may, for example, include a keypad, a keyboard, a mouse, a stylus, etc.), one or more output devices 6334, one or more storage devices 6335, and various tangible storage media 6336. All of these elements may interface directly or via one or more interfaces or adaptors to the bus 6340. For instance, the various tangible storage media 6336 can interface with the bus 6340 via storage medium interface 6326. Computer system 6300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 6300 includes one or more processor(s) 6301 (e.g., central processing units (CPUs), general purpose graphics processing units (GPGPUs), or quantum processing units (QPUs)) that carry out functions. Processor(s) 6301 optionally contains a cache memory unit 6302 for temporary local storage of instructions, data, or computer addresses. Processor(s) 6301 are configured to assist in execution of computer readable instructions. Computer system 6300 may provide functionality for the components depicted in FIG. 63 as a result of the processor(s) 6301 executing non-transitory, processor-executable instructions embodied in one or more tangible computer-readable storage media, such as memory 6303, storage 6308, storage devices 6335, and/or storage medium 6336. The computer-readable media may store software that implements particular embodiments, and processor(s) 6301 may execute the software. Memory 6303 may read the software from one or more other computer-readable media (such as mass storage device(s) 6335, 6336) or from one or more other sources through a suitable interface, such as network interface 120. The software may cause processor(s) 6301 to carry out one or more processes or one or more steps of one or more processes described or illustrated herein. Carrying out such processes or steps may include defining data structures stored in memory 6303 and modifying the data structures as directed by the software.

The memory 6303 may include various components (e.g., machine readable media) including, but not limited to, a random access memory component (e.g., RAM 6304) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 6305 may act to communicate data and instructions unidirectionally to processor(s) 6301, and RAM 6304 may act to communicate data and instructions bidirectionally with processor(s) 6301. ROM 6305 and RAM 6304 may include any suitable tangible computer-readable media described below. In one example, a basic input/output system 6306 (BIOS), including basic routines that help to transfer information between elements within computer system 6300, such as during start-up, may be stored in the memory 6303.

Fixed storage 6308 is connected bidirectionally to processor(s) 6301, optionally through storage control unit 6307. Fixed storage 6308 provides additional data storage capacity and may also include any suitable tangible computer-readable media described herein. Storage 6308 may be used to store operating system 6309, executable(s) 6310, data 6311, applications 6312 (application programs), and the like. Storage 6308 can also include an optical disk drive, a solid-state memory device (e.g., flash-based systems), or a combination of any of the above. Information in storage 6308 may, in appropriate cases, be incorporated as virtual memory in memory 6303.

In one example, storage device(s) 6335 may be removably interfaced with computer system 6300 (e.g., via an external port connector (not shown)) via a storage device interface 6325. Particularly, storage device(s) 6335 and an associated machine-readable medium may provide non-volatile and/or volatile storage of machine-readable instructions, data structures, program modules, and/or other data for the computer system 6300. In one example, software may reside, completely or partially, within a machine-readable medium on storage device(s) 6335. In another example, software may reside, completely or partially, within processor(s) 6301.

Bus 6340 connects a wide variety of subsystems. Herein, reference to a bus may encompass one or more digital signal lines serving a common function, where appropriate. Bus 6340 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 6300 may also include an input device 6333. In one example, a user of computer system 6300 may enter commands and/or other information into computer system 6300 via input device(s) 6333. Examples of an input device(s) 6333 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 6333 may be interfaced to bus 6340 via any of a variety of input interfaces 6323 (e.g., input interface 6323) including, but not limited to, serial, parallel, game port, USB, FIREWIRE, THUNDERBOLT, or any combination of the above.

In particular embodiments, when computer system 6300 is connected to network 6330, computer system 6300 may communicate with other devices, specifically mobile devices and enterprise systems, distributed computing systems, cloud storage systems, cloud computing systems, and the like, connected to network 6330. Communications to and from computer system 6300 may be sent through network interface 6320. For example, network interface 6320 may receive incoming communications (such as requests or responses from other devices) in the form of one or more packets (such as Internet Protocol (IP) packets) from network 6330, and computer system 6300 may store the incoming communications in memory 6303 for processing. Computer system 6300 may similarly store outgoing communications (such as requests or responses to other devices) in the form of one or more packets in memory 6303 and communicated to network 6330 from network interface 6320. Processor(s) 6301 may access these communication packets stored in memory 6303 for processing.

Examples of the network interface 6320 include, but are not limited to, a network interface card, a modem, and any combination thereof. Examples of a network 6330 or network segment 6330 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 6330, may employ a wired and/or a wireless mode of communication. In general, any network topology may be used.

Information and data can be displayed through a display 6332. Examples of a display 6332 include, but are not limited to, a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 6332 can interface to the processor(s) 6301, memory 6303, and fixed storage 6308, as well as other devices, such as input device(s) 6333, via the bus 6340. The display 6332 is linked to the bus 6340 via a video interface 6322, and transport of data between the display 6332 and the bus 6340 can be controlled via the graphics control 6321. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 6332, computer system 6300 may include one or more other peripheral output devices 6334 including, but not limited to, an audio speaker, a printer, a storage device, and any combinations thereof. Such peripheral output devices may be connected to the bus 6340 via an output interface 6324. Examples of an output interface 6324 include, but are not limited to, a serial port, a parallel connection, a USB port, a FIREWIRE port, a THUNDERBOLT port, and any combinations thereof.

In addition or as an alternative, computer system 6300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, subnotebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples. Apple TV®, Roku, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

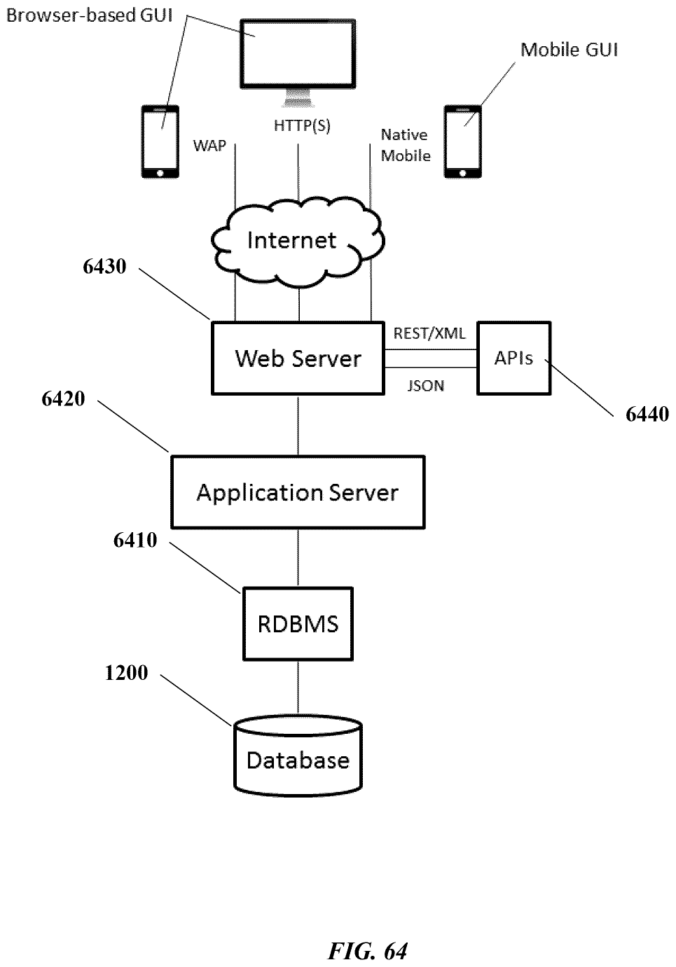

Referring to FIG. 64, in a particular embodiment, an application provision system comprises one or more databases 6400 accessed by a relational database management system (RDBMS) 6410. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 6420 (such as Java servers, .NET servers, PHP servers, and the like) and one or more web servers 6430 (such as Apache, IIS, GWS and the like). The web server(s) optionally expose one or more web services via app application programming interfaces (APIs) 6440. Via a network, such as the Internet, the system provides browser-based and/or mobile native user interfaces.

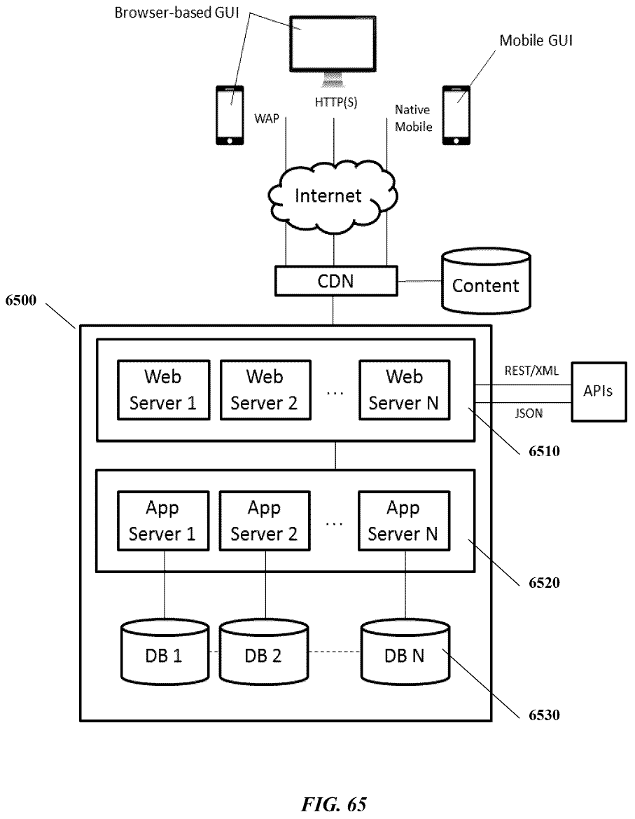

Referring to FIG. 65, in a particular embodiment, an application provision system alternatively has a distributed, cloud-based architecture 6500 and comprises elastically load balanced, auto-scaling web server resources 6510 and application server resources 6520 as well synchronously replicated databases 6530.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle Basic Web, Nokia Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of data or information local to the system herein. The database herein may be accessed, maintained, or controlled by the data-driven workflow platform. In some cases, the database may be different than the cloud-based repository associated with a customer of the platform. The database may be local to or can be remotely accessed by the data-driven workflow platform.

In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

Various embodiments of the disclosure are described herein. Reference is made to these examples in a non-limiting sense. They are provided to illustrate more broadly applicable aspects of the present disclosure. Various changes may be made to the disclosure described and equivalents may be substituted without departing from the true spirit and scope of the present disclosure. In addition, many modifications may be made to adapt a particular situation, material, composition of matter, process, process act(s) or step(s) to the objective(s), spirit or scope of the present disclosure. Further, as will be appreciated by those with skill in the art that each of the individual variations described and illustrated herein has discrete components and features which may be readily separated from or combined with the features of any of the other several embodiments without departing from the scope or spirit of the present disclosure. All such modifications are intended to be within the scope of claims associated with this disclosure.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-63. (canceled)

64. A method for a no-code automation platform, the method comprising:
accessing data objects stored in a data cloud configuration, wherein the data cloud configuration is distinct from, and operatively coupled to, the no-code automation platform;
displaying, on a graphical user interface (GUI) of the no-code automation platform, a workflow for building a cloud application utilizing or managing the data objects, wherein the workflow comprises a graphical element corresponding to an automation action, and wherein the automation action is defined by a rule defining an action triggered by a triggering event of selected data objects, or the automation action comprises a machine-learning-based anomaly detection on selected data objects; and
executing the cloud application built using the workflow displayed on the GUI of the no-code automation platform to automatically detect the triggering event of the selected data objects in the data cloud configuration and automatically perform the action on at least one of the selected data objects, or performing the machine-learning-based anomaly detection on the selected data objects, without extracting or loading the data objects from the data cloud configuration and without moving the data objects to the no-code automation platform.

65. The method of claim 64, wherein the automation action is modifiable by defining a variable using an operator via the GUI.

66. The method of claim 65, wherein the variable comprises a data object called out using the operator or an intermediary data generated by a previous action in the workflow.

67. The method of claim 65, wherein the variable is selected from one or more available variables provided by the no-code automation platform.

68. The method of claim 66, wherein the intermediary data is cached by the no-code automation platform.

69. The method of claim 64, wherein the workflow is created by identifying a workflow from a plurality of predefined workflows using a large language model (LLM).

70. The method of claim 64, wherein the workflow is identified based at least in part on a data schema of the data objects stored in the data cloud configuration.

71. The method of claim 70, wherein the LLM is trained using a data schema of the data objects stored in the data cloud configuration.

72. The method of claim 71, wherein the workflow is created by an LLM and an output of the LLM comprises a list of instructions for creating the workflow.

73. The method of claim 72, wherein an input to the LLM comprises a description of the cloud application.

74. The method of claim 64, wherein the machine-learning-based anomaly detection is configurable via the GUI.

75. The method of claim 74, wherein at least a windowing interval for data objects to be detected for anomaly is configurable.

76. A system for providing a no-code automation platform, the system comprising at least one processor and instructions executable to cause the at least one processor to perform operations comprising:
accessing data objects stored in a data cloud configuration, wherein the data cloud configuration is distinct from, and operatively coupled to, the no-code automation platform;
displaying, on a graphical user interface (GUI) of the no-code automation platform, a workflow for building a cloud application utilizing or managing the data objects, wherein the workflow comprises a graphical element corresponding to an automation action, and wherein the automation action is defined by a rule defining an action triggered by a triggering event of selected data objects, or the automation action comprises a machine-learning-based anomaly detection on selected data objects; and
executing the cloud application built using the workflow displayed on the GUI of the no-code automation platform to automatically detect the triggering event of the selected data objects in the data cloud configuration and automatically perform the action on at least one of the selected data objects, or performing the machine-learning-based anomaly detection on the selected data objects, without extracting or loading the data objects from the data cloud configuration and without moving the data objects to the no-code automation platform.

77. The system of claim 76, wherein the automation action is modifiable by defining a variable using an operator via the GUI.

78. The system of claim 77, wherein the variable comprises a data object called out using the operator or an intermediary data generated by a previous action in the workflow.

79. The system of claim 77, wherein the variable is selected from one or more available variables provided by the no-code automation platform.

80. The system of claim 78, wherein the intermediary data is cached by the no-code automation platform.

81. The method of claim 76, wherein the workflow is created by identifying a workflow from a plurality of predefined workflows using a large language model (LLM).

82. The method of claim 76, wherein the workflow is identified based at least in part on a data schema of the data objects stored in the data cloud configuration.

83. The method of claim 82, wherein the LLM is trained using a data schema of the data objects stored in the data cloud configuration.
